(19) United States
(12) Patent Application Publication
(10) Pub. No.: US 2022/0224776 A1
(43) Pub. Date: Jul. 14, 2022

(54) DYNAMIC LATENCY-RESPONSIVE CACHE MANAGEMENT

(71) Applicants: Kshitij Arun Doshi, Tempe, AZ (US); Francesc Guim Bernat, Barcelona (ES); Ned M. Smith, Beaverton, OR (US)

(72) Inventors: Kshitij Arun Doshi, Tempe, AZ (US); Francesc Guim Bernat, Barcelona (ES); Ned M. Smith, Beaverton, OR (US)

(21) Appl. No.: 17/711,742

(22) Filed: Apr. 1, 2022

(51) Int. Cl. H04L 67/5681; H04L 43/0852; G06F 12/0897; G06F 12/0891

(52) U.S. Cl. CPC H04L 67/5681; H04L 43/0852; G06F 2212/1024; G06F 12/0891; G06F 2212/154; G06F 12/0897

(57) ABSTRACT

The present disclosure is related to managing a caching system based on object fetch costs, where the fetch cost are based on the access latency, cache misses, and time to reuse of individual objects. The caching system may be a multi-tiered caching system that includes multiple storage tiers, where an object management system determines whether to retain or evict an object from a cache of a particular storage tier based on the object's fetch cost. Additionally, eviction can include moving objects from a current storage tier to another storage tier based on the current storage tier and fetch costs.

### TECHNICAL FIELD

The present disclosure is generally related to edge computing, cloud computing, network communication, data centers, network topologies, and communication system implementations, and in particular, to dynamic latency-responsive management of object caching and replication in hardware, software, storage and network hierarchies.

### BACKGROUND

Cache often refers to a hardware and/or software component or system that stores data in a cache (e.g., cache memory, buffer, or the like), which is/are used to serve future requests for that data faster and/or with improved access efficiency. Requested objects are stored in a cache based on, for example, a previous computation or a previous access to data stored in local memory or remote storage. A cache hit occurs when a requested object can be found in a cache, and a cache miss occurs when a requested object cannot be found in a cache. Cache hits are served by reading a requested object from the cache, which is faster than performing the computation or accessing the requested object from a slower data store (or a data store that is further from the requesting entity). Usually, the more requests that can be served from the cache results in faster system performance.

Typical computer applications access data with a high degree of locality of reference, which is the tendency of an application or processor to access the same set of memory locations repetitively over a short period of time. Such access patterns exhibit temporal locality, where data is requested that has been recently requested already, and spatial locality, where data is requested that is stored physically close to data that has already been requested. Caching is a common technique for achieving locality, which means keeping frequently accessed objects in a location that is closer to the point of access. Hardware (HW) and software (SW) caching systems perform caching either autonomously or with guidance from application SW. For autonomous caching, a cache algorithm is usually programmed into SW, firmware (FW), HW, or microcode.

When an application requests an object (or attempts to access the object), the object is usually accessed from a memory device or an external storage when a cache miss occurs. The memory/storage access takes a non-negligible amount of time to complete, thereby resulting in increased latency for accessing the requested objected from memory/storage rather than from the cache.

Typically, a caching system will retain requested objects for a predetermined amount of time in case the object is requested again. Thus, when the user or application requests that object again, the object is retrieved from the cache instead of from the memory/storage, thereby reducing the amount of time required to load/process the requested object (at least in comparison to not using a caching system).

The capacity of a cache is limited, and it is customary to manage the cache's capacity by evicting objects that are accessed less frequently or less recently than other objects. This allows more frequently requested objects (in time or in number of requests) to be retained in the cache. However, if accessing an object that is not found in the cache takes a relatively long time to obtain from memory or storage, then other accesses may arise during the cache miss interval, regardless of whether the other accesses are correlated to the initial object access or not. This may result in a cascading (i.e., increasing) delay. The amount of delay/latency resulting from cache misses is exacerbated in edge computing, distributed services, and other scale deployments because the execution can have dependency on network attached storage and network attached Function-as-a-Service (FaaS) pipelines.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows an example multi-tiered caching architecture.

FIG. 2 depicts an example caching system procedure.

FIGS. 3a, 3b, 3c, and 3d depict example caching statistics collection processes.

FIG. 4 depicts an example cache scaling process.

FIG. 5 depicts an example storage tier selection process.

FIG. 6 depicts an example storage tier eviction process.

FIG. 7 depicts an example infrastructure interplay process.

FIG. 8 illustrates an example edge computing environment.

FIG. 9 illustrates an overview of an edge cloud configuration for edge computing.

FIG. 10 illustrates an example network connectivity for non-terrestrial and terrestrial settings.

FIG. 11 illustrates an example information centric network (ICN).

FIG. 12 illustrates an example software distribution platform.

FIG. 13 depicts example components of a compute node, which may be used in edge computing system(s).

### DETAILED DESCRIPTION

The present disclosure generally relates to data processing, service management, resource allocation, compute management, network communication, application partitioning, and communication system implementations, and in particular, to caching techniques for selecting objects for retention to reduce cache miss latencies.

### 1. CACHING MECHANISMS

Some caching systems, whether hardware or software, employ heuristics for maximizing cache hit rate. Most caching systems assume that there are two outcomes when an object is requested: a cache hit or a cache miss. In these systems, a cache hit results in lower latency than a cache miss (see e.g., Atre et al., Caching with Delayed Hits, PROCEEDINGS OF THE ANNUAL CONFERENCE OF THE ACM SPECIAL INTEREST GROUP ON DATA COMMUNICATION ON THE APPLICATIONS, TECHNOLOGIES, ARCHITECTURES, AND PROTOCOLS FOR COMPUTER COMMUNICATION (SIGCOMM '20), pp. 495-513 (30 Jul. 2020), https://dl.acm.org/doi/pdf/10.1145/3387514.3405883 (“[Atre]”), the contents of which are hereby incorporated by reference in its entirety). However, a third outcome is a “delayed hit,” which occurs in high-throughput systems when multiple requests for the same object occur before the requested object is fetched from a data store (see [Atre]). Cache hit-rate maximization is not always the best approach for selecting objects for cache retention (see e.g., [Atre]). Conventional retention algorithms do not focus on minimizing the latency from cache misses and the “shadow latency build up” that occurs to other accessors while a requested object is being fetched.

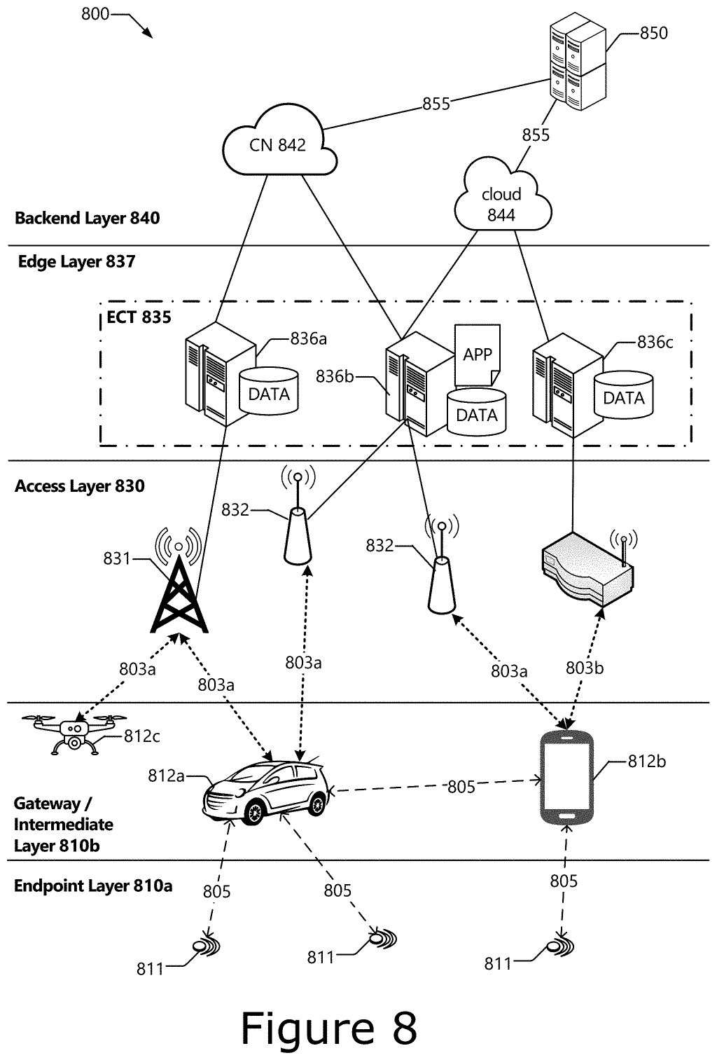

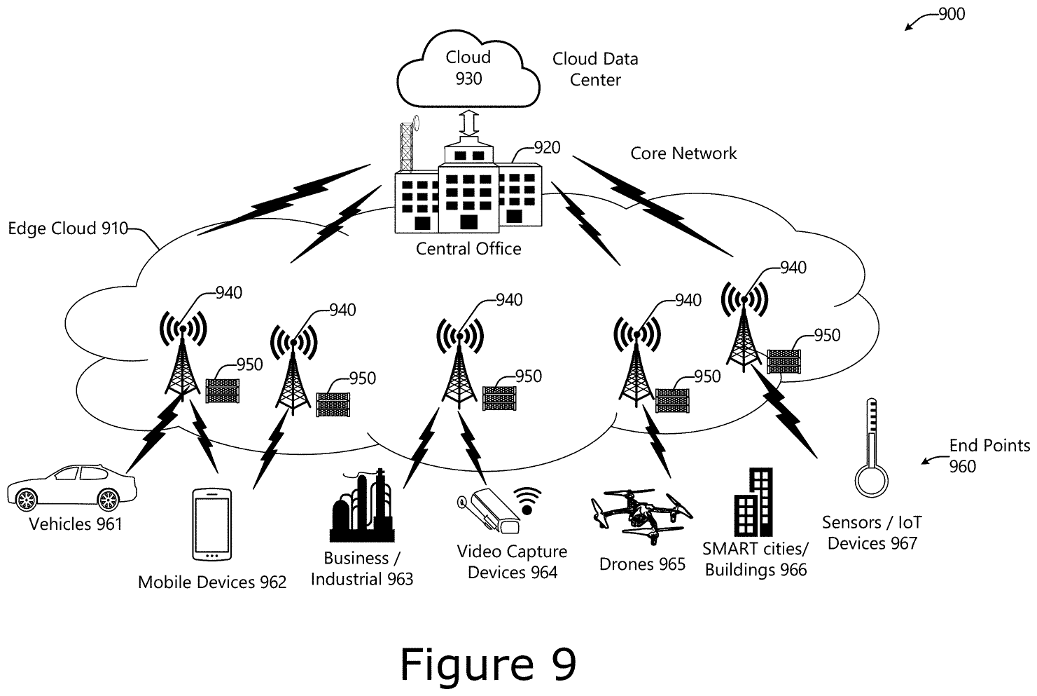

Data for computations is becoming more and more distributed owing to emerging classes of problems in the data center (often referred to as “big data” applications). Meanwhile, edge computing has mixed access scenarios that span from cloud (e.g., cloud 844 in FIG. 8) to Edge (e.g., ECT 835 in FIG. 8 and/or edge cloud 910 in FIG. 9), and/or from Edge to end-user devices (e.g., UEs 810 in FIG. 8). In these cases, the latency costs and additional overhead resulting from long distance fetches/accesses, as well as latencies based on shadow misses (e.g., cache misses arising or otherwise taking place during fetches, which are also referred to as “delayed hits” or the like) exacerbates cache miss penalties when traditional caching algorithms are used. For example, the last column in Table 1 shows the estimated number of requests that can pile up during an outstanding fetch for a cache miss, which suffer varying fractions of a shadow miss latency while the fetches are in progress.

TABLE 1
Cache System Latencies for Different Use Cases

| Scenario | Use Case | Latency | | Estimated number of outstanding cache requests | |
|---|---|---|---|---|---|
| CDN | Intra-data-center proxy | 1 | ms | 1K | (inter-req time = 1 μs) |
| | Fwd proxy to a remote | 200 | ms | 200K | (inter-req time = 1 μs) |
| Network | Single DRAM lookup | 100 | ns | <1 | (inter-req time in μs) |
| | Reverse DNS lookup in an IDS | 200 | ms | 67K | (inter-req time = 3 μs) |
| Storage | File access across data centers | 150 | ms | 5K | (inter-req time = 30 μs) |

Note that the latency in Table 1 is expressed in milliseconds (ms) or nanoseconds (ns). Additionally, for small inter-request latency, which is determined by the rate of handling a request at a processing node, higher latencies of completing a fetch produce frequent concomitant (associated) requests that must wait for the requested data to arrive. Similar latency buildup issues can be a problem for data center computing scenarios as well as for edge computing scenarios.

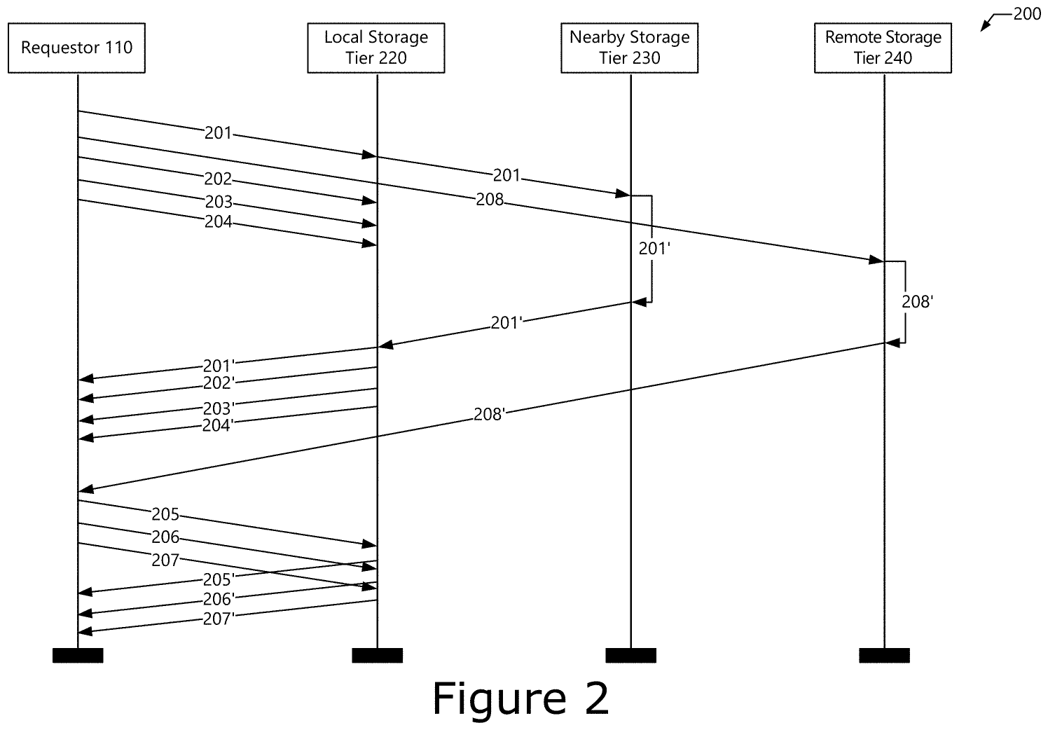

Additionally, delayed hits directly affect tail latencies since tail latencies reflect the worst-case effects. Tail latencies (also referred to as “high-percentile latency”) are latencies that occur at the tail of a distribution curve, which is often used as a key performance metric for some applications or workloads. Tail latencies can also be used to determine safe levels of throughput, for example, determining whether to handle a request rate of X frames per second (where X is a number), provided that P99 latency is below a threshold Y (where Y is a number), and thus tail latencies have a constraining effect on admission control. For some other workloads, tail latencies may not matter directly due to either of the above considerations, but as median latencies rise, scheduler overheads rise and processor caches get colder, opportunities for amortizing batched work decreases. For many operations, there are natural timeouts which start firing, packets start getting dropped, and reliability reduces, and a system appears sluggish or unavailable. Moreover, latency buildups are particularly detrimental for edge computing systems/networks because edge tiers and edge cloud (e.g., edge cloud 910 in FIG. 9) links have limited and fluctuating bandwidths. Disconnected operations are common, which breaks orderly flows of audio, video, and other streaming content when too many tasks are stalled. An example is shown by FIG. 2.

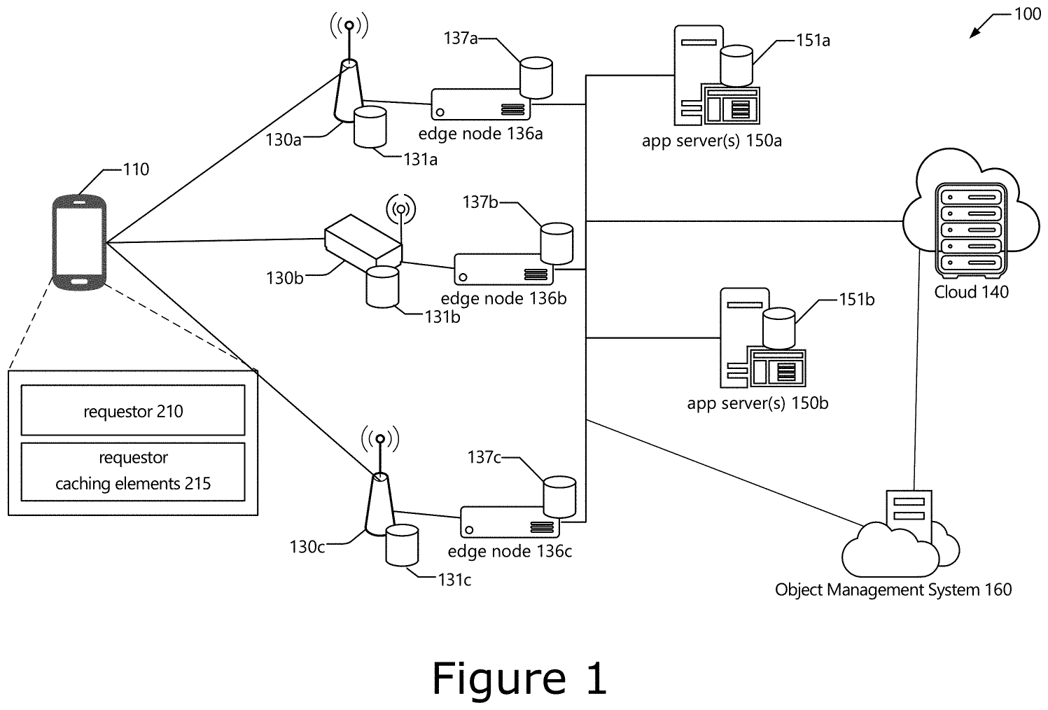

FIG. 1 shows an example multi-tiered caching architecture 100 including a user device 110, a set of edge compute nodes 136 (including edge compute nodes 136a, 136b, and 136c) co-located with respective network access nodes (NANs) 130 (including NANs 130a, 130b, and 130c), a set of application (app) servers (or clusters) 150 (including app server 150a and 150b), cloud storage 140, and an object management system (OMS) 160. The user device 110 may be the same or similar to the UEs 810 of FIG. 8, the NANs 130 may be the same or similar as NANs 830 of FIG. 8, the edge compute nodes 136 may be the same or similar as edge compute nodes 836 of FIG. 8, the cloud storage 140 may be the same or similar as cloud 844 of FIG. 8, and the app server(s) 150 may be the same or similar as the app server 850 of FIG. 8. The cloud storage 140 may be a commercial cloud storage service subscribed to by user device 110, and/or the cloud storage 140 may be a cloud storage service used by a content provider or network service provider. Each of the devices depicted by FIG. 1 may have the same or similar circuitry as discussed infra with respect to compute node 1350 of FIG. 13.

The user device 110 includes a requestor 210 and requestor caching elements 215. The requestor 210 may be a process, a task, a workload, a subscriber in a publish and subscribe (pub/sub) data model, a service, an app, a virtualization container and/or OS container, a virtual machine (VM), a hardware subsystem of the user device 110, or the user device 110 itself. In other implementations, the requestor 210 can be an app, service, container, VM, and/or the like operating on an app server, an edge compute node, a cluster of compute nodes, and/or some other entity or element. The requests for objects sent by the requestor 210 may be any suitable form of request such as, for example, a format defined by any of the protocols discussed herein. The requestor caching elements 215 may include local cache, system memory, and/or storage devices of the user device 110. For example, the requestor caching elements 215 may represent cache memory (e.g., within processor(s) 1352 in FIG. 13), memory device(s) (e.g., memory 1354 in FIG. 13), and/or storage device(s) (e.g., storage 1358 in FIG. 13) within or part of the user device 110 and/or communicatively coupled with the user device 110 (e.g., peripheral storage devices and the like). Additionally or alternatively, the requestor caching elements 215 can include a reserved section of memory for client-side caching mechanisms (e.g., web browser cache and/or the like).

Each the NANs 130, the edge compute nodes 136, and the app server(s) 150 includes cache 131 (including caches 131a, 131b, and 131c), cache 137 (including caches 137a, 137b, and 137c), and cache 151 (including caches 151a and 151b), respectively. The caching elements 215, caches 131, 137, 151, and the cloud storage 140 may be specific memory and/or storage devices reserved for caching objects, and/or respective sections of memory and/or storage used for multiple purposes that is/are reserved for caching objects. Here, the objects may be any type of data in any suitable data format such as, for example, electronic documents, database objects (e.g., a field, record, an association or relation, and/or the like), data structures, data files, archive files, resources, webpages, web forms, applications (e.g., web apps and the like), services, web services, media or content, data units, and/or the like. Additionally, individual objects may have a size specified in a data unit (e.g., bytes or the like), one or more identifiers, and/or one or more values, parameters, attributes, and/or the like.

In various implementations, the caching elements 215, caches 131, 137, 151, and the cloud storage 140 (collectively referred to as “storage tiers” or “caches”) are part of a tiered caching system that includes a set of storage tiers (e.g., storage tiers 220, 230, and 240 of FIG. 2). The caches are SW and/or HW component(s) that is/are used to temporarily store accessed objects to fulfill future access requests from the requestor 210. The caches can be any storage location where copies of data are stored temporarily for quicker subsequent access to that data and/or without additional access to persistent data storage. In some implementations, the cache discussed herein may be any dedicated (physical or logical) memory area or region that may be used to store cached data, including a reserved section of a local memory or storage device, and/or any of the storage tiers.

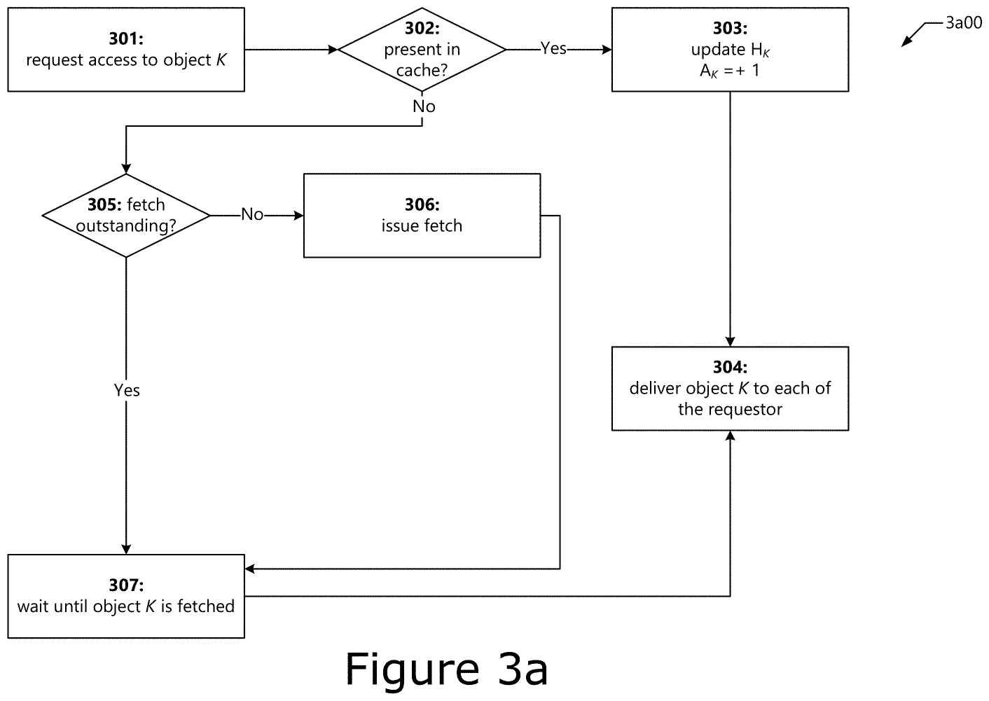

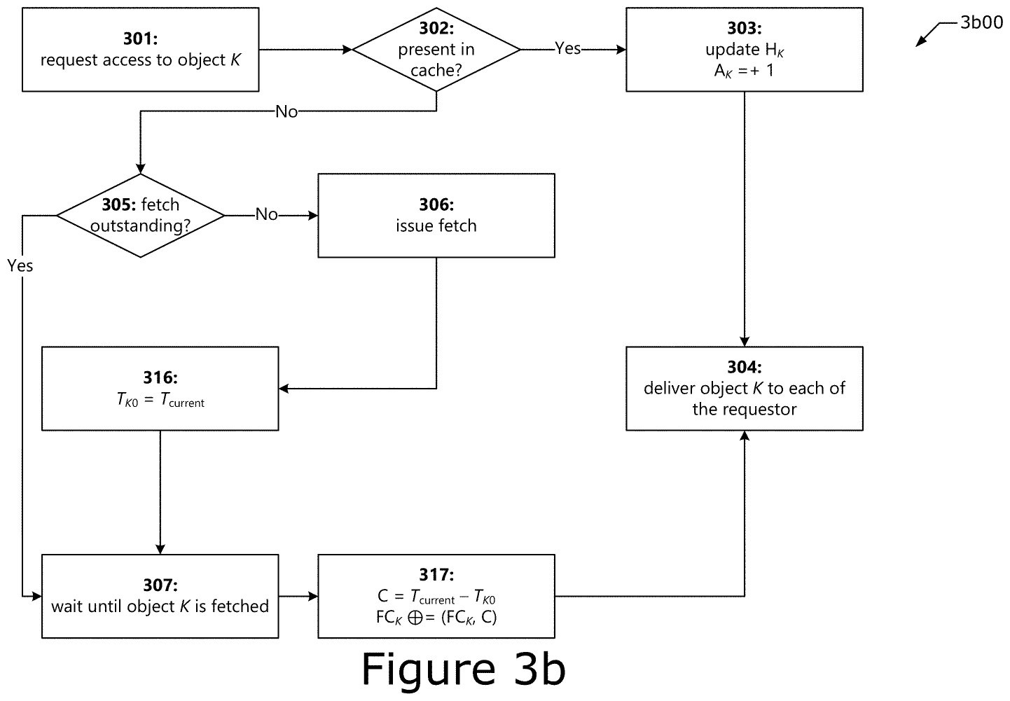

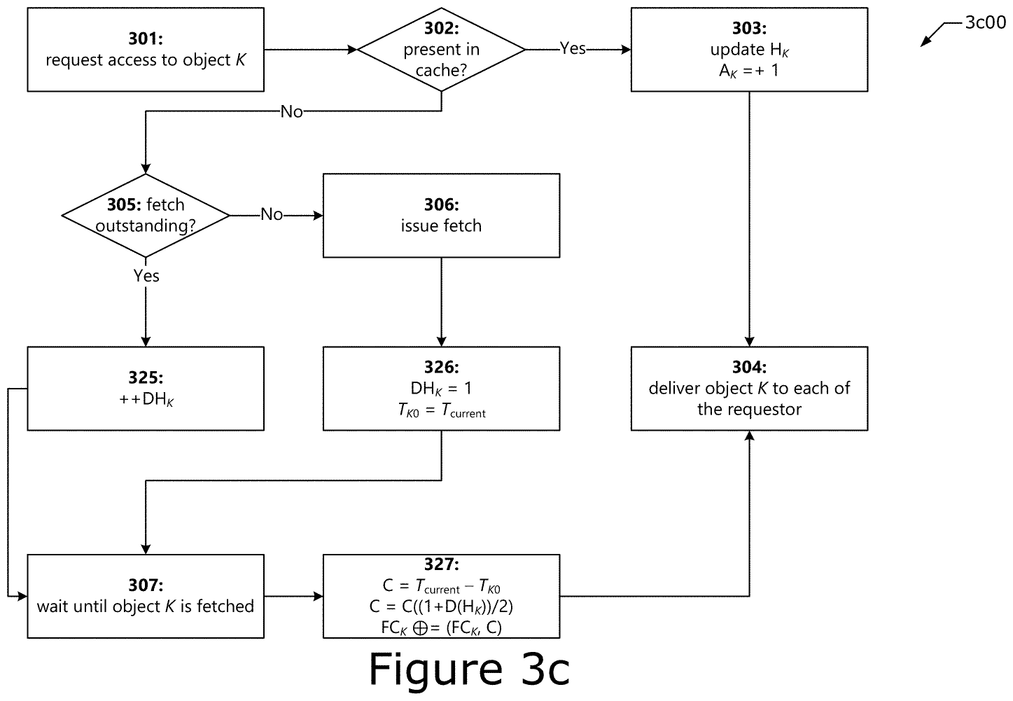

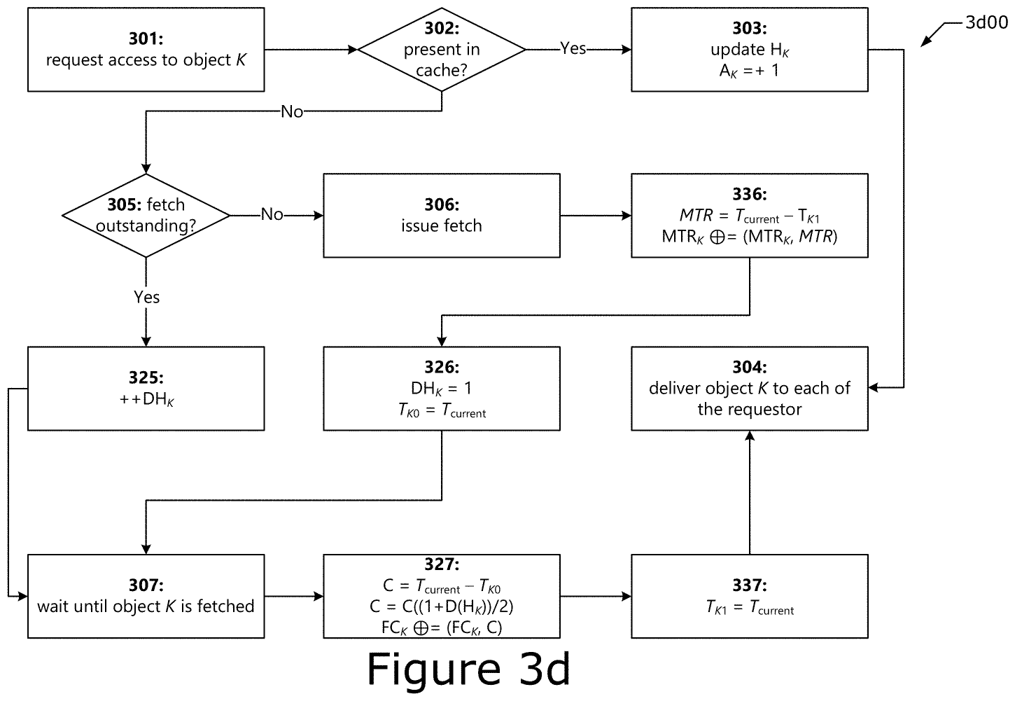

The OMS 160 manages the caching policy at each of the caches and/or storage tiers. As discussed in more detail infra, the OMS 160 handles and/or manages the eviction of objects between and/or among the different storage tiers (see e.g., FIGS. 3a-7). For instance, when the requestor 210 requests an object from any of the NANS 130, edge compute nodes 136, app server(s) 150, and/or cloud service 140, if the content is located in the local caching elements 215, the requestor 210 loads the content directly from its cache. Otherwise, if the content is not in local caching elements 215, then it is retrieved directly from one of the NANS 130, edge compute nodes 136, app server(s) 150, and/or cloud service 140. When the requestor 210 requests an object that is not in the local caching elements 215, the requestor 210 obtains the object and saves a copy of the object in the local caching elements 215, which can then be used to fulfill future requests for that object. The objects may be stored in a cache for a time to live (TTL) interval or until the cache is full. After an object's TTL, the object is usually evicted or removed from the cache. Cache eviction is a feature where objects and/or data blocks in a cache are released, removed, or deleted from the cache according to a cache policy, which creates space for new or alternative objects to be stored in the cache. In various embodiments, the OMS 160 uses multiple caching strategies for managing the caching of objects in the multi-tiered caching architecture 100. The multiple caching strategies are adaptive and based at least in part on access latency based caching policies, rather than only using hit ratios as is the case with conventional caching algorithms that do not account for dynamic situations involving fluctuating bandwidths, latencies, and/or transient outages/failures. The access latency is measured as a cost of both cache misses and delayed hits (DHs) at a particular storage tier. As a result, the OMS 160 provides direct feedback into the utilized caching strategies, implicitly factoring the net effects of multiple causes of latency dilation, not just those of hit or miss ratios.

The OMS 160 makes retention policy decisions informed by latency metrics that are drawn from and aggregated across distributed execution (or distributed applications), including the execution of networking software in network elements such as SmartNICs and/or coordination software in IPUs. These aspects can be provided in specifications, standards, and/or other documentation of software systems, SmartNIC, IPUs, network appliances, and/or other like SW and/or HW implementations. In some implementations, control elements (e.g., graphical user interfaces (GUIs) and/or physical input devices such as those discussed herein) can be used to control aggregate latency thresholds that determine which objects get assigned into which networking/storage tiers. In some implementations, the storage tiers can be defined or specified by a network operator, caching service provider, edge network owner/operation, and/or the like (e.g., by configuring the OMS 160 accordingly). In some implementations, protocol traces and timing analyses can be used to measure object access densities, fetch latencies, and object treatment based on the access densities and fetch latencies, which can be fed back into the OMS 160 for further refinement of object retention/replacement policies for a given storage tier or caching tier.

In some implementations, caching in edge computing networks occurs at multiple points including in or at an edge compute nodes 136, in other co-located infrastructure (e.g., NANs 130), and/or various tiers of storage across the cloud-to-edge continuum (e.g., storage elements between the co-located infrastructure NANs 130 and/or edge compute node 136 and a data center (cloud storage 140). Additionally or alternatively, object replication occurs across multiple storage tiers and within individual storage tiers in high availability and durability deployments.

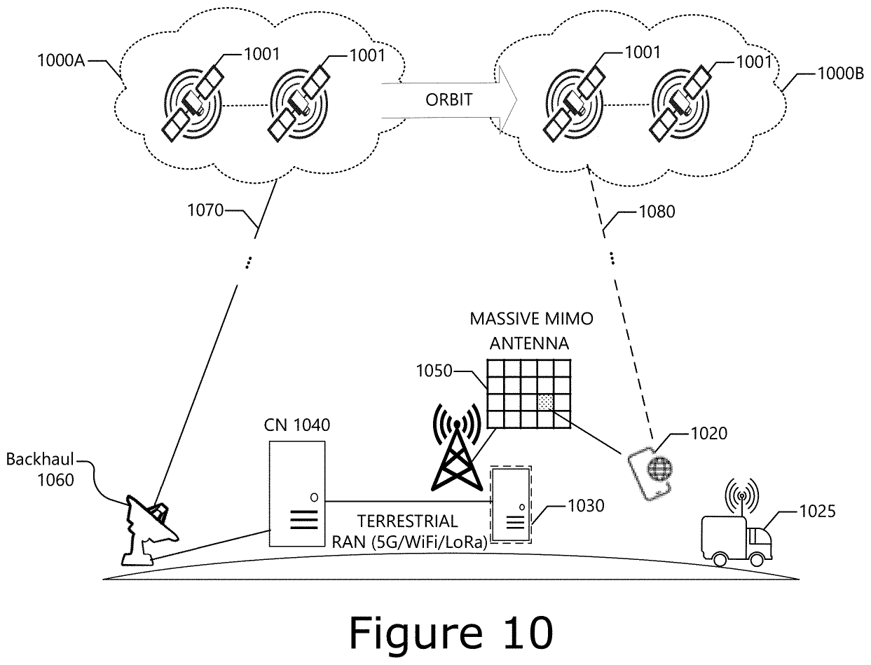

Additionally or alternatively, large capacity far memory pools can selectively cache objects for whom the amplified delays due to high fetch latencies that are excessive. This is particularly necessary for coordinating satellite mediated transfers since delayed hit can be very costly if the outstanding transport for the first miss stretches out because of long durations between re-establishing the communication channels with low earth orbit (LEO) and/or near earth orbit (NEO) satellites and their ground links (see e.g., FIG. 10).

Additionally or alternatively, the OMS 160 can be used to automate the collection of telemetry over delays accumulated by pending requests. In these implementations, the telemetry is used to sort objects into different classes for assigning different storage tiers in local memory/storage hierarchies for aging different classes of objects.

Additionally or alternatively, eviction tailoring utilizes aggregate capacity that is available at a local infrastructure nodes, rather than utilizing a server's individual capacity for caching. In some implementations, this is a second role that can be delegated to the OMS 160.

Additionally or alternatively, caching of remote direct memory access (RDMA)-accessed objects can be automated through OMS 160 connected caches and/or OMS 160 managed shadow caches in dynamic random access memory (DRAM) without complicating application software or RDMA SW stack.

Additionally or alternatively, the OMS 160 can be used to establish dynamic high occupancy bus (HOB) lines/lanes from the target or between an intermediate point and the target when latency critical requests are likely not to be satisfied. The idea is using network e2e telemetry to re-consider routes and potentially discover and establish alternate routes with bandwidth and latency enforcement. The HOB lines/lanes can be set dynamically by reprioritizing the energy and error correction coding budgets to pack more traffic than usual on highly utilized (e.g., more demanded) chains of hops. Here, if a predetermined or predefined latency goal (e.g., as specified by an SLA or the like) is likely to be missed on a current traffic route, an alternate route that is prioritized for high occupancy is assigned in order to reduce latency for transferring the object. This reassigned HOB line/lane may require more energy and/or more error correction budget.

FIG. 2 shows an example caching system scenario 200 involving a requestor 210 and multiple storage tiers including a local storage tier 220, a nearby storage tier 230, and a remote storage tier 240. The local storage tier 220 may represent caching elements 215 and/or other storage elements that are local and/or relatively close in distance to the requestor 210. For example, the requestor 210 may be a client application operated by the user device 110 (or compute node 1350 of FIG. 13), and the local storage tier 220 may represent the requestor caching elements 215. Additionally or alternatively, the local storage tier 220 may represent other accessible data stores such as storage devices attached (either wired or wirelessly) to the requestor 210 as a separate peripheral device and/or the like.

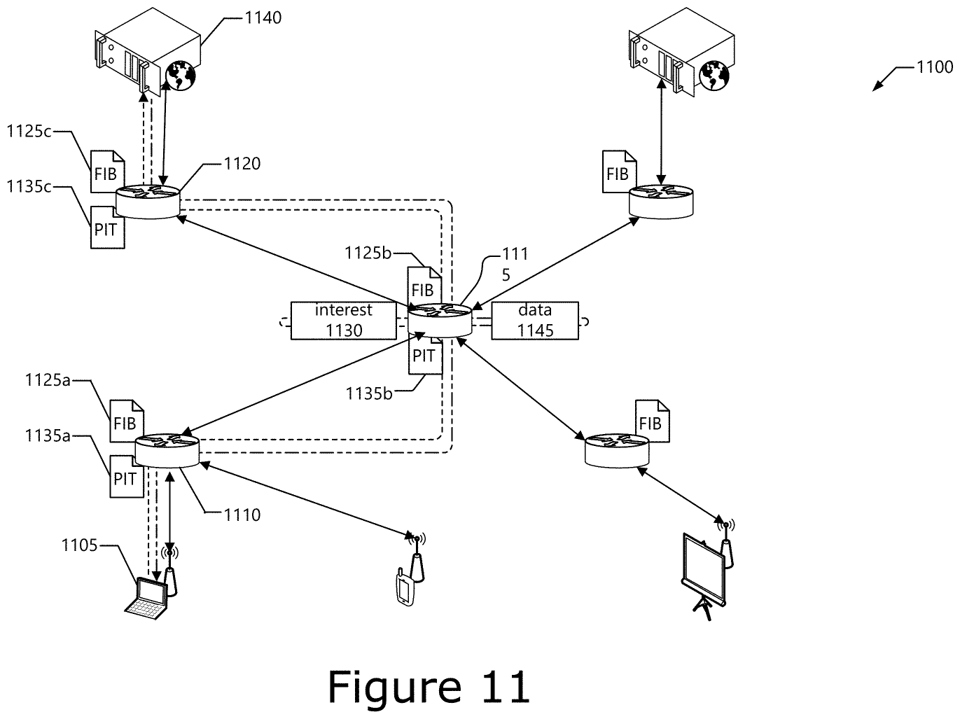

The nearby storage tier 230 (also referred to as “edge storage tier 230” or the like) may represent a storage device or system that is further away from the requestor 210 than the local storage tier 220. For example, the nearby storage tier 230 can be a clique peer in a clique network (or peer node in a peer-to-peer network such as peer endpoint devices 960 in FIG. 9), a network attached storage (NAS), a storage area network (SAN), caching elements 131 at NANs 130, caching elements 137 at one or more edge compute nodes 136, one or more content delivery network (CDN) nodes, one or more information-centric networking (ICN) nodes (see e.g., ICN nodes 1110, 1115, and 1120 in FIG. 11), and/or the like. In some implementations, the NAS,

SAN, caching elements 131, caching elements 137, CDN nodes, and/or ICN nodes are considered part of the nearby storage tier 230 when they are less than a threshold distance away from the requestor 210 and/or less than a threshold number of network hops away from the requestor 210.

The remote storage tier 240 (also referred to as “cloud storage tier 240” or the like) may represent a storage device or system that is further away from the requestor 210 than the nearby storage tier 230. For example, the remote storage tier 240 can be caching elements 131 at NANs 130, caching elements 137 at one or more edge compute nodes 136, one or more CDN nodes, one or more ICN nodes (see e.g., ICN nodes 1110, 1115, and 1120 in FIG. 11), a SAN, caching elements 151 at one or more app server(s) 150, cloud storage 140, and/or the like that are more than a threshold distance and/or a threshold number of network hops away from the requestor 210. In another example, the remote storage tier 240 can be divided into multiple sub-storage tiers according to the distance between the requestor 110, different (logical or physical) storage systems in the remote storage tier 240, overall available storage capacity or space of different (logical or physical) storage systems, subscriptions that the requestor 210 has with different cloud storage services, and/or the like.

Additionally or alternatively, one or more of the storage tiers may be further divided into two or more additional storage tiers (or sub-storage tiers), which may be classified according to performance metrics such as, for example, access speed, communication speed, storage space, and/or other like criteria. For example, the local storage tier 220 may be further divided into a first sub-storage tier including internal memory (e.g., the requestor's 210 processor registers and/or cache memory), a second sub-storage tier including system memory (e.g., main memory and/or primary storage), a third sub-storage tier including internal/embedded storage device(s) (e.g., disk and/or secondary storage), and a fourth sub-storage tier including peripheral-based storage devices (e.g., direct attached storage (DAS), nearline and/or tertiary storage). Additionally or alternatively, the first sub-storage tier can be further subdivided into additional sub-storage tiers for different levels or cache memory (e.g., level 0 (L0) cache through level 4 (L4) cache), and/or the like. The storage tiers 220, 230 and/or 240 can be divided into multiple sub-storage tiers in additional or alternative ways based on the particular implementation and/or use case involved. In various implementations, the OMS 160 may be responsible for allocating different caches to different storage tiers.

In scenario 200, a request 201 for an object is sent to a local storage tier 220 by requestor 210, which misses in local storage tier 220 and is satisfied by nearby storage tier 230. The nearby storage tier 230 provides a response 201′ to requestor 210 that includes the requested object (also referred to as “accessed object 201”). Additionally, a request 208 misses in both the local storage tier 220 and the nearby storage tier 230, and must be satisfied by the remote storage tier 240. The remote storage tier 240 provides a response 208′ to requestor 210 that includes the accessed object 208′. While request 201 is outstanding, requests 202, 203, and 204 are hits at the local storage tier 220, and arrive for the same object 201′ as requested by request 201 (e.g., accessed objects 202′, 203′, and 204′ are the same data as accessed object 201′), and are each satisfied soon after the fetch is completed for request 201. Subsequently, requests 205, 206, and 207 arrive at the local storage tier 220, each of which gets its data locally as accessed objects 205′, 206′, and 207′. Even though accessed object 201′ is not as far away from the requestor 210 as accessed object 208′, due to the dependencies of accessed objects 202′, 203′, and 204′ on the same data, the total performance degradation due to accessed objects 201′, 202′, 203′, and 204′ add up or otherwise accumulate. Conversely, even though the frequency of access to accessed object 208′ may be relatively low, and accessed objects 205′, 206′, and 207′ are hot data (e.g., relevant or objects that are likely to be requested) that are retained and have low latencies of access, the computation that uses accessed objects 205′, 206′, and 207′ is forced to push itself out due to its dependency on accessed object 208′. As discussed in more detail infra, the caching mechanisms discussed herein give greater credit to object 208′ for having to travel a longer distance in order to arrive at the requestor 210, during which time, there was evidence of other requests and/or other requestors 210 suffering delayed hits.

As mentioned previously, caching improves performance by keeping recent or often-used data items in memory locations that are faster or computationally cheaper to access than other memory/storage locations or devices. When the cache is full, a caching algorithm chooses which items in the cache to discard to make room for new objects. Conventional caching algorithms are based on variations of least-recently-used (LRU), which is a practical way of displacing or replacing objects that are likely to have the highest time to reuse. Variations of LRU include approximate LRU, clock replacement, weighted LRU, set-associative LRU, time-aware LRU (TLRU), and the like. Other caching algorithms include least frequently used (LRU) algorithms that replace cached objects based on popularity or frequency of accesses. Various other caching systems use cost-based displacement, where cost is a measure of the latency, bandwidth, and computational effort incurred while acquiring an object. In these systems, objects with a highest cost are retained the longest and heuristics are used to give each factor a weight so that recency, frequency, cost, and other factors. For purposes of the present disclosure, the various metrics or factors (or combination or metrics/factors) used to retain or evict objects from a cache are referred to as a “figure of merit” for retaining an object (or referred to as a “cache figure of merit”). However, these conventional cache replacement algorithms require constant, non-obvious tuning and/or profiling, which can be error prone or non-optimal based on changes in the computing environment. Additionally, the conventional caching algorithm strategies do not consider the complex problem of delayed hits.

[Atre] discusses a Minimum Aggregate Delay (MAD) caching algorithm that accounts for latencies suffered by requests that arrive under the shadow of a miss, when shaping the object displacement decisions at a given server. In particular, the MAD caching algorithm derives a ranking function from belatedly by modeling an object's future ‘aggregate delay’. This ranking function empirically approximates decisions made by a caching algorithm called “belatedly,” which is an offline caching algorithm designed by [Atre] to minimize latency given delayed hits. MAD then uses a delay heuristic that can be used to make traditional caching algorithms aware of delayed hits.

The embodiments discussed herein use multiple caching strategies in distributed processing, distributed computations, and/or the like. The multiple caching strategies range from adaptive to latency (e.g., the directly experienced cost of both misses and delayed hits) based caching policies, rather than only using hit ratios as is the case with conventional caching algorithms that do not account for dynamics situations involving fluctuating bandwidths, latencies, and/or transient outages/failures. As a result, the OMS 160 provides direct feedback into the utilized caching strategies, implicitly factoring the net effects of multiple causes of latency dilation, not just those of hit or miss ratios.

1.1. Example Latency-Responsive Caching

FIGS. 3a, 3b, 3c, and 3d depict example caching statistics collection processes. FIG. 3a illustrates shows a first caching statistics collection process 3a00, which begins at operation 301 where the OMS 160 requests access to an object K (or issues a command to access object K). The request may be for any type of data including a database object, an information object, and/or the like. At operation 302, the OMS 160 determines whether object K is present in a cache. If object K is present in the cache, object K is accessed from the cache and at operation 303, a hit counter for object K (e.g., “H_{K}”) is updated, and an access bit corresponding to the object K (e.g., “A_{K}”) is set to indicate that it has been accessed recently. In some implementations, H_{K} can represent the number of hits for object K or a hit ratio of object K. In some implementations, H_{K} is a saturating counter. At operation 304, object K is delivered to the requesting entity. In one example, each object or memory slot in the cache may be associated with a corresponding bit, which indicates that a corresponding object (or an object in the corresponding slot) is accessed or not accessed. The collection of these access bits may be referred to as an “access bitmap” or the like. Additionally, a clock or timer can be used to periodically (re)set all the access bits to zero, where is objects or slots whose access bits are already set to zero before expiration of the clock or timer can be evicted from the cache when the clock or timer expires. This is because those objects were not accessed within a threshold amount of time (e.g., the value of the timer/clock).

If at operation 302 the OMS 160 determines that object K is not present in the cache, then at operation 305 the OMS 160 determines whether a fetch/request for object K is pending or outstanding. If a fetch or request is not outstanding, then at operation 306 the OMS 160 issues a request for object K and/or a fetch or access command, and then proceeds to operation 307 to wait until object K is fetched. Then, the OMS 160 proceeds to operation 304 to deliver the object K to the requesting entity. If at operation 305 the OMS 160 determines that a fetch/request for object K is outstanding (or already in progress), then the OMS 160 proceeds to operation 307 to wait until object K is fetched, and then proceeds operations 307 and 304.

FIG. 3b shows a second caching statistics collection process 3b00, which includes operations 301-307 and adds some additional operations. In process 3b00, operations 301-306 are performed by the OMS 160 as discussed previously with respect to process 3a00 of FIG. 3a. In process 3b00, after the fetch/request is issued at operation 306, the OMS 160 proceeds to operation 316 to record the time of the start of the fetch (e.g., setting a variable T_{K0} to the current time (T_{current})), and then proceeds to operation 307 to wait until object K is fetched. After operation 307, the OMS 160 proceeds to operation 317 to measure the fetch time and aggregates it into a fetch cost for the object (e.g., FC_{K}) as shown by equation 1, effectively measuring a rolling indicator of latency for accessing object K. The fetch time is the amount of time it takes to complete the fetch (e.g., a difference between a current time and the time that the fetch command was issued). In other words, if the issued fetch is a first fetch (e.g., operations 305 to 306), then a time when object K was first missed is recorded (e.g., operation 316). The total duration of time for which object K was missed is the difference in the time that object K was first missed and the time that object K was obtained. In some implementations, the fetch cost (FC) is a mean weighted average cost (MWAC) (e.g., MWAC_{K}). As examples, the MWAC can be calculated using a simple moving average (SMA), cumulative average (CA), weighted moving average (WMA), exponential moving average (EMA), exponentially weighted moving average (EWMA), modified moving average (MMA), running moving average (RMA), smoothed moving average (SMMA), a moving average regression model, and/or the like. Such aggregation, even though it is shown here for a single object K, may actually be performed against some distinctive collection, or class, to which the object belongs.

C=T_{current}−T_{K0}

FC_{K}⊕(FC_{K},C) [equation 1]

In equation 1, C is the fetch duration (e.g., the amount of time it took to complete the fetch), T_{current} is the current time, T_{K0} is a time (timestamp) that the fetch/request for object K was issued, FC_{K} is the fetch cost of object K, and the symbol “s” represents a moving average or moving window average (e.g., EMWA and/or the like) into which a new value of C is being aggregated. Additionally or alternatively, the symbol “s” is an aggregation operator over the fetch cost (FC_{K}). After operation 317, the OMS 160 proceeds to operation 304 to deliver the object K to the requesting entity.

FIG. 3c shows a third caching statistics collection process 3c00, which includes operations 301-307 and adds some additional operations. In process 3c00, operations 301-305 are performed by the OMS 160 as discussed previously with respect to process 3a00 of FIG. 3a. In process 3c00, if at operation 305 the OMS 160 determines that a fetch/request for object K is outstanding (or already in progress), then the OMS 160 proceeds to operation 325 to count the number of outstanding or pending requests or delayed hits (DH) for object K, and then the OMS 160 proceeds to operation 307. Additionally or alternatively, at operation 325 the OMS 160 counts the total number of misses after a first fetch/request is issued. When there are no outstanding fetches at operation 305, and after the fetch/request is issued at operation 306, the OMS 160 proceeds to operation 326 to set a DH counter to 1, record the time of the start of the fetch in a same or similar manner as discussed previously with respect to operation 316 of FIG. 3b, and then proceeds to operation 307. After waiting until the object K is fetched at operation 307, the OMS 160 proceeds to operation 327. At operation 327, the OMS 160 updates the FC with an average amount of time that each of the subsequent requests/requestors 210 is incurred as shown by equation 2.

$$C = {T}_{c u r r e n t} - {T}_{K 0} \\ C = C ( \frac{( 1 + D ( {H}_{K} ) )}{2} ) \\ F {C}_{K} ⊕ = ( F {C}_{K} , C ) \qquad [ equation 2 ]$$

In equation 2, D (H_{K}) is the number of DHs for object K (or a value of the DH counter for object K). In this example, an average amount of time that each of the subsequent requests/requestors 210 is incurred is used to update the FC. In other implementations, one or more other metrics may be used such as, for example, a probabilistic sample from some measure that is distributed around the average and/or other like metrics or measurements, such as those discussed herein. At operation 327, instead of only accummulating the FC (e.g., SMA, CA, WMA, EMA, EWMA, MMA, RMA, SMMA, and/or the like) over fetch latencies as in process 3b00 of FIG. 3b, the OMS 160 aggregates an FC over the latencies experienced by both the first miss and subsequent DHs. Operational path 305-325-307-327 accounts for requests/fetches that take place after an initial fetch/request are likely to experience a DH between a maximum delay and a minimum delay. In operation 327, the expression “C=C ((1+D(H_{K}))/2)” of equation 2 assigns a unit multiplier to the first miss, and a fractional multiplier to all subsequent DHs. This is because the first miss is setting D(H) to 1 in operation 326. After operation 327, the OMS 160 proceeds to operation 304 to deliver the object K to the requesting entity.

FIG. 3d shows a fourth caching statistics collection process 3d00, which includes operations 301-307 and operations 325-327 discussed previously with respect to FIG. 3c, and also includes additional operations for computing a mean time to reuse (MTR). In process 3d00, after a fetch/request is issued at operation 306, the caching mechanism proceeds to operation 336 to calculate an MTR based on the current time (T_{current}) and a timestamp of when object K entered (e.g., was first stored in) the cache (T_{K1}) as shown by equation 3.

MTR=T_{current}−T_{K1}

MTR_{K}⊕=(MTR_{K},MTR) [equation 3]

In equation 3, MTR is the mean time to reuse, T_{current} is the current time, T_{K1} is the time (timestamp) that object K was stored in the cache, MTR_{K} is the MTR of object K, and the symbol “s” is a moving average or moving window average (e.g., a time-series aggregation operation for an average and/or the like) operator into which a new value of MTR_{K} is being aggregated. Here, the MTR is not counted for every object in the cache because each cached object is considered as being used while it is in the cache. Instead, the MTR is calculated for the first object to get a cache miss right after that object has been evicted from the cache.

The MTR is calculated for object K by tracking the time between the last time object K was accessed and a subsequent time when it was accessed after not having been found (operation 336). This time difference is aggregated into MTR_{K} to track object K's MTR, and in particular, the collection of object K's MTR. In some implementations, the time difference between the last time object K was accessed and the subsequent time when it was accessed after not having been found is aggregated using SMA, CA, WMA, EMA, EWMA, MMA, RMA, SMMA, and/or the like.

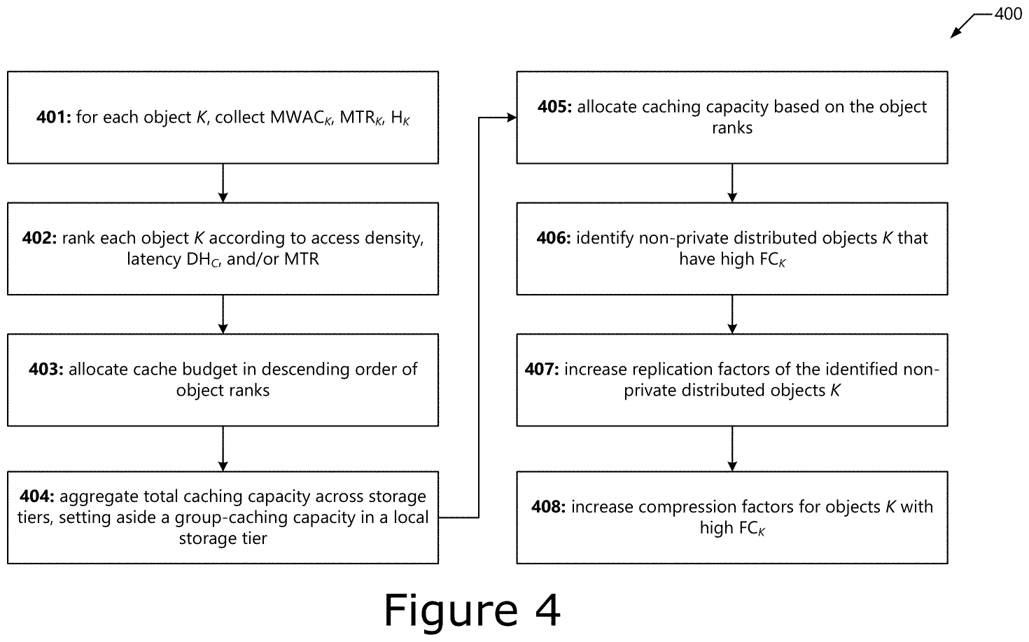

The processes of FIGS. 3a, 3b, 3c, and 3d allow the OMS 160 to collect caching statistics, namely the FCs, DHs, and MTRs of requested objects. This includes determining an FC of the original miss latencies compounded with DH latencies for each miss latency, and determining an FC over MTR. In addition, the OMS 160 may separately collect the number of hits or a hit ratio for accesses that do not reach the OMS 160 because of the locally satisfied hits. The collected statistics from FIGS. 3a-3d are used in the caching process of FIG. 4.

FIG. 4 shows an example cache scaling process 400. The OMS 160 performs the cache scaling process 400 to scale the caching approach because the number of cached objects can become relatively large over time. Rather than using an eviction strategy on an object-by-object basis, the cache scaling process 400 is used to group or cluster objects and assign capacity in different storage tiers to different object groups or clusters. Additionally, the cache scaling process 400 is used to replicate objects that have a high cost of cache misses due to delayed hits and first cache misses.

Process 400 begins at operation 401 where, for each object K, the OMS 160 collects the FC_{K} (e.g., FIGS. 3b-3c), MTR_{K} (e.g., FIG. 3d), and H_{K}, which may be a number of cache hits for object K and/or a hit ratio for object K (e.g., FIGS. 3a-3d). At operation 402, the OMS 160 ranks the objects according to their access density, latency and/or DH cost, and MTR. The access density is a ratio of the size of an object to the frequency that object is accessed or requested. In one example, the access density of an object is the number of accesses per byte of the object (e.g., number of accesses/byte). The manner in which the objects are ranked using these metrics can be implementation specific. In some implementations, a policy function can be used to give objects different ranks according to their access density, latency and/or DH cost, and MTR. In one example, the access density, latency/DH cost, and MTR of each object can be normalized and combined with respective weights to obtain a value that is comparable against other objects (e.g., rank=α(accessDensity)×β(DHcost)×γ(MTR)). In another example, a ratio of the latency/DH cost to MTR can be used as part of the ranking process. In this example, a ratio of the latency/DH cost to MTR of an object is a measure of the object's figure of latency merit for retention (FLMR), which may be expressed as shown by equation 4.

$$F L M R = \frac{D {H}_{C}}{M T R} \qquad [ equation 4 ]$$

In equation 4, DH_{c} is the latency/DH cost. Here, a higher MTR (e.g., denominator in equation 4) favors not retaining the object in the cache, while a higher mean compounded cost of miss and DHs (e.g., numerator in equation 4) favors retaining the object in the cache. Ranking the objects allows for prioritizing local or nearby caching resources (e.g., tiers 220 and/or 230 in FIG. 2) in line with their relative FLMR (see e.g., operation 403). However, in some implementations, this ranking is applied, not for separately allocating cache space in each computer node, but as discussed infra.

At operation 403, the OMS 160 allocates a flat cache budget in descending order of the ranks. In operation 403, the highest ranked objects will be placed in the front of the cache and the lowest ranking objects will go to the bottom/end of the cache, according to their according to their total capacity needs.

At operation 404, the OMS 160 aggregates a total caching capacity across the storage tiers 220, 230, and 240, setting aside a group-caching capacity in relatively close storage tiers (e.g., local storage tier 220 and/or nearby storage tier 230). Here, the OMS 160 coalesces and/or aggregates the total caching capacity and then assigns it across the cached objects K. This allows for cooperative caching across the aggregate capacity available in a given storage tier among a set of proximal compute nodes (e.g., servers, client devices, and the like) that may share a far memory pool (e.g., remote storage tier 240). However, a small amount of capacity is carved out of this aggregate capacity as an allocation for local caching (e.g., the aforementioned group-caching capacity). This is to ensure that each compute node caches its recently or frequently accessed objects across its own local caching hierarchy to minimize the time to serve each cache hit. In other words, operation 404 involves determining a preference for different storage tiers for each ranked object.

At operation 405, the OMS 160 allocates caching capacity based on the object ranks. In some implementations, the capacity is allocated to individual requestors 210 according to the ranks of the objects that they request. The OMS 160 can use an optimization function (e.g., a cost function or loss function) to resolve the object ranks into the amount of capacity reserved for individual requestors 210 that access objects whose ranks have different priorities against the local storage tiers 220 and nearby storage tiers 230. Additionally or alternatively, the OMS 160 maximizes a best match function to allocate a proportionally higher fraction in upper storage tiers to high ranking cached objects.

At operation 406, the OMS 160 identifies non-private distributed objects K that have a relatively high FC_{K}. Here, “non-private” refers to objects that are requested by multiple requestors 210 (e.g., multiple machines), which are likely to traverse multiple paths to the multiple requestors 210 over time, and as such, non-private distributed objects tend to have a high cost of replacement. In this example, the high cost of replacement is reflected in the FC_{K}, which includes both costs of first miss and DH_{c}. At operation 407, the OMS 160 increases the replication factors of the non-private distributed objects K identified in operation 406. In some implementations, the OMS 160 increases the far-edge and near-edge replication factors for the identified non-private distributed objects K with a relatively high FC_{K}. The “near-edge” is the storage tier closest to the cloud 844 (e.g., storage tiers 230 or 240), and “far-edge” is the edge closest to the requestors 210 (e.g., storage tier 220).

Operations 406 and 407 involve identifying objects that are shared across different requestors 210 that have a high cost of replacement (e.g., relatively high FC_{K} and/or relatively high FLMR), and assigning a high replication factor to those objects K. Cache replication involves generating and copying (or replicating) data and storing those copies (replications) to other storage elements in one or more storage tiers (or clusters). The replication factor is the number of copies (or replications) of an object that will be stored in one or more storage tiers. The objects identified in operation 406 not only experience a very high amount of eviction, but they also have a large number of correlated accesses. That is, these objects might not be requested for a long time, resulting in an eviction, but when they are requested again, numerous requests come in and they all suffer the cost of bringing the object back into the cache. As the OMS 160 obtains objects K from nearby storage tiers 230 and/or far storage tiers 240 based on local storage tier 220 misses, the OMS 160 also obtains a latest FC_{K} and/or FLMR values from the sources from which it obtains those objects K, along with the replication factors applied to those objects K. Increasing the replication factors allows these objects to be retained longer in order to effectively increase their dynamic replica counts in near-edge and far-edge buffer pools.

At operation 408, the OMS 160 increases compression factors for objects K with relatively high FC_{K}. Increasing the compression factor may involve using a more demanding compression algorithm or compressing the objects more than other objects. Here, the OMS 160 uses high compression factors for objects with a relatively high FC_{K} and/or FLMR so that more of those objects K can be packed into available local storage tiers 220 and/or nearby storage tiers 230.

Additionally, the OMS 160 may distribute these objects K with consistent hashing across set-aside group-caching capacity. Consistent caching is used to distribute load among a set of caching nodes of one or more storage tiers (e.g., caching servers and/or the like). That is, given the data to be cached, consistent hashing uses a cache key to determine the caching node(s) that stores the cached data.

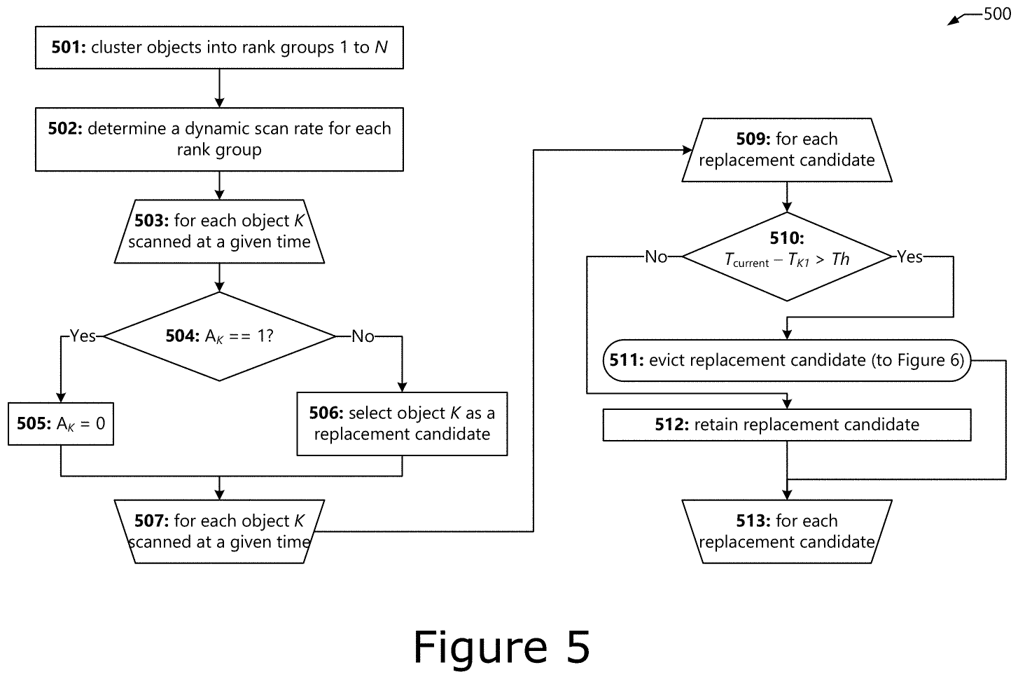

FIG. 5 shows a storage tier selection process 500 that can be performed by the OMS 160. The OMS 160 performs the storage tier selection process 500 to select the specific storage tiers for caching objects. Similar to process 300, in process 500 the OMS 160 clusters objects into various rank groups (e.g., 1 to N rank groups, where N is a number), and then determines a dynamic scan rate for each object rank group.

Process 500 begins at operation 501 where the OMS 160 groups or clusters objects K into 1 to N clusters or groups (where N is a number of groups or clusters). The clusters or groups may also be referred to as rank groups because the objects are being ranked with respect to one another. The objects K are assigned different ranks and are placed into a smaller number of rank groups, according to their newly assigned ranks (e.g., newly assigned in comparison to the ranks assigned to the objects in process 400 of FIG. 4). The rankings in this example are used to determine how long an object should be retained in the cache such that objects belonging to higher ranking groups will be retained in cache longer than objects belonging to lower ranking groups.

At operation 502, the OMS 160 determines a dynamic scan rate for each object group/cluster. A scan rate is the rate at which the OMS 160 identifies objects K for eviction from the cache, and in some implementations, can also include the process of eviction itself. The dynamic scan rate is a scan rate that changes over time and/or in response to an event. In some implementations, the dynamic scan rate is the mean time between scanning the same object K. In one example, the scanning is done according to a clock algorithm, where the OMS 160 inspects or analyzes all objects in each rank group in a round-robin fashion to identify the objects that should be evicted. Here, objects in a group/cluster are periodically scanned for eviction. In some implementations, the unused objects in higher performance levels are evicted sooner into a lower storage tier or an outer tier (e.g., further from the requestor 210) if they are not hot enough.

Operations 503-513 involve analyzing each object K in each rank group according to the scan rate of each rank group in order to determine which objects K should be evicted from the cache. At open loop operation 503, the OMS 160 processes each object K, in turn, and perform operations 504, 505, and 506 for each object K examined at a given time (e.g., according to the dynamic scan rate of the group/cluster to which the object belongs). In some implementations, at each step in a clock-aging algorithm the OMS 160 selects non-recently accessed objects at the time of the scan as potential displacement (replacement) candidates. Operations 504, 505, and 506 are performed for selecting non-recently accessed objects K at the time of a scan as potential displacement (replacement) candidates. At operation 504, the OMS 160 determines whether the access bit of an object K (A_{K}) is set or enabled (e.g., has a value of 1). If the object K's access bit is enabled, then the access bit is disabled or inactivated (e.g., set to have a value of 0) at operation 505. If the access bit of the object K (A_{K}) is not set (e.g., has a value of 0), then at operation 506 the OMS 160 selects the object K as a replacement candidate. At close loop operation 507, the OMS 160 proceeds back operation 503 to process a next object K, if any.

After all of the objects K are processed, the OMS 160 proceeds to open loop operation 508 to process each replacement candidate, in turn, and performs operations 510, 511, and 512 for each replacement candidate. Operations 510, 511, and 512 are performed for checking a displacement (replacement) candidate against a threshold for when it was last reference (e.g., a dynamic group time threshold (Th)). The dynamic group time threshold can be different for different rank groups such that groups with higher ranks have a higher dynamic group time threshold than groups with lower ranks. This check is used to resist evicting objects too soon by considering their rank group. In some implementations, the threshold itself is not fixed, as it may need to vary dynamically according to contention for capacity in a given storage tier. Because the threshold is used for checking all objects in a given rank group, this reduces the likelihood that excessive bias is applied against any given object K just because it happens not to have registered a recent access.

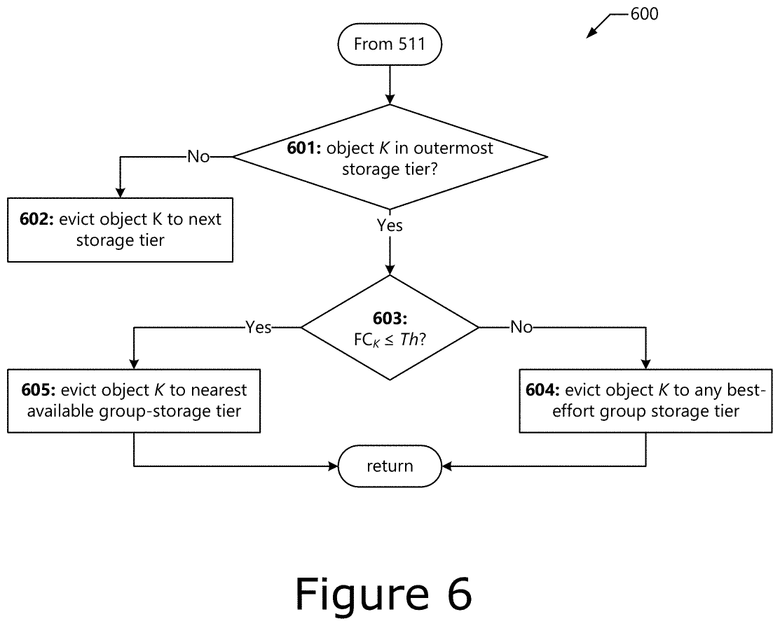

At operation 510, the OMS 160 determines whether a the MTR of the replacement candidate (e.g., difference between the current time (T_{current}) and a timestamp of when the replacement candidate entered (e.g., was first stored in) the cache (T_{K0}) is greater than the difference between a dynamic group time threshold (Th). If the MTR of the replacement candidate is greater than the dynamic group time threshold (Th), then the replacement candidate object is evicted at operation 511 (see e.g., FIG. 6). If the MTR of the replacement candidate is lower than the dynamic group time threshold (Th), then the replacement candidate object is not evicted (e.g., retained) at operation 512. At close loop operation 513, the OMS 160 proceeds back operation 509 to process a next replacement candidate, if any. After all of the replacement candidates are processed, the OMS 160 may end or repeat the process as necessary.

FIG. 6 shows an example storage tier eviction process 600, which can be performed by the OMS 160 for each object K selected as a replacement candidate for eviction (see e.g., operations 509-511 of FIG. 5). In process 600, the OMS 160 determines where to evict an object K. Based on the object K's aggregated latency cost, the object K is either evicted to a nearby storage tier or to a best effort storage tier. This ensures that objects whose value for retention abates over time do not crowd out objects with a relatively high or rising FCs and/or FLMRs.

Process 600 begins at operation 601 where the OMS 160 determines whether the object K (e.g., from operation 511 of FIG. 5) is located in an outermost storage tier (e.g., remote storage tier 240). If the object K is not located in the outermost storage tier, then the OMS 160 proceeds to operation 602 to evict the object K to a next outer storage tier. Here, “outermost” refers to a distance from the requestor 210 to the storage tier. For example, if the object K is located in the local storage tier 220, then the object K may be evicted to a next outer storage tier, which is the nearby storage tier 230 in the example of FIG. 2.

If the object K is located in the outermost storage tier (e.g., remote storage tier 240), then the OMS 160 proceeds to operation 603 to determine if the FC of object K (FC_{K}) is less than or equal to a threshold, which may be the same or different than the dynamic group time threshold (Th). If the FC_{K} is less than or equal to the threshold, then the OMS 160 proceeds to operation 604 to evict object K to any best effort storage tier. The best effort storage tier may be a first available storage tier that has space to store the object. If the FC_{K} more than the threshold, then the OMS 160 proceeds to operation 605 to evict object K to a nearest available storage tier. The nearest available storage tier may be any storage tier, further from the requestor 210 than the present storage tier, that has available capacity to store the object. After operations 604 and 605, the OMS 160 returns back to caching process 500.

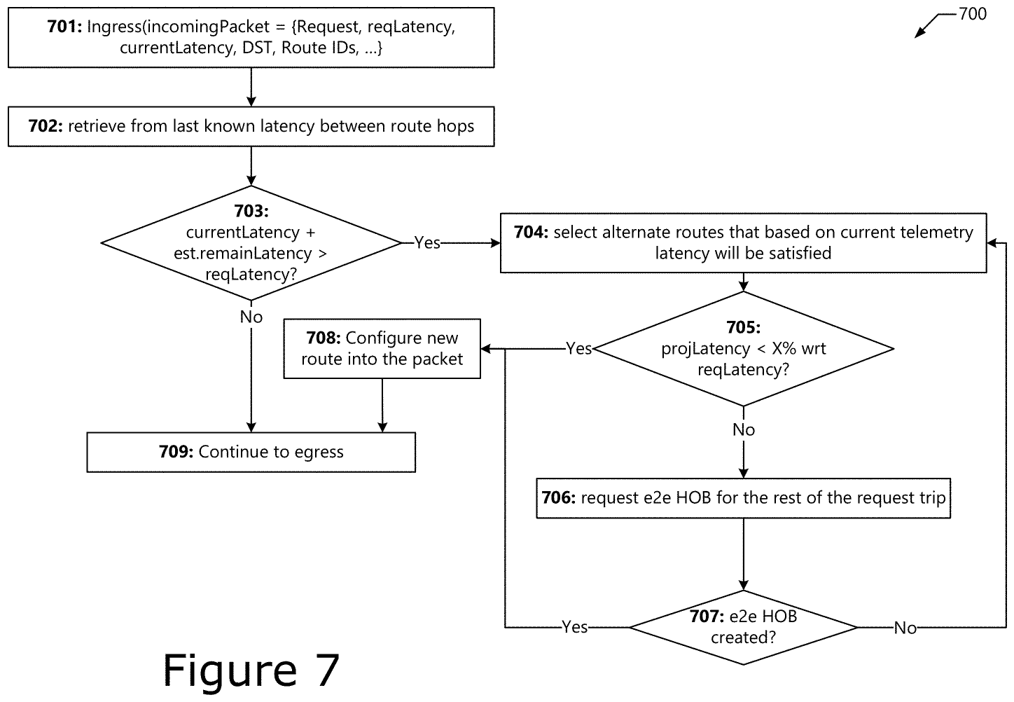

FIG. 7 depicts an example infrastructure interplay process 700. In various implementations, infrastructure equipment (e.g., network access nodes (NANs), SmartNICs, DPUs/IPUs, switches, and/or the like) can be used to establish dynamic HOB lines from a target (destination) node and/or between an intermediate node (e.g., a hop between the target and source nodes) and the target node when latency critical requests are likely not to be satisfied. In these implementations, the infrastructure equipment uses network end-to-end (e2e) telemetry to re-consider existing traffic routes/paths, and potentially discover and establish alternate routes with bandwidth and latency enforcement. As mentioned previously, the HOB lines/lanes can be set dynamically by reprioritizing the energy and error correction coding budgets to pack more traffic than usual on highly utilized (more demanded) chains of hops. In various implementations, HOB lanes are implemented by a switch hierarchy (which may be, or may be part of the storage tier hierarchy). Here, some or all switches on the architecture can provide real-time telemetry on the occupation that it is experiencing for each of the connections it has. This telemetry can be broadcasted or multicasted to the other switches of the architecture. Note that broadcast or multicast can be implemented in federated way. In one example, the telemetry is broadcast by an individual switch to a set of switches that are part of (or within) a certain radius from a location of the individual switch. When a given packet crosses a particular switch, the particular switch will select a next switch based on a routing table that indicates different routes to arrive at a certain target and the utilization of the links that need to be crossed to get to that destination. Additionally or alternatively, drive pathfinding activities within a team in order to drive new directions from the system architecture perspective. The packet can trace the different hops that it is routing packets through or over. Once a packet traverses from an origin to a target, the packet and the latency that has been achieved is included in an SLA or some other data structure. The feedback on the route is then provided to the original sender. Therefore, the next packets will include the pre-discovered HOB lane. It may dynamically change if the current HBO lane experiences that degradation of SLA, which would be identified at the target. The target would require the sender to rest the HOB lane and perform the HOB creation again based on the current telemetry

The infrastructure interplay process 700 begins at operation 701 where an ingress packet (incomingPacket) arrives at an infrastructure equipment. The ingress packet includes, for example, a request (e.g., a request to access a cached object), a required latency (reqLatency), a current latency value (currentLatency), a destination network address (DST), route identifiers (IDs) for one or more hops along the packet route, and/or other like information. The required latency (reqLatency) may be the required timing requirements for delivering the ingress packet. In some implementations, the required latency (reqLatency) can include, or be based on, for example, QoS class, forwarding treatment information, minimum and/or maximum guaranteed bit rate (GBR), reliability data, ultra-reliable low latency communications (URLLC) configurations/data, and/or the like. As examples, objects that can have latency requirements include smart factory/industrial automation (e.g., industrial control, process control, robotics, machine-to-machine communications, and the like), manufacturing (e.g., motion control, remote control, augmented reality (AR), virtual reality (VR), and the like), healthcare (e.g., remote diagnosis, emergency response communications, remote surgery, and the like), entertainment (e.g., immersive gaming such as AR, VR, online and/or interactive gaming, isochronous video, and the like), transportation (e.g., driver assistance applications, autonomous driving applications, enhanced safety, traffic management, and the like), energy sector (e.g., smart grid, smart energy delivery, and the like), and financial sector (e.g., real-time trading, and the like). At operation 702, the infrastructure equipment retrieves or otherwise identifies the last known latency between individual hops along the packet's route based in part on the information contained in the ingress packet.

At operation 703, the infrastructure equipment determines whether the current latency and an estimated remain latency (e.g., currentLatency+est.remLatency) is more than the required latency (reqLatency) indicated by the ingress packet. If the current latency and estimated remain latency (e.g., currentLatency+est.remLatency) is lower than the required latency (reqLatency), then the infrastructure element proceeds to operation 709 to continue to egress (e.g., forward the ingress packet to an egress node and/or toward the destination node).

If at operation 703 the current latency and estimated remain latency (e.g., currentLatency+est.remLatency) is more than the required latency (reqLatency), then the infrastructure element proceeds to operation 704 to select one or more alternate routes that are likely to satisfy the latency requirements of the ingress packet based on current telemetry/statistics. Then, at operation 705, the infrastructure equipment determines whether a new projected latency (projLatency) is greater than a percentage (X %, where X is a number) with respect to (wrt) the required latency (reqLatency). If the new projected latency (projLatency) is greater than the percentage (X %) of the required latency (reqLatency), then the infrastructure element proceeds to operation 708 to configure the new route for the packet, and then continues to egress at operation 709.

If at operation 705 the new projected latency (projLatency) is not greater than the percentage (X %) of the required latency (reqLatency), then the infrastructure element proceeds to operation 706 to request e2e HOB for the rest of the packet (request) trip/route. At operation 707, the infrastructure equipment determines whether the e2e HOB is created. If the e2e HOB is/was not created, then the infrastructure node proceeds back to operation 704. If the e2e HOB is/was created, then the infrastructure element proceeds to operation 708 to configure the new route for the packet, and then continues to egress at operation 709.

The infrastructure interplay process 700 is used to redirect and/or re-consider how packets are traversing from a source node to a target node depending on the current latency that has been experienced and a required latency (e.g., minimum allowable latency as defined by relevant service level agreements (SLAs)). Here, the packets can correspond either to a request coming from a requestor 210 (e.g., device/user) or from a response from a storage tier that is providing caching services to the requestor 210. Packets that correspond to a particular data access request include latency requirements, current latency experienced from the origin (source), and a current route or path that the packet needs to follow. As packets traverse different network hops (e.g., gateway appliances, HW switches, software-defined networking (SDN) technology, Multiprotocol Label Switching (MPLS), and/or the like), the current route of the packet can be reconsidered (e.g., the packet can be rerouted) based on the likelihood of missing a latency requirement/deadline. To do this, the infrastructure equipment tracks (e.g., using best effort or real-time tracking mechanism based on the deployment model) latencies between the different elements of the network (702). Using this information (702), on every hop, the current hop (infrastructure equipment) estimates whether the current route violates the current latency requirements (703). In the affirmative case, the infrastructure equipment reconsiders other alternative routes considering the current known infrastructure telemetry, the bandwidth, and latency requirements (704).

In some cases, the available routes may have very tight chances to satisfy the required latency (705). For instance, a selected route R1 may have estimated latency of 1000 microseconds (μs) where the required latency is 1100 μs. The infrastructure equipment may provide methods to allocate resources to specific packets traversing the network for a certain period of time. Thus, the current hop, based on the selected route it may request recursively to allocate resources for the request (706). Once the last hop acknowledges the HOB (707), the request route can be updated (708) and the request may continue. To implement this method, the infrastructure equipment may require specific channels to be used to establish the HOB lanes between all the hops so they can be established with low latency. As mentioned previously, the HOB lanes can be used to provide an alternate route between two points, all intermediate hops (e.g., point-to-point links) on that route have to support the e2e guaranteed priority and bandwidth to a particular channel. To do so, the networking infrastructure may require specific channel setup mechanisms to be used that are different from normal channel setup. These specific channel setup mechanisms can be used in emergency situations and are tied to pre-reserved frequency setasides so that they can be allocated quickly (and then released after use). In some implementations, the e2e HOB (706) may be associated with a request conveyed with a specific packet or can be associated with a stream ID (e.g., corresponding to the content that corresponds to the response) that will be mapped into multiple packets. In the latter case, the HOB lane creation includes a time for the HOB duration and the amount of traffic that will be associated to the response. This information is used by the hops to properly allocate the required resources.

1.2. Example Object Management System Implementations

The OMS 160 is a device, component, sub-system, and/or any HW element, SW element, and/or combination thereof that controls and/or manages the cache and/or cached data. For example, the OMS 160 controls and/or manages the storage of data in the caches, retrieves or accesses data from the caches, and evicts data from the caches according to the techniques discussed herein. In the example of FIG. 1, the OMS 160 is depicted as an entity that is separate from the other elements in the multi-tiered caching architecture 100. The OMS 160 being implemented as a standalone entity or element is one of a multitude of implementations that are possible. In particular, there are three implementation categories of the OMS 160 that are possible, including network function (NF) implementations, storage management implementations, and server implementations.

The NF implementation category involves any network element that can be deployed along a network path, which has suitable processing capabilities to operate the processes of FIGS. 3a-7. In these implementations, the caching techniques can be offloaded from a host or application platform to the NF element. Examples of the NF implementations include using network interface controllers (NICs) of one or more elements depicted by FIG. 1, routers, switches, gateway devices, network appliances, load balancers, firewall appliances, data processing units (DPUs), and/or other like network elements or appliances. The NF implementations can include any of the HW and/or SW elements discussed infra with respect to the network interface 1368 and/or acceleration circuitry 1364 of FIG. 13. In one example, the OMS 160 is implemented using a SmartNIC (e.g., Intel® FPGA SmartNIC N6000-PL Platform, Intel® FPGA PAC N3000, Silicom FPGA SmartNIC N5010, NVIDIA® ConnectX, NVIDIA® Mellanox® Innova™). In another example, the OMS 160 is implemented using a DPU such as an Intel® IPU (e.g., Intel® IPU C5000X-PL Platform, Intel® IPU Platform Codenamed Oak Springs Canyon, Intel® IPU SoC codenamed mount evans, or the like), NVIDIA® BlueField® DPU, Fungible DPU™, Broadcom® Stingray™, Kalray MPPA® DPUs, Marvell® OCTEON™ and ARMADA®, and/or the like. In another example, the OMS 160 is implemented using a switch such as an IFP (e.g., Intel® Tofino™ IFP), a smart edge switch (e.g., NVIDIA® Spectrum®, Broadcom® Trident 4™, and the like). In any of these examples, the OMS 160 can be built using the Infrastructure Programmer Development Kit (IPDK) (see e.g., IPDK Documentation, https://ipdk.io/documentation/), Open Computing Language (OpenCL), CUDA, Open Programmable Acceleration Engine (OPAE) API, and/or some other suitable framework such as any of those discussed herein.

Additionally or alternatively, the OMS 160 can be implemented using SW elements such as, for example, protocol stack layers, network/storage stack elements on a DPU, Software-Defined Networking (SDN) switches, network function virtualization (NFV) elements and/or virtualized network function (VNF), an in-server library, a caching agent of a message broker framework (e.g., an MPX cache agent in the ActiveMQ MPX publish/subscribe messaging framework and/or the like), a user agent caching mechanism (e.g., browser cache or the like), a web cache or CDN cache mechanism (e.g., cache servers, intermediary caching proxies, and/or the like).

The storage management implementations include using compute resources that are built or deployed in a storage proximal HW platform. This can include implementing the OMS 160 at or on a storage controller, in or connected to low level storage management SW (e.g., file management systems, database management systems, and/or the like), or a combination thereof. In a first example, the OMS 160 can be part of a cache controller or caching agent of interconnect (IX) interface circuitry (e.g., IX circuitry 1356 and/or external interface circuitry 1370 of FIG. 13). In a second example, the OMS 160 is part of a memory controller of one or more memory devices (e.g., memory circuitry 1354 of FIG. 13), such as an integrated memory controller (IMC), memory chip controller (MCC), memory controller unit (MCU), memory management unit (MUU), flash memory controller, and/or the like. In a third example, the OMS 160 is part of an in-memory caching engine such as those used for memcached, memcacheDB, object cache (formerly “Redis”), remote direct memory access (RDMA), and/or the like. In a fourth example, the OMS 160 is part of a storage controller of one or more storage devices (e.g., storage circuitry 1358 of FIG. 13) such as a disk array controller (or RAID controller), flash controller (or SSD controller), and/or the like.

In a fifth example, the OMS 160 is implemented as part of a large capacity storage device or system with the ability to persist data, which is used to provide a large far memory (e.g., remote storage tier 240 or the like). Here, the performance cost of accessing objects is larger than other storage devices/system, but provides other benefits such as low cost storage, persistency, and/or the ability to reorganize objects between the far memory pool and local and distributed pools of non-volatile memory disks and/or in VM disks. In this example, the OMS 160 can be used to create a kind of a storage network since the OMS 160 has ability to manage caching autonomously within and under storage and/or memory pools under its control.

The server implementations can include implementing the OMS 160 using server processors or server host processor platforms (e.g., multi-chip package (MCP) or the like), such as those designed for edge computing systems (e.g., Intel® Xeon® D and/or Xeon® E processors, which have the ability to operate at lower power), traffic coordination, security processing (e.g., cryptographic accelerators and/or the like). The server implementations can include any of the HW and/or SW elements discussed infra with respect to the processor circuitry 1352 and/or acceleration circuitry 1364 of FIG. 13.

### 2. EDGE COMPUTING SYSTEM CONFIGURATIONS AND ARRANGEMENTS

Edge computing refers to the implementation, coordination, and use of computing and resources at locations closer to the “edge” or collection of “edges” of a network. Deploying computing resources at the network's edge may reduce application and network latency, reduce network backhaul traffic and associated energy consumption, improve service capabilities, improve compliance with security or data privacy requirements (especially as compared to conventional cloud computing), and improve total cost of ownership.

Individual compute platforms or other components that can perform edge computing operations (referred to as “edge compute nodes,” “edge nodes,” or the like) can reside in whatever location needed by the system architecture or ad hoc service. In many edge computing architectures, edge nodes are deployed at NANs, gateways, network routers, and/or other devices that are closer to endpoint devices (e.g., UEs, IoT devices, etc.) producing and consuming data. As examples, edge nodes may be implemented in a high performance compute data center or cloud installation; a designated edge node server, an enterprise server, a roadside server, a telecom central office; or a local or peer at-the-edge device being served consuming edge services.

Edge compute nodes may partition resources (e.g., memory, CPU, GPU, interrupt controller, I/O controller, memory controller, bus controller, network connections or sessions, etc.) where respective partitionings may contain security and/or integrity protection capabilities. Edge nodes may also provide orchestration of multiple applications through isolated user-space instances such as containers, partitions, virtual environments (VEs), virtual machines (VMs), Function-as-a-Service (FaaS) engines, Servlets, servers, and/or other like computation abstractions. Containers are contained, deployable units of software that provide code and needed dependencies. Various edge system arrangements/architecture treats VMs, containers, and functions equally in terms of application composition. The edge nodes are coordinated based on edge provisioning functions, while the operation of the various applications are coordinated with orchestration functions (e.g., VM or container engine, etc.). The orchestration functions may be used to deploy the isolated user-space instances, identifying and scheduling use of specific hardware, security related functions (e.g., key management, trust anchor management, etc.), and other tasks related to the provisioning and lifecycle of isolated user spaces.

Applications that have been adapted for edge computing include but are not limited to virtualization of traditional network functions including include, for example, SDN, NFV, distributed RAN units and/or RAN clouds, and the like. Additional example use cases for edge computing include computational offloading, CDN services (e.g., video on demand, content streaming, security surveillance, alarm system monitoring, building access, data/content caching, etc.), gaming services (e.g., AR/VR, etc.), accelerated browsing, IoT and industry applications (e.g., factory automation), media analytics, live streaming/transcoding, and V2X applications (e.g., driving assistance and/or autonomous driving applications).

The present disclosure provides specific examples relevant to various edge computing configurations provided within and various access/network implementations. Any suitable standards and network implementations are applicable to the edge computing concepts discussed herein. For example, many edge computing/networking technologies may be applicable to the present disclosure in various combinations and layouts of devices located at the edge of a network. Examples of such edge computing/networking technologies include [MEC]; [O-RAN]; [ISEO]; [SA6Edge]; Content Delivery Networks (CDNs) (also referred to as “Content Distribution Networks” or the like); Mobility Service Provider (MSP) edge computing and/or Mobility as a Service (MaaS) provider systems (e.g., used in AECC architectures); Nebula edge-cloud systems; Fog computing systems; Cloudlet edge-cloud systems; Mobile Cloud Computing (MCC) systems; Central Office Re-architected as a Datacenter (CORD), mobile CORD (M-CORD) and/or Converged Multi-Access and Core (COMAC) systems; and/or the like. Further, the techniques disclosed herein may relate to other IoT edge network systems and configurations, and other intermediate processing entities and architectures may also be used for purposes of the present disclosure.

FIG. 8 illustrates an example edge computing environment 800 including different layers of communication, starting from an endpoint layer 810a (also referred to as “sensor layer 810a”, “things layer 810a”, or the like) including one or more IoT devices 811 (also referred to as “endpoints 810a” or the like) (e.g., in an Internet of Things (IoT) network, wireless sensor network (WSN), fog, and/or mesh network topology); increasing in sophistication to intermediate layer 810b (also referred to as “client layer 810b”, “gateway layer 810b”, or the like) including various user equipment (UEs) 812a, 812b, and 812c (also referred to as “intermediate nodes 810b” or the like), which may facilitate the collection and processing of data from endpoints 810a; increasing in processing and connectivity sophistication to access layer 830 including a set of network access nodes (NANs) 831, 832, and 833 (collectively referred to as “NANs 830” or the like); increasing in processing and connectivity sophistication to edge layer 837 including a set of edge compute nodes 836a-c (collectively referred to as “edge compute nodes 836” or the like) within an edge computing framework 835 (also referred to as “ECT 835” or the like); and increasing in connectivity and processing sophistication to a backend layer 840 including core network (CN) 842, cloud 844, and server(s) 850. The processing at the backend layer 840 may be enhanced by network services as performed by one or more remote servers 850, which may be, or include, one or more CN functions, cloud compute nodes or clusters, application (app) servers, and/or other like systems and/or devices. Some or all of these elements may be equipped with or otherwise implement some or all features and/or functionality discussed herein.

The environment 800 is shown to include end-user devices such as intermediate nodes 810b and endpoint nodes 810a (collectively referred to as “nodes 810”, “UEs 810”, or the like), which are configured to connect to (or communicatively couple with) one or more communication networks (also referred to as “access networks,” “radio access networks,” or the like) based on different access technologies (or “radio access technologies”) for accessing application, edge, and/or cloud services. These access networks may include one or more NANs 830, which are arranged to provide network connectivity to the UEs 810 via respective links 803a and/or 803b (collectively referred to as “channels 803”, “links 803”, “connections 803”, and/or the like) between individual NANs 830 and respective UEs 810.

As examples, the communication networks and/or access technologies may include cellular technology such as LTE, MuLTEfire, and/or NR/5G (e.g., as provided by Radio Access Network (RAN) node 831 and/or RAN nodes 832), WiFi or wireless local area network (WLAN) technologies (e.g., as provided by access point (AP) 833 and/or RAN nodes 832), and/or the like.

Different technologies exhibit benefits and limitations in different scenarios, and application performance in different scenarios becomes dependent on the choice of the access networks (e.g., WiFi, LTE, etc.) and the used network and transport protocols such as any of those discussed herein.

The intermediate nodes 810b include UE 812a, UE 812b, and UE 812c (collectively referred to as “UE 812” or “UEs 812”). In this example, the UE 812a is illustrated as a vehicle system (also referred to as a vehicle UE or vehicle station), UE 812b is illustrated as a smartphone (e.g., handheld touchscreen mobile computing device connectable to one or more cellular networks), and UE 812c is illustrated as a flying drone or unmanned aerial vehicle (UAV). However, the UEs 812 may be any mobile or non-mobile computing device, such as desktop computers, workstations, laptop computers, tablets, wearable devices, PDAs, pagers, wireless handsets smart appliances, single-board computers (SBCs) (e.g., Raspberry Pi, Arduino, Intel Edison, etc.), plug computers, and/or any type of computing device such as any of those discussed herein.

The endpoints 810 include UEs 811, which may be IoT devices (also referred to as “IoT devices 811”), which are uniquely identifiable embedded computing devices (e.g., within the Internet infrastructure) that comprise a network access layer designed for low-power IoT applications utilizing short-lived UE connections. The IoT devices 811 are any physical or virtualized, devices, sensors, or “things” that are embedded with HW and/or SW components that enable the objects, devices, sensors, or “things” capable of capturing and/or recording data associated with an event, and capable of communicating such data with one or more other devices over a network with little or no user intervention. As examples, IoT devices 811 may be abiotic devices such as autonomous sensors, gauges, meters, image capture devices, microphones, light emitting devices, audio emitting devices, audio and/or video playback devices, electro-mechanical devices (e.g., switch, actuator, etc.), EEMS, ECUs, ECMs, embedded systems, microcontrollers, control modules, networked or “smart” appliances, MTC devices, M2M devices, and/or the like. The IoT devices 811 can utilize technologies such as M2M or MTC for exchanging data with an MTC server (e.g., a server 850), an edge server 836 and/or ECT 835, or device via a PLMN, ProSe or D2D communication, sensor networks, or IoT networks. The M2M or MTC exchange of data may be a machine-initiated exchange of data.

The IoT devices 811 may execute background applications (e.g., keep-alive messages, status updates, etc.) to facilitate the connections of the IoT network. Where the IoT devices 811 are, or are embedded in, sensor devices, the IoT network may be a WSN. An IoT network describes an interconnecting IoT UEs, such as the IoT devices 811 being connected to one another over respective direct links 805. The IoT devices may include any number of different types of devices, grouped in various combinations (referred to as an “IoT group”) that may include IoT devices that provide one or more services for a particular user, customer, organizations, etc. A service provider (e.g., an owner/operator of server(s) 850, CN 842, and/or cloud 844) may deploy the IoT devices in the IoT group to a particular area (e.g., a geolocation, building, etc.) in order to provide the one or more services. In some implementations, the IoT network may be a mesh network of IoT devices 811, which may be termed a fog device, fog system, or fog, operating at the edge of the cloud 844. The fog involves mechanisms for bringing cloud computing functionality closer to data generators and consumers wherein various network devices run cloud application logic on their native architecture. Fog computing is a system-level horizontal architecture that distributes resources and services of computing, storage, control, and networking anywhere along the continuum from cloud 844 to Things (e.g., IoT devices 811). The fog may be established in accordance with specifications released by the OFC, the OCF, among others. Additionally or alternatively, the fog may be a tangle as defined by the IOTA foundation.

The fog may be used to perform low-latency computation/aggregation on the data while routing it to an edge cloud (e.g., edge cloud 910) computing service (e.g., edge nodes 830) and/or a central cloud computing service (e.g., cloud 844) for performing heavy computations or computationally burdensome tasks. On the other hand, edge cloud computing consolidates human-operated, voluntary resources, as a cloud. These voluntary resource may include, inter-alia, intermediate nodes 820 and/or endpoints 810, desktop PCs, tablets, smartphones, nano data centers, and the like. In various implementations, resources in the edge cloud may be in one to two-hop proximity to the IoT devices 811, which may result in reducing overhead related to processing data and may reduce network delay.

Additionally or alternatively, the fog may be a consolidation of IoT devices 811 and/or networking devices, such as routers and switches, with high computing capabilities and the ability to run cloud application logic on their native architecture. Fog resources may be manufactured, managed, and deployed by cloud vendors, and may be interconnected with high speed, reliable links. Moreover, fog resources reside farther from the edge of the network when compared to edge systems but closer than a central cloud infrastructure. Fog devices are used to effectively handle computationally intensive tasks or workloads offloaded by edge resources.

Additionally or alternatively, the fog may operate at the edge of the cloud 844. The fog operating at the edge of the cloud 844 may overlap or be subsumed into an edge network 830 of the cloud 844. The edge network of the cloud 844 may overlap with the fog, or become a part of the fog. Furthermore, the fog may be an edge-fog network that includes an edge layer and a fog layer. The edge layer of the edge-fog network includes a collection of loosely coupled, voluntary and human-operated resources (e.g., the aforementioned edge compute nodes 836 or edge devices). The Fog layer resides on top of the edge layer and is a consolidation of networking devices such as the intermediate nodes 820 and/or endpoints 810 of FIG. 8.

Data may be captured, stored/recorded, and communicated among the IoT devices 811 or, for example, among the intermediate nodes 820 and/or endpoints 810 that have direct links 805 with one another as shown by FIG. 8. Analysis of the traffic flow and control schemes may be implemented by aggregators that are in communication with the IoT devices 811 and each other through a mesh network. The aggregators may be a type of IoT device 811 and/or network appliance. In the example of FIG. 8, the aggregators may be edge nodes 830, or one or more designated intermediate nodes 820 and/or endpoints 810. Data may be uploaded to the cloud 844 via the aggregator, and commands can be received from the cloud 844 through gateway devices that are in communication with the IoT devices 811 and the aggregators through the mesh network. Unlike the traditional cloud computing model, in some implementations, the cloud 844 may have little or no computational capabilities and only serves as a repository for archiving data recorded and processed by the fog. In these implementations, the cloud 844 centralized data storage system and provides reliability and access to data by the computing resources in the fog and/or edge devices. Being at the core of the architecture, the Data Store of the cloud 844 is accessible by both Edge and Fog layers of the aforementioned edge-fog network.

As mentioned previously, the access networks provide network connectivity to the end-user devices 820, 810 via respective NANs 830. The access networks may be Radio Access Networks (RANs) such as an NG RAN or a 5G RAN for a RAN that operates in a 5G/NR cellular network, an E-UTRAN for a RAN that operates in an LTE or 4G cellular network, or a legacy RAN such as a UTRAN or GERAN for GSM or CDMA cellular networks. The access network or RAN may be referred to as an Access Service Network for WiMAX implementations. Additionally or alternatively, all or parts of the RAN may be implemented as one or more software entities running on server computers as part of a virtual network, which may be referred to as a cloud RAN (CRAN), Cognitive Radio (CR), a virtual baseband unit pool (vBBUP), and/or the like. Additionally or alternatively, the CRAN, CR, or vBBUP may implement a RAN function split, wherein one or more communication protocol layers are operated by the CRAN/CR/vBBUP and other communication protocol entities are operated by individual RAN nodes 831, 832. This virtualized framework allows the freed-up processor cores of the NANs 831, 832 to perform other virtualized applications, such as virtualized applications for various elements discussed herein.

The UEs 810 may utilize respective connections (or channels) 803a, each of which comprises a physical communications interface or layer. The connections 803a are illustrated as an air interface to enable communicative coupling consistent with cellular communications protocols, such as 3GPP LTE, 5G/NR, Push-to-Talk (PTT) and/or PTT over cellular (POC), UMTS, GSM, CDMA, and/or any of the other communications protocols discussed herein. Additionally or alternatively, the UEs 810 and the NANs 830 communicate data (e.g., transmit and receive) data over a licensed medium (also referred to as the “licensed spectrum” and/or the “licensed band”) and an unlicensed shared medium (also referred to as the “unlicensed spectrum” and/or the “unlicensed band”). To operate in the unlicensed spectrum, the UEs 810 and NANs 830 may operate using LAA, enhanced LAA (eLAA), and/or further eLAA (feLAA) mechanisms. The UEs 810 may further directly exchange communication data via respective direct links 805, which may be LTE/NR Proximity Services (ProSe) link or PC5 interfaces/links, or WiFi based links or a personal area network (PAN) based links (e.g., [IEEE802154] based protocols including ZigBee, IPv6 over Low power Wireless Personal Area Networks (6LoWPAN), WirelessHART, MiWi, Thread, etc.; WiFi-direct; Bluetooth/Bluetooth Low Energy (BLE) protocols).

Additionally or alternatively, individual UEs 810 provide radio information to one or more NANs 830 and/or one or more edge compute nodes 836 (e.g., edge servers/hosts, etc.). The radio information may be in the form of one or more measurement reports, and/or may include, for example, signal strength measurements, signal quality measurements, and/or the like. Each measurement report is tagged with a timestamp and the location of the measurement (e.g., the UEs 810 current location). As examples, the measurements collected by the UEs 810 and/or included in the measurement reports may include one or more of the following: bandwidth (BW), network or cell load, latency, jitter, round trip time (RTT), number of interrupts, out-of-order delivery of data packets, transmission power, bit error rate, bit error ratio (BER), Block Error Rate (BLER), packet error ratio (PER), packet loss rate, packet reception rate (PRR), data rate, peak data rate, e2e delay, signal-to-noise ratio (SNR), signal-to-noise and interference ratio (SINR), signal-plus-noise-plus-distortion to noise-plus-distortion (SINAD) ratio, carrier-to-interference plus noise ratio (CINR), Additive White Gaussian Noise (AWGN), energy per bit to noise power density ratio (Eb/NO), energy per chip to interference power density ratio (Ec/I0), energy per chip to noise power density ratio (Ec/NO), peak-to-average power ratio (PAPR), reference signal received power (RSRP), reference signal received quality (RSRQ), received signal strength indicator (RSSI), received channel power indicator (RCPI), received signal to noise indicator (RSNI), Received Signal Code Power (RSCP), average noise plus interference (ANPI), GNSS timing of cell frames for UE positioning for E-UTRAN or 5G/NR (e.g., a timing between an AP or RAN node reference time and a GNSS-specific reference time for a given GNSS), GNSS code measurements (e.g., the GNSS code phase (integer and fractional parts) of the spreading code of the ith GNSS satellite signal), GNSS carrier phase measurements (e.g., the number of carrier-phase cycles (integer and fractional parts) of the ith GNSS satellite signal, measured since locking onto the signal; also called Accumulated Delta Range (ADR)), channel interference measurements, thermal noise power measurements, received interference power measurements, power histogram measurements, channel load measurements, STA statistics, and/or other like measurements. The RSRP, RSSI, and/or RSRQ measurements may include RSRP, RSSI, and/or RSRQ measurements of cell-specific reference signals, channel state information reference signals (CSI-RS), and/or synchronization signals (SS) or SS blocks for 3GPP networks (e.g., LTE or 5G/NR), and RSRP, RSSI, RSRQ, RCPI, RSNI, and/or ANPI measurements of various beacon, Fast Initial Link Setup (FILS) discovery frames, or probe response frames for WLAN/WiFi (e.g., [IEEE80211]) networks. Other measurements may be additionally or alternatively used, such as those discussed in 3GPP TS 36.214 v16.2.0 (2021 Mar. 31) (“[TS36214]”), 3GPP TS 38.215 v16.4.0 (2021 Jan. 8) (“[TS38215]”), 3GPP TS 38.314 v16.4.0 (2021 Sep. 30) (“[TS38314]”), IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications, IEEE Std 802.11-2020, pp. 1-4379 (26 Feb. 2021) C[IEEE80211]″), and/or the like. Additionally or alternatively, any of the aforementioned measurements (or combination of measurements) may be collected by one or more NANs 830 and provided to the edge compute node(s) 836.

Additionally or alternatively, the measurements can include one or more of the following measurements: measurements related to Data Radio Bearer (DRB) (e.g., number of DRBs attempted to setup, number of DRBs successfully setup, number of released active DRBs, in-session activity time for DRB, number of DRBs attempted to be resumed, number of DRBs successfully resumed, etc.); measurements related to Radio Resource Control (RRC) (e.g., mean number of RRC connections, maximum number of RRC connections, mean number of stored inactive RRC connections, maximum number of stored inactive RRC connections, number of attempted, successful, and/or failed RRC connection establishments, etc.); measurements related to UE Context (UECNTX); measurements related to Radio Resource Utilization (RRU) (e.g., DL total PRB usage, UL total PRB usage, distribution of DL total PRB usage, distribution of UL total PRB usage, DL PRB used for data traffic, UL PRB used for data traffic, DL total available PRBs, UL total available PRBs, etc.); measurements related to Registration Management (RM); measurements related to Session Management (SM) (e.g., number of PDU sessions requested to setup; number of PDU sessions successfully setup; number of PDU sessions failed to setup, etc.); measurements related to GTP Management (GTP); measurements related to IP Management (IP); measurements related to Policy Association (PA); measurements related to Mobility Management (MM) (e.g., for inter-RAT, intra-RAT, and/or Intra/Inter-frequency handovers and/or conditional handovers: number of requested, successful, and/or failed handover preparations; number of requested, successful, and/or failed handover resource allocations; number of requested, successful, and/or failed handover executions; mean and/or maximum time of requested handover executions; number of successful and/or failed handover executions per beam pair, etc.); measurements related to Virtualized Resource(s) (VR); measurements related to Carrier (CARR); measurements related to QoS Flows (QF) (e.g., number of released active QoS flows, number of QoS flows attempted to release, in-session activity time for QoS flow, in-session activity time for a UE 810, number of QoS flows attempted to setup, number of QoS flows successfully established, number of QoS flows failed to setup, number of initial QoS flows attempted to setup, number of initial QoS flows successfully established, number of initial QoS flows failed to setup, number of QoS flows attempted to modify, number of QoS flows successfully modified, number of QoS flows failed to modify, etc.); measurements related to Application Triggering (AT); measurements related to Short Message Service (SMS); measurements related to Power, Energy and Environment (PEE); measurements related to NF service (NFS); measurements related to Packet Flow Description (PFD); measurements related to Random Access Channel (RACH); measurements related to Measurement Report (MR); measurements related to Layer 1 Measurement (L1M); measurements related to Network Slice Selection (NSS); measurements related to Paging (PAG); measurements related to Non-IP Data Delivery (NIDD); measurements related to external parameter provisioning (EPP); measurements related to traffic influence (TI); measurements related to Connection Establishment (CE); measurements related to Service Parameter Provisioning (SPP); measurements related to Background Data Transfer Policy (BDTP); measurements related to Data Management (DM); and/or any other performance measurements such as those discussed in 3GPP TS 28.552 v17.3.1 (2021 Jun. 24) (“[TS28552]”), 3GPP TS 32.425 v17.1.0 (2021 Jun. 24) (“[TS32425]”), and/or the like.

The radio information may be reported in response to a trigger event and/or on a periodic basis. Additionally or alternatively, individual UEs 810 report radio information either at a low periodicity or a high periodicity depending on a data transfer that is to take place, and/or other information about the data transfer. Additionally or alternatively, the edge compute node(s) 836 may request the measurements from the NANs 830 at low or high periodicity, or the NANs 830 may provide the measurements to the edge compute node(s) 836 at low or high periodicity. Additionally or alternatively, the edge compute node(s) 836 may obtain other relevant data from other edge compute node(s) 836, core network functions (NFs), application functions (AFs), and/or other UEs 810 such as Key Performance Indicators (KPIs), with the measurement reports or separately from the measurement reports.

Additionally or alternatively, in cases where is discrepancy in the observation data from one or more UEs, one or more RAN nodes, and/or core network NFs (e.g., missing reports, erroneous data, etc.) simple imputations may be performed to supplement the obtained observation data such as, for example, substituting values from previous reports and/or historical data, apply an extrapolation filter, and/or the like. Additionally or alternatively, acceptable bounds for the observation data may be predetermined or configured. For example, CQI and MCS measurements may be configured to only be within ranges defined by suitable 3GPP standards. In cases where a reported data value does not make sense (e.g., the value exceeds an acceptable range/bounds, or the like), such values may be dropped for the current learning/training episode or epoch. For example, on packet delivery delay bounds may be defined or configured, and packets determined to have been received after the packet delivery delay bound may be dropped.

In any of the embodiments discussed herein, any suitable data collection and/or measurement mechanism(s) may be used to collect the observation data. For example, data marking (e.g., sequence numbering, etc.), packet tracing, signal measurement, data sampling, and/or timestamping techniques may be used to determine any of the aforementioned metrics/observations. The collection of data may be based on occurrence of events that trigger collection of the data. Additionally or alternatively, data collection may take place at the initiation or termination of an event. The data collection can be continuous, discontinuous, and/or have start and stop times. The data collection techniques/mechanisms may be specific to a HW configuration/implementation or non-HW-specific, or may be based on various software parameters (e.g., OS type and version, etc.). Various configurations may be used to define any of the aforementioned data collection parameters. Such configurations may be defined by suitable specifications/standards, such as 3GPP (e.g., [SA6Edge]), ETSI (e.g., [MEC]), O-RAN (e.g., [O-RAN]), Intel® Smart Edge Open (formerly OpenNESS) (e.g., [ISEO]), IETF (e.g., [MAMS]), IEEE/WiFi (e.g., [IEEE802], [IEEE80211], [WiMAX], [IEEE16090], etc.), and/or any other like standards such as those discussed herein.

The UE 812b is shown as being capable of accessing access point (AP) 833 via a connection 803b. In this example, the AP 833 is shown to be connected to the Internet without connecting to the CN 842 of the wireless system. The connection 803b can include a local wireless connection, such as a connection consistent with any [IEEE802] protocol (e.g., [IEEE80211] and variants thereof), wherein the AP 833 would comprise a WiFi router. Additionally or alternatively, the UEs 810 can be configured to communicate using suitable communication signals with each other or with any of the AP 833 over a single or multicarrier communication channel in accordance with various communication techniques, such as, but not limited to, an OFDM communication technique, a single-carrier frequency division multiple access (SC-FDMA) communication technique, and/or the like, although the scope of the present disclosure is not limited in this respect.

The communication technique may include a suitable modulation scheme such as Complementary Code Keying (CCK); Phase-Shift Keying (PSK) such as Binary PSK (BPSK), Quadrature PSK (QPSK), Differential PSK (DPSK), etc.; or Quadrature Amplitude Modulation (QAM) such as M-QAM; and/or the like.

The one or more NANs 831 and 832 that enable the connections 803a may be referred to as “RAN nodes” or the like. The RAN nodes 831, 832 may comprise ground stations (e.g., terrestrial access points) or satellite stations providing coverage within a geographic area (e.g., a cell). The RAN nodes 831, 832 may be implemented as one or more of a dedicated physical device such as a macrocell base station, and/or a low power base station for providing femtocells, picocells or other like cells having smaller coverage areas, smaller user capacity, or higher bandwidth compared to macrocells. In this example, the RAN node 831 is embodied as a NodeB, evolved NodeB (eNB), or a next generation NodeB (gNB), and the RAN nodes 832 are embodied as relay nodes, distributed units, or Road Side Unites (RSUs). Any other type of NANs can be used.

Any of the RAN nodes 831, 832 can terminate the air interface protocol and can be the first point of contact for the UEs 812 and IoT devices 811. Additionally or alternatively, any of the RAN nodes 831, 832 can fulfill various logical functions for the RAN including, but not limited to, RAN function(s) (e.g., radio network controller (RNC) functions and/or NG-RAN functions) for radio resource management, admission control, UL and DL dynamic resource allocation, radio bearer management, data packet scheduling, etc. Additionally or alternatively, the UEs 810 can be configured to communicate using OFDM communication signals with each other or with any of the NANs 831, 832 over a multicarrier communication channel in accordance with various communication techniques, such as, but not limited to, an OFDMA communication technique (e.g., for DL communications) and/or an SC-FDMA communication technique (e.g., for UL and ProSe or sidelink communications), although the scope of the present disclosure is not limited in this respect.

For most cellular communication systems, the RAN function(s) operated by the RAN or individual NANs 831-832 organize DL transmissions (e.g., from any of the RAN nodes 831, 832 to the UEs 810) and UL transmissions (e.g., from the UEs 810 to RAN nodes 831, 832) into radio frames (or simply “frames”) with 10 millisecond (ms) durations, where each frame includes ten 1 ms subframes. Each transmission direction has its own resource grid that indicate physical resource in each slot, where each column and each row of a resource grid corresponds to one symbol and one subcarrier, respectively. The duration of the resource grid in the time domain corresponds to one slot in a radio frame. The resource grids comprises a number of resource blocks (RBs), which describe the mapping of certain physical channels to resource elements (REs). Each RB may be a physical RB (PRB) or a virtual RB (VRB) and comprises a collection of REs. An RE is the smallest time-frequency unit in a resource grid. The RNC function(s) dynamically allocate resources (e.g., PRBs and modulation and coding schemes (MCS)) to each UE 810 at each transmission time interval (TTI). A TTI is the duration of a transmission on a radio link 803a, 805, and is related to the size of the data blocks passed to the radio link layer from higher network layers.

The NANs 831, 832 may be configured to communicate with one another via respective interfaces or links (not shown), such as an X2 interface for LTE implementations (e.g., when CN 842 is an Evolved Packet Core (EPC)), an Xn interface for 5G or NR implementations (e.g., when CN 842 is an Fifth Generation Core (5GC)), or the like. The NANs 831 and 832 are also communicatively coupled to CN 842. Additionally or alternatively, the CN 842 may be an evolved packet core (EPC) network, a NextGen Packet Core (NPC) network, a 5G core (5GC), or some other type of CN. The CN 842 is a network of network elements and/or network functions (NFs) relating to a part of a communications network that is independent of the connection technology used by a terminal or user device. The CN 842 comprises a plurality of network elements/NFs configured to offer various data and telecommunications services to customers/subscribers (e.g., users of UEs 812 and IoT devices 811) who are connected to the CN 842 via a RAN. The components of the CN 842 may be implemented in one physical node or separate physical nodes including components to read and execute instructions from a machine-readable or computer-readable medium (e.g., a non-transitory machine-readable storage medium). Additionally or alternatively, Network Functions Virtualization (NFV) may be utilized to virtualize any or all of the above-described network node functions via executable instructions stored in one or more computer-readable storage mediums (described in further detail infra). A logical instantiation of the CN 842 may be referred to as a network slice, and a logical instantiation of a portion of the CN 842 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more CN 842 components/functions.

The CN 842 is shown to be communicatively coupled to an application server 850 and a network 850 via an IP communications interface 855. the one or more server(s) 850 comprise one or more physical and/or virtualized systems for providing functionality (or services) to one or more clients (e.g., UEs 812 and IoT devices 811) over a network. The server(s) 850 may include various computer devices with rack computing architecture component(s), tower computing architecture component(s), blade computing architecture component(s), and/or the like. The server(s) 850 may represent a cluster of servers, a server farm, a cloud computing service, or other grouping or pool of servers, which may be located in one or more datacenters. The server(s) 850 may also be connected to, or otherwise associated with one or more data storage devices (not shown). Moreover, the server(s) 850 may include an operating system (OS) that provides executable program instructions for the general administration and operation of the individual server computer devices, and may include a computer-readable medium storing instructions that, when executed by a processor of the servers, may allow the servers to perform their intended functions. Suitable implementations for the OS and general functionality of servers are known or commercially available, and are readily implemented by persons having ordinary skill in the art. Generally, the server(s) 850 offer applications or services that use IP/network resources. As examples, the server(s) 850 may provide traffic management services, cloud analytics, content streaming services, immersive gaming experiences, social networking and/or microblogging services, and/or other like services. In addition, the various services provided by the server(s) 850 may include initiating and controlling software and/or firmware updates for applications or individual components implemented by the UEs 812 and IoT devices 811. The server(s) 850 can also be configured to support one or more communication services (e.g., Voice-over-Internet Protocol (VoIP) sessions, PTT sessions, group communication sessions, social networking services, etc.) for the UEs 812 and IoT devices 811 via the CN 842.

The Radio Access Technologies (RATs) employed by the NANs 830, the UEs 810, and the other elements in FIG. 8 may include, for example, any of the communication protocols and/or RATs discussed herein. Different technologies exhibit benefits and limitations in different scenarios, and application performance in different scenarios becomes dependent on the choice of the access networks (e.g., WiFi, LTE, etc.) and the used network and transport protocols (e.g., Transfer Control Protocol (TCP), Virtual Private Network (VPN), Multi-Path TCP (MPTCP), Generic Routing Encapsulation (GRE), etc.). These RATs may include one or more V2X RATs, which allow these elements to communicate directly with one another, with infrastructure equipment (e.g., NANs 830), and other devices. In some implementations, at least two distinct V2X RATs may be used including WLAN V2X (W-V2X) RAT based on IEEE V2X technologies (e.g., DSRC for the U.S. and ITS-G5 for Europe) and 3GPP C-V2X RAT (e.g., LTE, 5G/NR, and beyond). In one example, the C-V2X RAT may utilize a C-V2X air interface and the WLAN V2X RAT may utilize an W-V2X air interface.

The W-V2X RATs include, for example, IEEE Guide for Wireless Access in Vehicular Environments (WAVE) Architecture, IEEE STANDARDS ASSOCIATION, IEEE 1609.0-2019 (10 Apr. 2019) (“[IEEE16090]”), V2X Communications Message Set Dictionary, SAE INT'L (23 Jul. 2020) (“[J2735_202007]”), Intelligent Transport Systems in the 5 GHz frequency band (ITS-G5), the [IEEE80211p] (which is the layer 1 (L1) and layer 2 (L2) part of WAVE, DSRC, and ITS-G5), and/or IEEE Standard for Air Interface for Broadband Wireless Access Systems, IEEE Std 802.16-2017, pp. 1-2726 (2 Mar. 2018) (“[WiMAX]”). The term “DSRC” refers to vehicular communications in the 5.9 GHz frequency band that is generally used in the United States, while “ITS-G5” refers to vehicular communications in the 5.9 GHz frequency band in Europe. Since any number of different RATs are applicable (including [IEEE80211p] RATs) that may be used in any geographic or political region, the terms “DSRC” (used, among other regions, in the U.S.) and “ITS-G5” (used, among other regions, in Europe) may be used interchangeably throughout this disclosure. The access layer for the ITS-G5 interface is outlined in ETSI EN 302 663 V1.3.1 (2020-01) (hereinafter “[EN302663]”) and describes the access layer of the ITS-S reference architecture. The ITS-G5 access layer comprises [IEEE80211] (which now incorporates [IEEE80211p]), as well as features for Decentralized Congestion Control (DCC) methods discussed in ETSI TS 102 687 V1.2.1 (2018 April) (“[TS102687]”). The access layer for 3GPP LTE-V2X based interface(s) is outlined in, inter alia, ETSI EN 303 613 V1.1.1 (2020 January), 3GPP TS 23.285 v16.2.0 (2019-12); and 3GPP 5G/NR-V2X is outlined in, inter alia, 3GPP TR 23.786 v16.1.0 (2019-06) and 3GPP TS 23.287 v16.2.0 (2020 March).

The cloud 844 may represent a cloud computing architecture/platform that provides one or more cloud computing services. Cloud computing refers to a paradigm for enabling network access to a scalable and elastic pool of shareable computing resources with self-service provisioning and administration on-demand and without active management by users. Computing resources (or simply “resources”) are any physical or virtual component, or usage of such components, of limited availability within a computer system or network. Examples of resources include usage/access to, for a period of time, servers, processor(s), storage equipment, memory devices, memory areas, networks, electrical power, input/output (peripheral) devices, mechanical devices, network connections (e.g., channels/links, ports, network sockets, etc.), operating systems (OS), virtual machines (VMs), software/applications, computer files, and/or the like. Cloud computing provides cloud computing services (or cloud services), which are one or more capabilities offered via cloud computing that are invoked using a defined interface (e.g., an API or the like). Some capabilities of cloud 844 include application capabilities type, infrastructure capabilities type, and platform capabilities type. A cloud capabilities type is a classification of the functionality provided by a cloud service to a cloud service customer (e.g., a user of cloud 844), based on the resources used. The application capabilities type is a cloud capabilities type in which the cloud service customer can use the cloud service provider's applications; the infrastructure capabilities type is a cloud capabilities type in which the cloud service customer can provision and use processing, storage or networking resources; and platform capabilities type is a cloud capabilities type in which the cloud service customer can deploy, manage and run customer-created or customer-acquired applications using one or more programming languages and one or more execution environments supported by the cloud service provider. Cloud services may be grouped into categories that possess some common set of qualities. Some cloud service categories that the cloud 844 may provide include, for example, Communications as a Service (CaaS), which is a cloud service category involving real-time interaction and collaboration services; Compute as a Service (CompaaS), which is a cloud service category involving the provision and use of processing resources needed to deploy and run software; Database as a Service (DaaS), which is a cloud service category involving the provision and use of database system management services; Data Storage as a Service (DSaaS), which is a cloud service category involving the provision and use of data storage and related capabilities; Firewall as a Service, which is a cloud service category involving providing firewall and network traffic management services; Infrastructure as a Service (IaaS), which is a cloud service category involving infrastructure capabilities type; Network as a Service (NaaS), which is a cloud service category involving transport connectivity and related network capabilities; Platform as a Service (PaaS), which is a cloud service category involving the platform capabilities type; Software as a Service (SaaS), which is a cloud service category involving the application capabilities type; Security as a Service, which is a cloud service category involving providing network and information security (infosec) services; and/or other like cloud services.

Additionally or alternatively, the cloud 844 may represent one or more cloud servers, application servers, web servers, and/or some other remote infrastructure. The remote/cloud servers may include any one of a number of services and capabilities such as, for example, any of those discussed herein. Additionally or alternatively, the cloud 844 may represent a network such as the Internet, a local area network (LAN), a wide area network (WAN), a wireless local area network (WLAN), or a wireless wide area network (WWAN) including proprietary and/or enterprise networks for a company or organization, or combinations thereof. The cloud 844 may be a network that comprises computers, network connections among the computers, and software routines to enable communication between the computers over network connections. In this regard, the cloud 844 comprises one or more network elements that may include one or more processors, communications systems (e.g., including network interface controllers, one or more transmitters/receivers connected to one or more antennas, etc.), and computer readable media.

Examples of such network elements may include wireless access points (WAPs), home/business servers (with or without RF communications circuitry), routers, switches, hubs, radio beacons, base stations, picocell or small cell base stations, backbone gateways, and/or any other like network device. Connection to the cloud 844 may be via a wired or a wireless connection using the various communication protocols discussed infra. More than one network may be involved in a communication session between the illustrated devices. Connection to the cloud 844 may require that the computers execute software routines which enable, for example, the seven layers of the OSI model of computer networking or equivalent in a wireless (cellular) phone network. Cloud 844 may be used to enable relatively long-range communication such as, for example, between the one or more server(s) 850 and one or more UEs 810. Additionally or alternatively, the cloud 844 may represent the Internet, one or more cellular networks, local area networks, or wide area networks including proprietary and/or enterprise networks, TCP/Internet Protocol (IP)-based network, or combinations thereof. In these implementations, the cloud 844 may be associated with network operator who owns or controls equipment and other elements necessary to provide network-related services, such as one or more base stations or access points, one or more servers for routing digital data or telephone calls (e.g., a core network or backbone network), etc. The backbone links 855 may include any number of wired or wireless technologies, and may be part of a LAN, a WAN, or the Internet. In one example, the backbone links 855 are fiber backbone links that couple lower levels of service providers to the Internet, such as the CN 812 and cloud 844.

As shown by FIG. 8, each of the NANs 831, 832, and 833 are co-located with edge compute nodes (or “edge servers”) 836a, 836b, and 836c, respectively. These implementations may be small-cell clouds (SCCs) where an edge compute node 836 is co-located with a small cell (e.g., pico-cell, femto-cell, etc.), or may be mobile micro clouds (MCCs) where an edge compute node 836 is co-located with a macro-cell (e.g., an eNB, gNB, etc.). The edge compute node 836 may be deployed in a multitude of arrangements other than as shown by FIG. 8. In a first example, multiple NANs 830 are co-located or otherwise communicatively coupled with one edge compute node 836. In a second example, the edge servers 836 may be co-located or operated by RNCs, which may be the case for legacy network deployments, such as 3G networks. In a third example, the edge servers 836 may be deployed at cell aggregation sites or at multi-RAT aggregation points that can be located either within an enterprise or used in public coverage areas. In a fourth example, the edge servers 836 may be deployed at the edge of CN 842. These implementations may be used in follow-me clouds (FMC), where cloud services running at distributed data centers follow the UEs 810 as they roam throughout the network.

In any of the implementations discussed herein, the edge servers 836 provide a distributed computing environment for application and service hosting, and also provide storage and processing resources so that data and/or content can be processed in close proximity to subscribers (e.g., users of UEs 810) for faster response times The edge servers 836 also support multitenancy run-time and hosting environment(s) for applications, including virtual appliance applications that may be delivered as packaged virtual machine (VM) images, middleware application and infrastructure services, content delivery services including content caching, mobile big data analytics, and computational offloading, among others. Computational offloading involves offloading computational tasks, workloads, applications, and/or services to the edge servers 836 from the UEs 810, CN 842, cloud 844, and/or server(s) 850, or vice versa. For example, a device application or client application operating in a UE 810 may offload application tasks or workloads to one or more edge servers 836. In another example, an edge server 836 may offload application tasks or workloads to one or more UE 810 (e.g., for distributed ML computation or the like).

The edge compute nodes 836 may include or be part of an edge system 835 that employs one or more ECTs 835. The edge compute nodes 836 may also be referred to as “edge hosts 836” or “edge servers 836.” The edge system 835 includes a collection of edge servers 836 and edge management systems (not shown by FIG. 8) necessary to run edge computing applications within an operator network or a subset of an operator network. The edge servers 836 are physical computer systems that may include an edge platform and/or virtualization infrastructure, and provide compute, storage, and network resources to edge computing applications. Each of the edge servers 836 are disposed at an edge of a corresponding access network, and are arranged to provide computing resources and/or various services (e.g., computational task and/or workload offloading, cloud-computing capabilities, IT services, and other like resources and/or services as discussed herein) in relatively close proximity to UEs 810. The VI of the edge servers 836 provide virtualized environments and virtualized resources for the edge hosts, and the edge computing applications may run as VMs and/or application containers on top of the VI.

In one example implementation, the ECT 835 is and/or operates according to the MEC framework, as discussed in ETSI GR MEC 001 v3.1.1 (2022 January), ETSI GS MEC 003 v3.1.1 (2022 March), ETSI GS MEC 009 v3.1.1 (2021 June), ETSI GS MEC 010-1 v1.1.1 (2017 October), ETSI GS MEC 010-2 v2.2.1 (2022 February), ETSI GS MEC 011 v2.2.1 (2020 December), ETSI GS MEC 012 V2.2.1 (2022 February), ETSI GS MEC 013 V2.2.1 (2022 January), ETSI GS MEC 014 v2.1.1 (2021 March), ETSI GS MEC 015 v2.1.1 (2020 June), ETSI GS MEC 016 v2.2.1 (2020 April), ETSI GS MEC 021 v2.2.1 (2022 February), ETSI GR MEC 024 v2.1.1 (2019 November), ETSI GS MEC 028 V2.2.1 (2021 July), ETSI GS MEC 029 v2.2.1 (2022 January), ETSI MEC GS 030 v2.1.1 (2020 April), ETSI GR MEC 031 v2.1.1 (2020 December), U.S. Provisional App. No. 63/003,834 filed Apr. 1, 2020 (“[US '834]”), and Int'l App. No. PCT/US2020/066969 filed on Dec. 23, 2020 (“[PCT '696]”) (collectively referred to herein as “[MEC]”), the contents of each of which are hereby incorporated by reference in their entireties. This example implementation (and/or in any other example implementation discussed herein) may also include NFV and/or other like virtualization technologies such as those discussed in ETSI GR NFV 001 V1.3.1 (2021 March), ETSI GS NFV 002 V1.2.1 (2014 December), ETSI GR NFV 003 V1.6.1 (2021 March), ETSI GS NFV 006 V2.1.1 (2021 January), ETSI GS NFV-INF 001 V1.1.1 (2015 January), ETSI GS NFV-INF 003 V1.1.1 (2014 December), ETSI GS NFV-INF 004 V1.1.1 (2015 January), ETSI GS NFV-MAN 001 v1.1.1 (2014 December), and/or Israel et al., OSM Release FIVE Technical Overview, ETSI OPEN SOURCE MANO, OSM White Paper, 1st ed. (January 2019), https://osm.etsi.org/images/OSM-Whitepaper-TechContent-ReleaseFIVE-FINAL.pdf (collectively referred to as “[ETSINFV]”), the contents of each of which are hereby incorporated by reference in their entireties. Other virtualization technologies and/or service orchestration and automation platforms may be used such as, for example, those discussed in E2E Network Slicing Architecture, GSMA, Official Doc. NG.127, v1.0 (3 Jun. 2021), https://www.gsma.com/newsroom/wp-content/uploads//NG.127-v1.0-2.pdf, Open Network Automation Platform (ONAP) documentation, Release Istanbul, v9.0.1 (17 Feb. 2022), https://docs.onap.org/en/latest/index.html (“[ONAP]”), 3GPP Service Based Management Architecture (SBMA) as discussed in 3GPP TS 28.533 v17.1.0 (2021 Dec. 23) (“[TS28533]”), the contents of each of which are hereby incorporated by reference in their entireties.

In another example implementation, the ECT 835 is and/or operates according to the O-RAN framework. Typically, front-end and back-end device vendors and carriers have worked closely to ensure compatibility. The flip-side of such a working model is that it becomes quite difficult to plug-and-play with other devices and this can hamper innovation. To combat this, and to promote openness and inter-operability at every level, several key players interested in the wireless domain (e.g., carriers, device manufacturers, academic institutions, and/or the like) formed the Open RAN alliance (“O-RAN”) in 2018. The O-RAN network architecture is a building block for designing virtualized RAN on programmable hardware with radio access control powered by AI. Various aspects of the O-RAN architecture are described in O-RAN Architecture Description v05.00, O-RAN ALLIANCE WG1 (July 2021); O-RAN Operations and Maintenance Architecture Specification v04.00, O-RAN ALLIANCE WG1 (November 2020); O-RAN Operations and Maintenance Interface Specification v04.00, O-RAN ALLIANCE WG1 (November 2020); O-RAN Information Model and Data Models Specification v01.00, O-RAN ALLIANCE WG1 (November 2020); O-RAN Working Group 1 Slicing Architecture v05.00, O-RAN ALLIANCE WG1 (July 2021) (“[O-RAN.WG1. Slicing-Architecture]”); O-RAN Working Group 2 (Non RT RIC and A1 interface WG) A1 interface: Application Protocol v03.01, O-RAN ALLIANCE WG2 (March 2021); O-RAN Working Group 2 (Non-RT RIC and A1 interface WG) A1 interface: Type Definitions v02.00, O-RAN ALLIANCE WG2 (July 2021); O-RAN Working Group 2 (Non-RT RIC and A1 interface WG) A1 interface: Transport Protocol v01.01, O-RAN ALLIANCE WG2 (March 2021); O-RAN Working Group 2 AI/ML workflow description and requirements v01.03 O-RAN ALLIANCE WG2 (July 2021); O-RAN Working Group 2 Non-RT RIC: Functional Architecture v01.03 O-RAN ALLIANCE WG2 (July 2021); O-RAN Working Group 3, Near-Real-time Intelligent Controller, E2 Application Protocol (E2AP) v02.00, O-RAN ALLIANCE WG3 (July 2021); O-RAN Working Group 3 Near-Real-time Intelligent Controller Architecture & E2 General Aspects and Principles v02.00, O-RAN ALLIANCE WG3 (July 2021); O-RAN Working Group 3 Near-Real-time Intelligent Controller E2 Service Model (E2SM) v02.00, O-RAN ALLIANCE WG3 (July 2021); O-RAN Working Group 3 Near-Real-time Intelligent Controller E2 Service Model (E2SM) KPM v02.00, O-RAN ALLIANCE WG3 (July 2021); O-RAN Working Group 3 Near-Real-time Intelligent Controller E2 Service Model (E2SM) RAN Function Network Interface (NI) v01.00, O-RAN ALLIANCE WG3 (February 2020); O-RAN Working Group 3 Near-Real-time Intelligent Controller E2 Service Model (E2SM) RAN Control v01.00, O-RAN ALLIANCE WG3 (July 2021); O-RAN Working Group 3 Near-Real-time Intelligent Controller Near RT RIC Architecture v02.00, O-RAN ALLIANCE WG3 (March 2021); O-RAN Fronthaul Working Group 4 Cooperative Transport Interface Transport Control Plane Specification v02.00, O-RAN ALLIANCE WG4 (March 2021); O-RAN Fronthaul Working Group 4 Cooperative Transport Interface Transport Management Plane Specification v02.00, O-RAN ALLIANCE WG4 (March 2021); O-RAN Fronthaul Working Group 4 Control, User, and Synchronization Plane Specification v07.00, O-RAN ALLIANCE WG4 (July 2021) (“[O-RAN.WG4.CUS]”); O-RAN Fronthaul Working Group 4 Management Plane Specification v07.00, O-RAN ALLIANCE WG4 (July 2021); O-RAN Open F1/W1/E1/X2/Xn Interfaces Working Group Transport Specification v01.00, O-RAN ALLIANCE WG5 (April 2020); O-RAN Alliance Working Group 5 O1 Interface specification for O-DU v02.00, O-RAN ALLIANCE WGX (July 2021); Cloud Architecture and Deployment Scenarios for O-RAN Virtualized RAN v02.02, O-RAN ALLIANCE WG6 (July 2021); O-RAN Acceleration Abstraction Layer General Aspects and Principles v01.01, O-RAN ALLIANCE WG6 (July 2021); Cloud Platform Reference Designs v02.00, O-RAN ALLIANCE WG6 (November 2020); O-RAN O2 Interface General Aspects and Principles v01.01, O-RAN ALLIANCE WG6 (July 2021); O-RAN White Box Hardware Working Group Hardware Reference Design Specification for Indoor Pico Cell with Fronthaul Split Option 6 v02.00, O-RAN ALLIANCE WG7 (July 2021) (“[O-RAN.WG7.IPC-HRD-Opt6]”); O-RAN WG7 Hardware Reference Design Specification for Indoor Picocell (FR1) with Split Option 7-2 v03.00, O-RAN ALLIANCE WG7 (July 2021) (“[O-RAN.WG7.IPC-HRD-Opt7]”); O-RAN WG7 Hardware Reference Design Specification for Indoor Picocell (FR1) with Split Option 8 v03.00, O-RAN ALLIANCE WG7 (July 2021) (“[O-RAN.WG7IPC-HRD-Opt8]”); O-RAN Open Transport Working Group 9 Xhaul Packet Switched Architectures and Solutions v02.00, O-RAN ALLIANCE WG9 (July 2021) (“[ORAN-WG9.XPAAS]”); O-RAN Open X-haul Transport Working Group Management interfaces for Transport Network Elements v02.00, O-RAN ALLIANCE WG9 (July 2021) (“[ORAN-WG9.XTRP-MGT]”); O-RAN Open X-haul Transport WG9 WDM-based Fronthaul Transport v01.00, O-RAN ALLIANCE WG9 (November 2020) (“[ORAN-WG9.WDM]”); O-RAN Open X-haul Transport Working Group Synchronization Architecture and Solution Specification v01.00, O-RAN ALLIANCE WG9 (March 2021) (“[ORAN-WG9.XTRP-SYN]”); O-RAN Operations and Maintenance Interface Specification v05.00, O-RAN ALLIANCE WG10 (July 2021); O-RAN Operations and Maintenance Architecture v05.00, O-RAN ALLIANCE WG10 (July 2021); O-RAN: Towards an Open and Smart RAN, O-RAN ALLIANCE, White Paper (October 2018), https://static1.squarespace.com/static/5ad774cce74940d7115044b0/t/5bc79b371905f4197055e8c 6/1539808057078/O-RAN+WP+FInal+181017.pdf (“[ORANWP]”), and U.S. application Ser. No. 17/484,743 filed on 24 Sep. 2021 (“[US '743]”) (collectively referred to as “[O-RAN]”); the contents of each of which are hereby incorporated by reference in their entireties.

In another example implementation, the ECT 835 is and/or operates according to the 3rd Generation Partnership Project (3GPP) System Aspects Working Group 6 (SA6) Architecture for enabling Edge Applications (referred to as “3GPP edge computing”) as discussed in 3GPP TS 23.558 v17.2.0 (2021 Dec. 31), 3GPP TS 23.501 v17.3.0 (2021 Dec. 31), 3GPP TS 28.538 v0.4.0 (2021 Dec. 8), and U.S. application Ser. No. 17/484,719 filed on 24 Sep. 2021 (“[US '719]”) (collectively referred to as “[SA6Edge]”), the contents of each of which are hereby incorporated by reference in their entireties.

In another example implementation, the ECT 835 is and/or operates according to the Intel® Smart Edge Open framework (formerly known as OpenNESS) as discussed in Intel® Smart Edge Open Developer Guide, version 21.09 (30 Sep. 2021), available at: https://smart-edge-open.github.io/ (“[ISEO]”), the contents of which is hereby incorporated by reference in its entirety.

In another example implementation, the edge system 835 operates according to the Multi-Access Management Services (MAMS) framework as discussed in Kanugovi et al., Multi-Access Management Services (MAMS), INTERNET ENGINEERING TASK FORCE (IETF), Request for Comments (RFC) 8743 (March 2020) (“[RFC8743]”), Ford et al., TCP Extensions for Multipath Operation with Multiple Addresses, IETF RFC 8684, (March 2020), De Coninck et al., Multipath Extensions for QUIC (MP-QUIC), IETF DRAFT-DECONINCK-QUIC-MULTIPATH-07, IETA, QUIC Working Group (3 May 2021), Zhu et al., User-Plane Protocols for Multiple Access Management Service, IETF DRAFT-ZHU-INTAREA-MAMS-USER-PROTOCOL-09, IETA, INTAREA (4 Mar. 2020), and Zhu et al., Generic Multi-Access (GMA) Convergence Encapsulation Protocols, IETF DRAFT-ZHU-INTAREA-GMA-14, IETA, INTAREA/Network Working Group (24 Nov. 2021) (collectively referred to as “[MAMS]”), the contents of each of which are hereby incorporated by reference in their entireties. In these implementations, an edge compute node 835 and/or one or more cloud computing nodes/clusters may be one or more MAMS servers that includes or operates a Network Connection Manager (NCM) for downstream/DL traffic, and the individual UEs 810 include or operate a Client Connection Manager (CCM) for upstream/UL traffic. An NCM is a functional entity that handles MAMS control messages from clients (e.g., individual UEs 810 configures the distribution of data packets over available access paths and (core) network paths, and manages user-plane treatment (e.g., tunneling, encryption, and/or the like) of the traffic flows (see e.g., Error! Reference source not found., [MAMS]). The CCM is the peer functional element in a client (e.g., individual UEs 810 that handles MAMS control-plane procedures, exchanges MAMS signaling messages with the NCM, and configures the network paths at the client for the transport of user data (e.g., network packets, and/or the like) (see e.g., Error! Reference source not found., [MAMS]).

It should be understood that the aforementioned edge computing frameworks/ECTs and services deployment examples are only illustrative examples of ECTs, and that the present disclosure may be applicable to many other or additional edge computing/networking technologies in various combinations and layouts of devices located at the edge of a network including the various edge computing networks/systems described herein. Further, the techniques disclosed herein may relate to other IoT edge network systems and configurations, and other intermediate processing entities and architectures may also be applicable to the present disclosure.

FIG. 9 is a block diagram 900 showing an overview of a configuration for edge computing, which includes a layer of processing referred to in many of the following examples as an “edge cloud”. As shown, the edge cloud 910 is co-located at an edge location, such as a NAN 940 (e.g., access point, base station, or the like), a local processing hub 950, or a central office 920, and thus may include multiple entities, devices, and equipment instances. The edge cloud 910 is located much closer to the endpoint (consumer and producer) data sources 960 (e.g., autonomous vehicles 961, user equipment 962, business and industrial equipment 963, video capture devices 964, drones 965, smart cities and building devices 966, sensors and IoT devices 967, etc.) than the cloud data center 930. Compute, memory, and storage resources which are offered at the edges in the edge cloud 910 are critical to providing ultra-low latency response times for services and functions used by the endpoint data sources 960 as well as reduce network backhaul traffic from the edge cloud 910 toward cloud data center 930 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of an appropriately arranged compute platform (e.g., x86, ARM, Nvidia or other CPU/GPU based compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Alternatively, an arrangement with hardware combined with virtualized functions, commonly referred to as a hybrid arrangement may also be successfully implemented. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

The network components of the edge cloud 910 may be servers, multi-tenant servers, appliance computing devices, and/or any other type of computing devices. For example, the edge cloud 910 may include an appliance computing device that is a self-contained electronic device including a housing, a chassis, a case or a shell. In some circumstances, the housing may be dimensioned for portability such that it can be carried by a human and/or shipped. Alternatively, it may be a smaller module suitable for installation in a vehicle for example. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Smaller, modular implementations may also include an extendible or embedded antenna arrangement for wireless communications. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 13. The edge cloud 910 may also include one or more servers and/or one or more multi-tenant servers. Such a server may include an OS and/or implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

FIG. 10 illustrates an example of network connectivity in non-terrestrial (e.g., satellite) and terrestrial (e.g., mobile cellular network) settings. In FIG. 10, a satellite constellation 1000 (e.g., the constellation at orbital positions 1000A and 1000B in FIG. 10) include multiple satellite vehicles (SVs) 1001 (and numerous other SVs 1001 not shown by FIG. 10), which are connected to each other and to one or more terrestrial networks. Each SV 1001 in the constellation 1000 conducts an orbit around the earth, at an orbit speed that increases as the SV 1001 is closer to earth. low Earth orbit (LEO) constellations (e.g., constellation 1000) are generally considered to include SVs (e.g., SVs 1001) that orbit at an altitude between 160 and 1000 kilometers (km), and at this altitude each SV orbits the earth about every 90 to 120 minutes. The constellation 1000 uses one or multiple SVs 1001 to provide communications coverage to a geographic area on earth. The constellation 1000 may also coordinate with other satellite constellations (not shown), and with terrestrial-based networks, to selectively provide connectivity and services for individual devices (e.g., UEs 1020, 1025) or terrestrial network systems (e.g., network equipment).

In this example, the satellite constellation 1000 is connected via a satellite link 1070 to a backhaul network 1060, which is in turn connected to a CN 1040, which may be the same or similar as the CN 842 discussed previously. The CN 1040 is used to support cellular (e.g., 5G and/or the like) communication operations with the satellite network (e.g., constellation 1000) and at a terrestrial RAN 1030, which may be the same or similar as a RAN including NANs 830 discussed previously. In a first example, the CN 1040 is located in a remote location, and uses the satellite constellation 1000 as the exclusive mechanism to reach wide area networks (WANs) and/or the Internet. In a second example, the CN 1040 uses the satellite constellation 1000 as a redundant link to access the WANs and/or the Internet. In a third example, the CN 1040 uses the satellite constellation 1000 as an alternate path to access the WANs and/or the Internet (e.g., to communicate with networks on other continents and the like).

FIG. 10 also depicts a terrestrial RAN 1030 that provides radio connectivity to user equipment (UE) including user device 1020 or vehicle system 1025 on-ground via a massive multiple input multiple output (MIMO) antenna 1050. The UEs 1020, 1025 may be the same or similar as the UEs 810 discussed previously. A variety of 5G and/or other network communication components and units are not depicted in FIG. 10 for purposes of simplicity/clarity. In some examples, each UE 1020, 1025 also may have its own satellite connectivity hardware (e.g., receiver circuitry and antenna), to directly connect with the satellite constellation 1000 via satellite link 1080. Although a cellular (e.g., 5G) network setting is depicted and discussed herein, other variations of 3GPP, O-RAN, WiFi, and other network specifications may also be applicable.

Other permutations (not shown) may involve a direct connection of the RAN 1030 to the satellite constellation 1000 (e.g., with the CN 1040 accessible over a satellite link 1070, 1080); coordination with other wired (e.g., fiber), laser or optical, and wireless links and backhaul; multi-access radios among the UE, the RAN, and other UEs; and other permutations of terrestrial and non-terrestrial connectivity. Satellite network connections may be coordinated with 5G network equipment and user equipment based on satellite orbit coverage, available network services and equipment, cost and security, and geographic or geopolitical considerations, and the like. With these basic entities in mind, and with the changing compositions of mobile users and in-orbit satellites, the following techniques describe ways in which terrestrial and satellite networks can be extended for various edge computing scenarios.

Additionally or alternatively, the provision of a RAN 1030 from SVs 1001, and the significantly reduced latency from LEO vehicles, enables much more robust use cases, including the direct connection of devices (e.g., UEs 1020, 1025) using 5G satellite antennas at the device, and communication between an edge appliance (not shown) and the satellite constellation 1000 using standard and/or proprietary protocols. As an example, in some LEO settings, one 5G LEO satellite can cover a 500 km radius for 8 minutes, every 12 hours. Connectivity latency to LEO satellites may be as small as one ms. Further, connectivity between the satellite constellation and the UEs 1020, 1025 or the RAN 1030 depends on the number and capability of satellite ground stations. For example, one or more SVs 1001 can communicate with a ground station (e.g., satellite dish 1060 and/or a RAN node), which may host edge computing processing capabilities. The ground station in turn may be connected to a data center via CN 1040 (not shown) for additional processing. With the low latency offered by 5G communications, data processing, compute, and storage may be located at any number of locations (at edge, in satellite, on ground, at core network, at low-latency data center).

Additionally or alternatively, although not shown by FIG. 10, an edge appliance may be located at an SV 1001. Here, various edge compute operations may be directly performed using hardware located at the SV 1001, reducing the latency and transmission time that would have been otherwise needed to communicate with the ground station or data center. Likewise, in these scenarios, edge compute capabilities may be implemented or coordinated among specialized processing circuitry (e.g., acceleration circuitry 1364 of FIG. 13 such as FPGAs, ASICs, and the like) or general purpose processing circuitry (e.g., processor circuitry 1352 of FIG. 13 such as x86 CPUs, and/or the like) located at the SV 1001, the ground station, UEs/devices, and/or other edge appliances not shown, and/or combinations thereof. Additionally or alternatively, although not shown by FIG. 10, other types of orbit-based connectivity and edge computing may be involved with these architectures. These include connectivity and compute provided via balloons, drones, dirigibles, and similar types of non-terrestrial elements. Such systems encounter similar temporal limitations and connectivity challenges (like those encountered in a satellite orbit).

The need to deal with delayed hits (DHs) can be minimized by building meshes of intermediate processing that has local context. Hence, cache hits are localized thereby avoiding delayed hits. This applies to the satellite context by building an NF mesh at each satellite tier (e.g., terrestrial satellite 1060, near-Earth objects (NEO), LEO, medium Earth orbit (MEO), high Earth orbit (HEO), and/or Geostationary Earth Orbit (GEO) satellites 1001 in FIG. 10). Using the caching mechanisms discussed herein, a requested object that is at risk of receiving a delayed hit would migrate to an appropriate mesh layer with a function task that can be completed given available data. The workload may be blocked at a lower mesh layer for the upper layer mesh to complete. This is like a delayed hit scenario, but the workload blocks on task completion from another mesh layer. Hence, the cache can be cleared as the context remains in memory.

Additionally or alternatively, the delayed hit cache algorithm opts to keep the function context in cache to avoid the context switch overhead. But this is likely to be uncommon given expected latencies between meshes (e.g., NEO, LEO, MEO, HEP, and/or GEO meshes and the like) versus context switch latency.

FIG. 11 illustrates an example information centric network (ICN) 1100. ICNs operate differently than traditional host-based (e.g., address-based) communication networks. ICN is an umbrella term for a networking paradigm in which information and/or functions themselves are named and requested from the network instead of hosts (e.g., machines that provide information). In ICN, access to the content is done through a pull-based model, where a client (consumer) device 1105 sends interest packets 1130 to the network requesting content by its name, and the network replies (e.g., sending data packets 1145) with the requested content. In a host-based networking paradigm (e.g., Internet protocol (IP) or the like), a device locates a host and requests content from the host. The network understands how to route (e.g., direct) packets based on the address specified in the packet. In contrast, ICN 1100 does not include a request for a particular machine and does not use addresses. Instead, to obtain content, a device 1105 (e.g., subscriber) requests named content from the network itself. The content request is called an “interest,” and the interest is conveyed via an interest packet 1130.

As the interest packet 1130 traverses network devices (e.g., network elements, routers, switches, hubs, etc.)—such as network elements 1110, 1115, and 1120—a record of the interest is kept, for example, in a pending interest table (PIT) 1135 at each network element. In this example, network element 1110 maintains an entry in its PIT 1135a for the interest packet 1130, network element 1115 maintains the entry in its PIT 1135b for the interest packet 1130, and network element 1120 maintains the entry in its PIT 1135c for the interest packet 1130. When a node receives an interest packet 1130, the node checks its content store (CS) to see whether it already has the content cached. If the node does not have the content in its cache, the interest packet 1130 is passed to the node's PIT 1135 to find a matching name. If no match is found in the PIT 1135, the node records the interest in its PIT 1135, and forwards the interest packet 1130 to the next hop(s) towards the requested content based on the information in its Forwarding Information Base (FIB) 1125.

When a device, such as publisher 1140, that has content matching the name in the interest packet 1130 is encountered, that device 1140 may send a data packet 1145 in response to the interest packet 1130. The data packet 1145 is tracked back through the network to the source (e.g., device 1105) by following the traces of the interest packet 1130 left in the network element PITs 1135. Thus, the PIT 1135 at each network element establishes a trail back to the subscriber 1105 for the data packet 1145 to follow.

Matching the named data in an ICN may follow several strategies. Generally, the data is named hierarchically, such as with a universal resource identifier (URI). For example, a video may be named www.somedomain.com or videos or v8675309. Here, the hierarchy may be seen as the publisher, “www.somedomain.com,” a sub-category, “videos,” and the canonical identification “v8675309.” As an interest 1130 traverses the ICN, ICN network elements will generally attempt to match the name to a greatest degree. Thus, if an ICN element has a cached item or route for both “www.somedomain.com or videos” and “www.somedomain.com or videos or v8675309,” the ICN element will match the later for an interest packet 1130 specifying “www.somedomain.com or videos or v8675309.” In an example, an expression may be used in matching by the ICN device. For example, the interest packet may specify “www.somedomain.com or videos or v8675*” where ‘*’ is a wildcard. Thus, any cached item or route that includes the data other than the wildcard will be matched.

Item matching involves matching the interest 1130 to data cached in the ICN element. Thus, for example, if the data 1145 named in the interest 1130 is cached in network element 1115, then the network element 1115 will return the data 1145 to the subscriber 1105 via the network element 1110. However, if the data 1145 is not cached at network element 1115, the network element 1115 routes the interest 1130 on (e.g., to network element 1120). To facilitate routing, the network elements may use a forwarding information base (FIB) 1125 to match named data to an interface (e.g., physical port) for the route In this example, network element 1110 maintains an FIB 1125a, network element 1115 maintains an FIB 1125b, and network element 1120 maintains an FIB 1125c. The FIB 1125 operates much like a routing table on a traditional network device.

In an example, additional metadata may be attached to the interest packet 1130, the cached data, and/or the route (e.g., in the FIB 1125), to provide an additional level of matching. For example, the data name may be specified as “www.somedomain.com or videos or v8675309,” but also include a version number—or timestamp, time range, endorsement, etc. In this example, the interest packet 1130 may specify the desired name, the version number, or the version range. The matching may then locate routes or cached data matching the name and perform the additional comparison of meta-data or the like to arrive at an ultimate decision as to whether data or a route matches the interest packet 1130 for respectively responding to the interest packet 1130 with the data packet 1145 or forwarding the interest packet 1130.

ICN has advantages over host-based networking because the data segments are individually named. This enables aggressive caching throughout the network as a network element may provide a data packet 1130 in response to an interest 1130 as easily as an original author 1140. Accordingly, it is less likely that the same segment of the network will transmit duplicates of the same data requested by different devices.

Fine grained encryption is another feature of many ICN networks. A typical data packet 1145 includes a name for the data that matches the name in the interest packet 1130. Further, the data packet 1145 includes the requested data and may include additional information to filter similarly named data (e.g., by creation time, expiration time, version, etc.). To address malicious entities providing false information under the same name, the data packet 1145 may also encrypt its contents with a publisher key or provide a cryptographic hash of the data and the name. Thus, knowing the key (e.g., from a certificate of an expected publisher 1140) enables the recipient to ascertain whether the data is from that publisher 1140. This technique also facilitates the aggressive caching of the data packets 1145 throughout the network because each data packet 1145 is self-contained and secure. In contrast, many host-based networks rely on encrypting a connection between two hosts to secure communications. This may increase latencies while connections are being established and prevents data caching by hiding the data from the network elements.

Example ICN networks include content centric networking (CCN) (see e.g., Mosko et al., Content-Centric Networking (CCNx) Semantics, INTERNET RESEARCH TASK FORCE (IRTF) REQUEST FOR COMMENTS (RFC) 8569 (July 2019) and Wissingh et al., Information-Centric Networking (ICN): Content-Centric Networking (CCNx) and Named Data Networking (NDN) Terminology, INTERNET RESEARCH TASK FORCE (IRTF) REQUEST FOR COMMENTS (RFC) 8793 (June 2020) (“[RFC8793]”), the contents of each of which are hereby incorporated by reference in their entireties), named data networking (NDN), (see e.g., Zhang et al., Named Data Networking (NDN) Project, Technical Report NDN-0001 (31 Oct. 2010), https://named-data.net/wp-content/uploads/TR001ndn-proj.pdf, the contents of which are hereby incorporated by reference in its entirety), and ICN caching systems (see e.g., U.S. Pat. No. 11,184,457, filed 27 Jun. 2019, the contents of which are hereby incorporated by reference in its entirety).

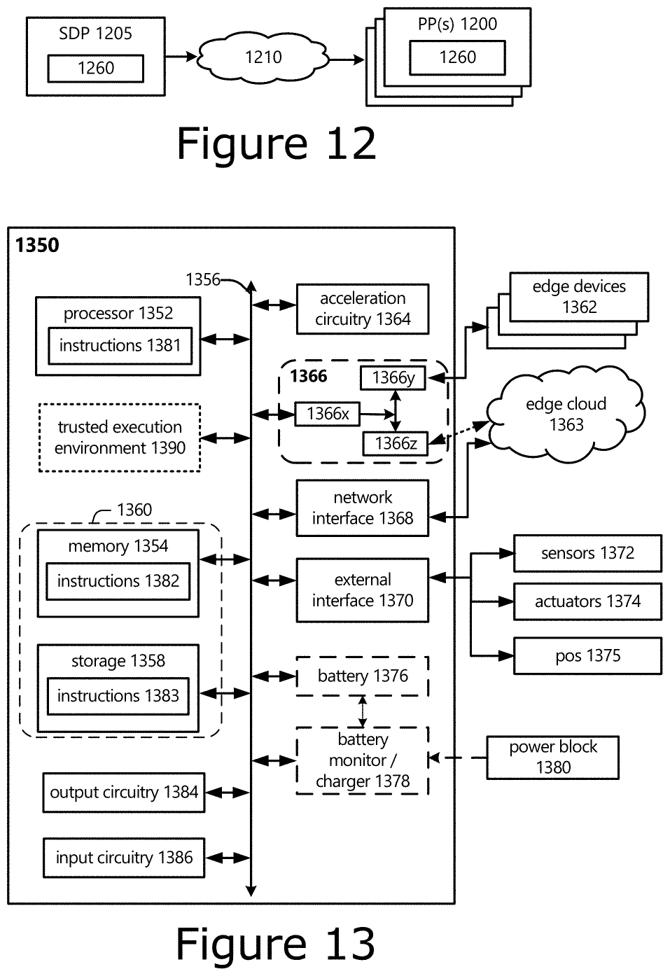

FIG. 12 illustrates an example software distribution platform 1205 to distribute software 1260, such as the example computer readable instructions 1360 of FIG. 13, to one or more devices, such as example processor platform(s) 1200 and/or example connected edge devices 1362 (see e.g., FIG. 13) and/or any of the other computing systems/devices discussed herein. The example software distribution platform 1205 may be implemented by any computer server, data facility, cloud service, etc., capable of storing and transmitting software to other computing devices (e.g., third parties, the example connected edge devices 1362 of FIG. 13). Example connected edge devices may be customers, clients, managing devices (e.g., servers), third parties (e.g., customers of an entity owning and/or operating the software distribution platform 1205).

Example connected edge devices may operate in commercial and/or home automation environments. In some examples, a third party is a developer, a seller, and/or a licensor of software such as the example computer readable instructions 1360 of FIG. 13. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 12, the software distribution platform 1205 includes one or more servers and one or more storage devices. The storage devices store the computer readable instructions 1260, which may correspond to the example computer readable instructions 1360 of FIG. 13, as described above. The one or more servers of the example software distribution platform 1205 are in communication with a network 1210, which may correspond to any one or more of the Internet and/or any of the example networks as described herein. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 1260 from the software distribution platform 1205.

For example, the software 1260, which may correspond to the example computer readable instructions 1360 of FIG. 13, may be downloaded to the example processor platform(s) 1200, which is/are to execute the computer readable instructions 1260 to implement Radio apps.

In some examples, one or more servers of the software distribution platform 1205 are communicatively connected to one or more security domains and/or security devices through which requests and transmissions of the example computer readable instructions 1260 must pass. In some examples, one or more servers of the software distribution platform 1205 periodically offer, transmit, and/or force updates to the software (e.g., the example computer readable instructions 1360 of FIG. 13) to ensure improvements, patches, updates, etc. are distributed and applied to the software at the end user devices.

In the illustrated example of FIG. 12, the computer readable instructions 1260 are stored on storage devices of the software distribution platform 1205 in a particular format. A format of computer readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 1381, 1382, 1383 stored in the software distribution platform 1205 are in a first format when transmitted to the example processor platform(s) 1200. In some examples, the first format is an executable binary in which particular types of the processor platform(s) 1200 can execute. However, in some examples, the first format is uncompiled code that requires one or more preparation tasks to transform the first format to a second format to enable execution on the example processor platform(s) 1200. For instance, the receiving processor platform(s) 1200 may need to compile the computer readable instructions 1260 in the first format to generate executable code in a second format that is capable of being executed on the processor platform(s) 1200. In still other examples, the first format is interpreted code that, upon reaching the processor platform(s) 1200, is interpreted by an interpreter to facilitate execution of instructions.

### 3. HARDWARE COMPONENTS

FIG. 13 illustrates an example of components that may be present in an edge computing node 1350 for implementing the techniques (e.g., operations, processes, methods, and methodologies) described herein. This edge computing node 1350 provides a closer view of the respective components of node 1350 when implemented as or as part of a computing device (e.g., as a mobile device, a base station, server, gateway, etc.). The edge computing node 1350 may include any combinations of the hardware or logical components referenced herein, and it may include or couple with any device usable with an edge communication network or a combination of such networks. The components may be implemented as ICs, portions thereof, discrete electronic devices, or other modules, instruction sets, programmable logic or algorithms, hardware, hardware accelerators, software, firmware, or a combination thereof adapted in the edge computing node 1350, or as components otherwise incorporated within a chassis of a larger system.

The edge computing node 1350 includes processing circuitry in the form of one or more processors 1352. The processor circuitry 1352 includes circuitry such as, for example, one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 1352 may include one or more hardware accelerators (e.g., same or similar to acceleration circuitry 1364), which may be microprocessors, programmable processing devices (e.g., FPGA, ASIC, etc.), or the like. The one or more accelerators may include, for example, computer vision and/or deep learning accelerators. In some implementations, the processor circuitry 1352 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor circuitry 1352 may be, for example, one or more processor cores (CPUs), application processors, graphics processing units (GPUs), RISC processors, Acorn RISC Machine (ARM) processors, CISC processors, one or more DSPs, FPGAs, PLDs, one or more ASICs, is baseband processors, radio-frequency integrated circuits (RFIC), microprocessors or controllers, multi-core processor, multithreaded processor, ultra-low voltage processor, embedded processor, a specialized x-processing unit (xPU) or a data processing unit (DPU) (e.g., Infrastructure Processing Unit (IPU), network processing unit (NPU), and the like), and/or any other known processing elements, or any suitable combination thereof. The processors (or cores) 1352 may be coupled with or may include memory/storage and may be configured to execute instructions stored in the memory/storage to enable various applications or OSs to run on the platform 1350. The processors (or cores) 1352 is configured to operate application software to provide a specific service to a user of the platform 1350. Additionally or alternatively, the processor(s) 1352 may be a special-purpose processor(s)/controller(s) configured (or configurable) to operate according to the elements, features, and implementations discussed herein. In some implementations, the processor circuitry 1352 includes or operates an OMS 160 that is capable of executing the μenclave implementations and techniques discussed herein.

As examples, the processor(s) 1352 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, Calif. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centrig™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor(s) 1352 may be a part of a system on a chip (SoC), System-in-Package (SiP), a multi-chip package (MCP), and/or the like, in which the processor(s) 1352 and other components are formed into a single integrated circuit, or a single package, such as the Edison™ or Galileo™ SoC boards from Intel® Corporation. Other examples of the processor(s) 1352 are mentioned elsewhere in the present disclosure.

The processor(s) 1352 may communicate with system memory 1354 over an interconnect (IX) 1356. Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). Other types of RAM, such as dynamic RAM (DRAM), synchronous DRAM (SDRAM), and/or the like may also be included. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs. Additionally or alternatively, the memory circuitry 1354 is or includes block addressable memory device(s), such as those based on NAND or NOR technologies (e.g., Single-Level Cell (“SLC”), Multi-Level Cell (“MLC”), Quad-Level Cell (“QLC”), Tri-Level Cell (“TLC”), or some other NAND).

To provide for persistent storage of information such as data, applications, OSs and so forth, a storage 1358 may also couple to the processor 1352 via the IX 1356. In an example, the storage 1358 may be implemented via a solid-state disk drive (SSDD) and/or high-speed electrically erasable memory (commonly referred to as “flash memory”). Other devices that may be used for the storage 1358 include flash memory cards, such as SD cards, microSD cards, eXtreme Digital (XD) picture cards, and the like, and USB flash drives. Additionally or alternatively, the memory circuitry 1354 and/or storage circuitry 1358 may be or may include memory devices that use chalcogenide glass, multi-threshold level NAND flash memory, NOR flash memory, single or multi-level Phase Change Memory (PCM) and/or phase change memory with a switch (PCMS), NVM devices that use chalcogenide phase change material (e.g., chalcogenide glass), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, or a combination of any of the above, or other memory. Additionally or alternatively, the memory circuitry 1354 and/or storage circuitry 1358 can include resistor-based and/or transistor-less memory architectures. The memory circuitry 1354 and/or storage circuitry 1358 may also incorporate three-dimensional (3D) cross-point (XPOINT) memory devices (e.g., Intel® 3D XPoint™ memory), and/or other byte addressable write-in-place NVM. The memory circuitry 1354 and/or storage circuitry 1358 may refer to the die itself and/or to a packaged memory product.

In low power implementations, the storage 1358 may be on-die memory or registers associated with the processor 1352. However, in some examples, the storage 1358 may be implemented using a micro hard disk drive (HDD). Further, any number of new technologies may be used for the storage 1358 in addition to, or instead of, the technologies described, such resistance change memories, phase change memories, holographic memories, or chemical memories, among others.

The OS stored by the memory circuitry 1354 and/or storage circuitry 1358 is software to control the compute node 1350. The OS may include one or more drivers that operate to control particular devices that are embedded in the compute node 1350, attached to the compute node 1350, and/or otherwise communicatively coupled with the compute node 1350. Example OSs include consumer-based operating systems (e.g., Microsoft® Windows® 10, Google® Android®, Apple® macOS®, Apple® iOS®, KaiOS™ provided by KaiOS Technologies Inc., Unix or a Unix-like OS such as Linux, Ubuntu, or the like), industry-focused OSs such as real-time OS (RTOS) (e.g., Apache® Mynewt, Windows® IoTO, Android Things®, Micrium® Micro-Controller OSs (“MicroC/OS” or “μC/OS”), VxWorks®, FreeRTOS, and/or the like), hypervisors (e.g., Xen® Hypervisor, Real-Time Systems® RTS Hypervisor, Wind River Hypervisor, VMWare® vSphere® Hypervisor, and/or the like), and/or the like. The OS can invoke alternate software to facilitate one or more functions and/or operations that are not native to the OS, such as particular communication protocols and/or interpreters. Additionally or alternatively, the OS instantiates various functionalities that are not native to the OS. In some examples, OSs include varying degrees of complexity and/or capabilities. In some examples, a first OS on a first compute node 1350 may be the same or different than a second OS on a second compute node 1350. For instance, the first OS may be an RTOS having particular performance expectations of responsivity to dynamic input conditions, and the second OS can include GUI capabilities to facilitate end-user I/O and the like.

The storage 1358 may include instructions 1383 in the form of software, firmware, or hardware commands to implement the techniques described herein. In some implementations, the instructions 1383 may be one or more code blocks, where one or more of the codes blocks corresponds to the OMS 160 discussed previously. Although such instructions 1383 are shown as code blocks included in the memory 1354 and the storage 1358, any of the code blocks may be replaced with hardwired circuits, for example, built into an application specific integrated circuit (ASIC), FPGA memory blocks, and/or the like. In an example, the instructions 1381, 1382, 1383 provided via the memory 1354, the storage 1358, or the processor 1352 may be embodied as a non-transitory, machine-readable medium 1360 including code to direct the processor 1352 to perform electronic operations in the edge computing node 1350. The processor 1352 may access the non-transitory, machine-readable medium 1360 (also referred to as “computer readable medium 1360” or “CRM 1360”) over the IX 1356. For instance, the non-transitory, CRM 1360 may be embodied by devices described for the storage 1358 or may include specific storage units such as storage devices and/or storage disks that include optical disks (e.g., digital versatile disk (DVD), compact disk (CD), CD-ROM, Blu-ray disk), flash drives, floppy disks, hard drives (e.g., SSDs), or any number of other hardware devices in which information is stored for any duration (e.g., for extended time periods, permanently, for brief instances, for temporarily buffering, and/or caching). The non-transitory, CRM 1360 may include instructions to direct the processor 1352 to perform a specific sequence or flow of actions, for example, as described with respect to the flowchart(s) and/or block diagram(s) of operations and functionality depicted herein.

The components of edge computing device 1350 may communicate over an interconnect (IX) 1356. The IX 1356 may include any number of technologies, including instruction set architecture (ISA), extended ISA (eISA), Inter-Integrated Circuit (I²C), serial peripheral interface (SPI), point-to-point interfaces, power management bus (PMBus), peripheral component interconnect (PCI), PCI express (PCIe), PCI extended (PCIx), Intel® Ultra Path Interconnect (UPI), Intel® Accelerator Link, Intel® QuickPath Interconnect (QPI), Intel® Omni-Path Architecture (OPA), Compute Express Link™ (CXL™) IX, RapidIO™ IX, Coherent Accelerator Processor Interface (CAPI), OpenCAPI, Advanced Microcontroller Bus Architecture (AMBA) IX, cache coherent interconnect for accelerators (CCIX), Gen-Z Consortium IXs, a HyperTransport IX, NVLink provided by NVIDIA®, ARM Advanced eXtensible Interface (AXI), a Time-Trigger Protocol (TTP) system, a FlexRay system, PROFIBUS, Ethernet, USB, On-Chip System Fabric (IOSF), Infinity Fabric (IF), and/or any number of other IX technologies. The IX 1356 may be a proprietary bus, for example, used in a SoC based system. In various implementations, the 1356 includes IX interface circuitry, which may be or may include a cache controller or a caching agent (CA). In these implementations, the IX interface circuitry may correspond to the OMS 160 discussed previously.

The IX 1356 couples the processor 1352 to communication circuitry 1366 for communications with other devices, such as a remote server (not shown) and/or the connected edge devices 1362. The communication circuitry 1366 is a hardware element, or collection of hardware elements, used to communicate over one or more networks (e.g., cloud 1363) and/or with other devices (e.g., edge devices 1362). Communication circuitry 1366 includes modem circuitry 1366x may interface with application circuitry of system 800 (e.g., a combination of processor circuitry 802 and CRM 860) for generation and processing of baseband signals and for controlling operations of the TRx 812. The modem circuitry 1366x may handle various radio control functions that enable communication with one or more (R)ANs via the transceivers (TRx) 1366y and 1366z according to one or more wireless communication protocols and/or RATs. The modem circuitry 1366x may include circuitry such as, but not limited to, one or more single-core or multi-core processors (e.g., one or more baseband processors) or control logic to process baseband signals received from a receive signal path of the TRxs 1366y, 1366z, and to generate baseband signals to be provided to the TRxs 1366y, 1366z via a transmit signal path. The modem circuitry 1366x may implement a real-time OS (RTOS) to manage resources of the modem circuitry 1366x, schedule tasks, perform the various radio control functions, process the transmit/receive signal paths, and the like. In some implementations, the modem circuitry 1366x includes or operates an OMS 160 that is capable of executing the μenclave implementations and techniques discussed herein.

The TRx 1366y may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1362. For example, a wireless local area network (WLAN) unit may be used to implement Wi-Fi® communications in accordance with a [IEEE802] standard (e.g., [IEEE80211] and/or the like). In addition, wireless wide area communications, e.g., according to a cellular or other wireless wide area protocol, may occur via a wireless wide area network (WWAN) unit.

The TRx 1366y (or multiple transceivers 1366y) may communicate using multiple standards or radios for communications at a different range. For example, the compute node 1350 may communicate with relatively close devices (e.g., within about 10 meters) using a local transceiver based on BLE, or another low power radio, to save power. More distant connected edge devices 1362 (e.g., within about 50 meters) may be reached over ZigBee® or other intermediate power radios. Both communications techniques may take place over a single radio at different power levels or may take place over separate transceivers, for example, a local transceiver using BLE and a separate mesh transceiver using ZigBee®.

A TRx 1366z (e.g., a radio transceiver) may be included to communicate with devices or services in the edge cloud 1363 via local or wide area network protocols. The TRx 1366z may be an LPWA transceiver that follows [IEEE802154] or IEEE 802.15.4g standards, among others. The edge computing node 1363 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used. Any number of other radio communications and protocols may be used in addition to the systems mentioned for the TRx 1366z, as described herein. For example, the TRx 1366z may include a cellular transceiver that uses spread spectrum (SPA/SAS) communications for implementing high-speed communications. Further, any number of other protocols may be used, such as WiFi® networks for medium speed communications and provision of network communications. The TRx 1366z may include radios that are compatible with any number of 3GPP specifications, such as LTE and 5G/NR communication systems.

A network interface controller (NIC) 1368 may be included to provide a wired communication to nodes of the edge cloud 1363 or to other devices, such as the connected edge devices 1362 (e.g., operating in a mesh, fog, and/or the like). The wired communication may provide an Ethernet connection (ses e.g., Ethernet (e.g., IEEE Standard for Ethernet, IEEE Std 802.3-2018, pp. 1-5600 (31 Aug. 2018) (“[IEEE8023]”)) or may be based on other types of networks, such as Controller Area Network (CAN), Local Interconnect Network (LIN), DeviceNet, ControlNet, Data Highway+, or PROFINET, a SmartNIC, Intelligent Fabric Processor(s) (IFP(s)), among many others. An additional NIC 1368 may be included to enable connecting to a second network, for example, a first NIC 1368 providing communications to the cloud over Ethernet, and a second NIC 1368 providing communications to other devices over another type of network. In some implementations, the NIC 1368 includes or operates an OMS 160 that is capable of executing the μenclave implementations and techniques discussed herein.

Given the variety of types of applicable communications from the device to another component or network, applicable communications circuitry used by the device may include or be embodied by any one or more of components 1364, 1366, 1368, or 1370. Accordingly, in various examples, applicable means for communicating (e.g., receiving, transmitting, etc.) may be embodied by such communications circuitry.

The compute node 1350 may include or be coupled to acceleration circuitry 1364, which may be embodied by one or more AI accelerators, a neural compute stick, neuromorphic hardware, an FPGA, an arrangement of GPUs, one or more SoCs (including programmable SoCs), one or more CPUs, one or more digital signal processors, dedicated ASICs (including programmable ASICs), PLDs such as CPLDs or HCPLDs, and/or other forms of specialized processors or circuitry designed to accomplish one or more specialized tasks. Additionally or alternatively, the acceleration circuitry 1364 may include xPUs and/or DPUs, IPUs, NPUs, and/or the like. These tasks may include AI/ML tasks (e.g., training, inferencing/prediction, classification, and the like), visual data processing, network data processing, infrastructure function management, object detection, rule analysis, or the like. In FPGA-based implementations, the acceleration circuitry 1364 may comprise logic blocks or logic fabric and other interconnected resources that may be programmed (configured) to perform various functions, such as the procedures, methods, functions, etc. discussed herein. In such implementations, the acceleration circuitry 1364 may also include memory cells (e.g., EPROM, EEPROM, flash memory, static memory (e.g., SRAM, anti-fuses, etc.) used to store logic blocks, logic fabric, data, etc. in LUTs and the like.

The IX 1356 also couples the processor 1352 to a sensor hub or external interface 1370 that is used to connect additional devices or subsystems. The additional/external devices may include sensors 1372, actuators 1374, and positioning circuitry 1345.

The sensor circuitry 1372 includes devices, modules, or subsystems whose purpose is to detect events or changes in its environment and send the information (sensor data) about the detected events to some other a device, module, subsystem, etc. Examples of such sensors 1372 include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors, including sensors for measuring the temperature of internal components and sensors for measuring temperature external to the compute node 1350); pressure sensors; barometric pressure sensors; gravimeters; altimeters; image capture devices (e.g., cameras); light detection and ranging (LiDAR) sensors; proximity sensors (e.g., infrared radiation detector and the like); depth sensors, ambient light sensors; optical light sensors; ultrasonic transceivers; microphones; and the like.

The actuators 1374, allow platform 1350 to change its state, position, and/or orientation, or move or control a mechanism or system. The actuators 1374 comprise electrical and/or mechanical devices for moving or controlling a mechanism or system, and converts energy (e.g., electric current or moving air and/or liquid) into some kind of motion. The actuators 1374 may include one or more electronic (or electrochemical) devices, such as piezoelectric biomorphs, solid state actuators, solid state relays (SSRs), shape-memory alloy-based actuators, electroactive polymer-based actuators, relay driver integrated circuits (ICs), and/or the like. The actuators 1374 may include one or more electromechanical devices such as pneumatic actuators, hydraulic actuators, electromechanical switches including electromechanical relays (EMRs), motors (e.g., DC motors, stepper motors, servomechanisms, etc.), power switches, valve actuators, wheels, thrusters, propellers, claws, clamps, hooks, audible sound generators, visual warning devices, and/or other like electromechanical components. The platform 1350 may be configured to operate one or more actuators 1374 based on one or more captured events and/or instructions or control signals received from a service provider and/or various client systems.

The positioning circuitry 1345 includes circuitry to receive and decode signals transmitted/broadcasted by a positioning network of a global navigation satellite system (GNSS).

Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 1345 comprises various hardware elements (e.g., including hardware devices such as switches, filters, amplifiers, antenna elements, and the like to facilitate OTA communications) to communicate with components of a positioning network, such as navigation satellite constellation nodes. Additionally or alternatively, the positioning circuitry 1345 may include a Micro-Technology for Positioning, Navigation, and Timing (Micro-PNT) IC that uses a master timing clock to perform position tracking/estimation without GNSS assistance. The positioning circuitry 1345 may also be part of, or interact with, the communication circuitry 1366 to communicate with the nodes and components of the positioning network. The positioning circuitry 1345 may also provide position data and/or time data to the application circuitry, which may use the data to synchronize operations with various infrastructure (e.g., radio base stations), for turn-by-turn navigation, or the like. When a GNSS signal is not available or when GNSS position accuracy is not sufficient for a particular application or service, a positioning augmentation technology can be used to provide augmented positioning information and data to the application or service. Such a positioning augmentation technology may include, for example, satellite based positioning augmentation (e.g., EGNOS) and/or ground based positioning augmentation (e.g., DGPS). In some implementations, the positioning circuitry 1345 is, or includes an INS, which is a system or device that uses sensor circuitry 1372 (e.g., motion sensors such as accelerometers, rotation sensors such as gyroscopes, and altimimeters, magentic sensors, and/or the like to continuously calculate (e.g., using dead by dead reckoning, triangulation, or the like) a position, orientation, and/or velocity (including direction and speed of movement) of the platform 1350 without the need for external references.

In some optional examples, various input/output (I/O) devices may be present within or connected to, the edge computing node 1350, which are referred to as input circuitry 1386 and output circuitry 1384 in FIG. 13. The input circuitry 1386 and output circuitry 1384 include one or more user interfaces designed to enable user interaction with the platform 1350 and/or peripheral component interfaces designed to enable peripheral component interaction with the platform 1350. Input circuitry 1386 may include any physical or virtual means for accepting an input including, inter alia, one or more physical or virtual buttons (e.g., a reset button), a physical keyboard, keypad, mouse, touchpad, touchscreen, microphones, scanner, headset, and/or the like.

The output circuitry 1384 may be included to show information or otherwise convey information, such as sensor readings, actuator position(s), or other like information. Data and/or graphics may be displayed on one or more user interface components of the output circuitry 1384. Output circuitry 1384 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, etc.), with the output of characters, graphics, multimedia objects, and the like being generated or produced from the operation of the platform 1350. The output circuitry 1384 may also include speakers or other audio emitting devices, printer(s), and/or the like. Additionally or alternatively, the sensor circuitry 1372 may be used as the input circuitry 1384 (e.g., an image capture device, motion capture device, or the like) and one or more actuators 1374 may be used as the output device circuitry 1384 (e.g., an actuator to provide haptic feedback or the like). In another example, near-field communication (NFC) circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, etc. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1376 may power the edge computing node 1350, although, in examples in which the edge computing node 1350 is mounted in a fixed location, it may have a power supply coupled to an electrical grid, or the battery may be used as a backup or for temporary capabilities. The battery 1376 may be a lithium ion battery, or a metal-air battery, such as a zinc-air battery, an aluminum-air battery, a lithium-air battery, and the like.

A battery monitor/charger 1378 may be included in the edge computing node 1350 to track the state of charge (SoCh) of the battery 1376, if included. The battery monitor/charger 1378 may be used to monitor other parameters of the battery 1376 to provide failure predictions, such as the state of health (SoH) and the state of function (SoF) of the battery 1376. The battery monitor/charger 1378 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 1378 may communicate the information on the battery 1376 to the processor 1352 over the IX 1356. The battery monitor/charger 1378 may also include an analog-to-digital (ADC) converter that enables the processor 1352 to directly monitor the voltage of the battery 1376 or the current flow from the battery 1376. The battery parameters may be used to determine actions that the edge computing node 1350 may perform, such as transmission frequency, mesh network operation, sensing frequency, and the like.

A power block 1380, or other power supply coupled to a grid, may be coupled with the battery monitor/charger 1378 to charge the battery 1376. In some examples, the power block 1380 may be replaced with a wireless power receiver to obtain the power wirelessly, for example, through a loop antenna in the edge computing node 1350. A wireless battery charging circuit, such as an LTC4020 chip from Linear Technologies of Milpitas, Calif., among others, may be included in the battery monitor/charger 1378. The specific charging circuits may be selected based on the size of the battery 1376, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The example of FIG. 13 is intended to depict a high-level view of components of a varying device, subsystem, or arrangement of an edge computing node. However, in other implementations, some of the components shown may be omitted, additional components may be present, and a different arrangement of the components shown may occur in other implementations. Further, these arrangements are usable in a variety of use cases and environments, including those discussed below (e.g., a mobile UE in industrial compute for smart city or smart factory, among many other examples).

### 4. EXAMPLES

Additional examples of the presently described methods, devices, systems, and networks discussed herein include the following, non-limiting implementations. Each of the following non-limiting examples may stand on its own or may be combined in any permutation or combination with any one or more of the other examples provided below or throughout the present disclosure.

Example 1 includes a method of managing a multi-tiered caching system including a plurality of storage tiers, the method comprising: measuring, by an object management system (OMS), a fetch cost for accessing an object from a first cache of a first storage tier of the plurality of storage tiers in which the object is currently stored, wherein the fetch cost is based on a fetch latency, and the fetch latency is an amount of latency of the object being delivered to a requestor of the object; determining, by the OMS, a second storage tier of the plurality of storage tiers in which to evict the object when the fetch cost exceeds a threshold; causing eviction, by the OMS, of the object from the first cache; and storing or causing storage, by the OMS, of the evicted object in the second cache.

Example 2 includes the method of example 1 and/or some other example(s) herein, wherein the method includes: determining, by the OMS, the fetch cost based on a fetch latency, wherein the fetch latency is based on a fetch time, and the fetch time is an amount of time between issuing a fetch command to access the object from the first cache and delivery of the object to the requestor.

Example 3 includes the method of example 2 and/or some other example(s) herein, wherein the method includes: determining, by the OMS, a number of delayed hits of accessing the object; and determining, by the OMS, the fetch cost based on the fetch time and the number of delayed hits.

Example 4 includes the method of example 3 and/or some other example(s) herein, wherein the method includes: determining, by the OMS, the fetch cost based on a mean weighted average (MWA) of the fetch time compounded with the number of delayed hits.

Example 5 includes the method of example 4 and/or some other example(s) herein, wherein the MWA is one or more of a simple moving average (SMA), a cumulative average (CA), a weighted moving average (WMA), an exponential moving average (EMA), an exponentially weighted moving average (EWMA), a modified moving average (MMA), a running moving average (RMA), a smoothed moving average (SMMA), or a moving average regression model.

Example 6 includes the method of example 5 and/or some other example(s) herein, wherein the method includes: determining, by the OMS, a reuse time associated with the object, wherein the reuse time is a time between a previous access of the object and a current access of the object.

Example 7 includes the method of example 6 and/or some other example(s) herein, wherein the method includes: determining, by the OMS, a mean time to reuse (MTR) of the object based on a time-series aggregation of the determined reuse time.

Example 8 includes the method of example 7 and/or some other example(s) herein, wherein the method includes: aggregating, by the OMS, cache space among caches of the storage tiers of the plurality of storage tiers; and allocating, by the OMS, an amount of the aggregated cache space to the object based on the fetch cost, MTR, and an access density of the object.

Example 9 includes the method of examples 7-8 and/or some other example(s) herein, wherein the method includes: increasing, by the OMS, a replication factor of the object when the object has a higher fetch cost than other objects stored in the first cache or other caches of other storage tiers of the plurality of storage tiers.

Example 10 includes the method of examples 7-9 and/or some other example(s) herein, wherein the method includes: increasing, by the OMS, a compression factor for the object when the object has a higher fetch cost than other objects stored in the first cache or other caches of other storage tiers of the plurality of storage tiers; and distributing or causing to distribute, by the OMS, the object with consistent hashing across the aggregated cache space.

Example 11 includes the method of examples 1-10 and/or some other example(s) herein, wherein the method includes: detecting, by the OMS, a request for the object issued by the requestor; issuing or causing issuance, by the OMS, of the fetch command to access the object from the first cache when there is no outstanding fetch command for the object; waiting, by the OMS, until the object is fetched from the first cache when there is an outstanding fetch command for the object; and delivering or causing delivery, by the OMS, of the object to the requestor when the object is fetched from the first cache.

Example 12 includes the method of examples 1-11 and/or some other example(s) herein, wherein the method includes: determining, by the OMS, a latency requirement for delivery of the object from the first cache to the requestor, a current latency of delivery of data from the first cache to the requestor, and a current network route between the first cache and the requestor; and routing the object or causing the object to be routed, by the OMS, to be delivered to the requestor over a new network route to the requestor when the current latency and an estimated remaining latency is larger than the latency requirement.

Example 13 includes the method of examples 1-12 and/or some other example(s) herein, wherein the second storage tier is a best-effort storage tier in comparison with other storage tiers of the plurality of storage tiers when: the fetch cost is less than or equal to the threshold, and the first storage tier is an outer-most storage tier among the plurality of storage tiers.

Example 14 includes the method of examples 1-13 and/or some other example(s) herein, wherein the second storage tier is a nearest available storage tier with respect to the first storage tier when: the fetch cost is greater the threshold, and the first storage tier is an outer-most storage tier among the plurality of storage tiers.

Example 15 includes the method of examples 1-14 and/or some other example(s) herein, wherein the second storage tier is a storage tier of the plurality of storage tiers further from the requestor than the first storage tier when: the first storage tier is not an outer-most storage tier among the plurality of storage tiers.

Example 16 includes the method of examples 1-15 and/or some other example(s) herein, wherein the requestor is one of a user device, a router, a switch, a smart edge switch, a gateway device, a network appliance, a load balancing server, a firewall appliance, a DPU, an IPU, a NIC, a smart NIC, a storage controller, a cache controller or caching agent of interconnect interface circuitry, a memory controller, an in-memory caching engine, a server host processor platform, a hardware accelerator, and a cloud computing service.

Example 17 includes the method of examples 1-16 and/or some other example(s) herein, wherein the OMS is implemented as, or part of, a protocol stack layer of a communication protocol, a network storage stack software element on a DPU, a Software-Defined Networking switch, virtualized network function, an in-server library, a caching agent of a message broker framework, a user agent caching mechanism, a web caching system, a router, a switch, a smart edge switch, a gateway device, a network appliance, a load balancing server, a firewall appliance, a DPU, an IPU, a NIC, a smart NIC, a storage controller, a cache controller or caching agent of interconnect interface circuitry, a memory controller, an in-memory caching engine, a server host processor platform, a hardware accelerator, and a cloud computing service.

Example 18 includes a router configured to perform the method of examples 1-16 and/or some other example(s) herein.

Example 19 includes a switch configured to perform the method of examples 1-16 and/or some other example(s) herein.

Example 20 includes a smart edge switch configured to perform the method of examples 1-16 and/or some other example(s) herein.

Example 21 includes a gateway device configured to perform the method of examples 1-16 and/or some other example(s) herein.

Example 22 includes a network appliance configured to perform the method of examples 1-16 and/or some other example(s) herein.

Example 23 includes a load balancing server configured to perform the method of examples 1-16 and/or some other example(s) herein.

Example 24 includes a firewall appliance configured to perform the method of examples 1-16 and/or some other example(s) herein.

Example 25 includes a DPU configured to perform the method of examples 1-16 and/or some other example(s) herein.

Example 26 includes an IPU configured to perform the method of examples 1-16 and/or some other example(s) herein.

Example 27 includes a NIC configured to perform the method of examples 1-16 and/or some other example(s) herein.

Example 28 includes a smart NIC configured to perform the method of examples 1-16 and/or some other example(s) herein.

Example 29 includes a storage controller configured to perform the method of examples 1-16 and/or some other example(s) herein.

Example 30 includes a cache controller or caching agent of interconnect interface circuitry configured to perform the method of examples 1-16 and/or some other example(s) herein.

Example 31 includes a memory controller configured to perform the method of examples 1-16 and/or some other example(s) herein.

Example 32 includes an in-memory caching engine configured to perform the method of examples 1-16 and/or some other example(s) herein.

Example 33 includes server host processor platform configured to perform the method of examples 1-16 and/or some other example(s) herein.

Example 34 includes a hardware accelerator configured to perform the method of examples 1-16 and/or some other example(s) herein.

Example 35 includes a cloud computing service configured to perform the method of examples 1-16 and/or some other example(s) herein.

Example 36 includes one or more computer readable media comprising instructions, wherein execution of the instructions by processor circuitry is to cause the processor circuitry to perform the method of examples 1-17 and/or some other example(s) herein.

Example 37 includes a computer program comprising the instructions of example 36 and/or some other example(s) herein.

Example 38 includes an Application Programming Interface defining functions, methods, variables, data structures, and/or protocols for the computer program of example 37 and/or some other example(s) herein.

Example 39 includes an apparatus comprising circuitry loaded with the instructions of example 36 and/or some other example(s) herein.

Example 40 includes an apparatus comprising circuitry operable to run the instructions of example 36 and/or some other example(s) herein.

Example 41 includes an integrated circuit comprising one or more of the processor circuitry of example 36 and the one or more computer readable media of example 36 and/or some other example(s) herein.

Example 42 includes a computing system comprising the one or more computer readable media and the processor circuitry of example 36 and/or some other example(s) herein.

Example 43 includes an apparatus comprising means for executing the instructions of example 36 and/or some other example(s) herein.

Example 44 includes a signal generated as a result of executing the instructions of example 36 and/or some other example(s) herein.

Example 45 includes a data unit generated as a result of executing the instructions of example 36 and/or some other example(s) herein.

Example 46 includes the data unit of example 45, the data unit is a datagram, network packet, data frame, data segment, PDU, SDU, a message, or a database object.

Example 47 includes a signal encoded with the data unit of examples 45-46 and/or some other example(s) herein.

Example 48 includes an electromagnetic signal carrying the instructions of example 36 and/or some other example(s) herein.

Example 49 includes an apparatus comprising means for performing the method of examples 1-17 and/or some other example(s) herein.

### 5. TERMINOLOGY

As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” each of which may refer to one or more of the same or different embodiments. Furthermore, the terms “comprising,” “including,” “having,” and the like, as used with respect to the present disclosure, are synonymous.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “establish” or “establishment” at least in some embodiments refers to (partial or in full) acts, tasks, operations, etc., related to bringing or the readying the bringing of something into existence either actively or passively (e.g., exposing a device identity or entity identity). Additionally or alternatively, the term “establish” or “establishment” at least in some embodiments refers to (partial or in full) acts, tasks, operations, etc., related to initiating, starting, or warming communication or initiating, starting, or warming a relationship between two entities or elements (e.g., establish a session, establish a session, etc.). Additionally or alternatively, the term “establish” or “establishment” at least in some embodiments refers to initiating something to a state of working readiness. The term “established” at least in some embodiments refers to a state of being operational or ready for use (e.g., full establishment). Furthermore, any definition for the term “establish” or “establishment” defined in any specification or standard can be used for purposes of the present disclosure and such definitions are not disavowed by any of the aforementioned definitions.

The term “obtain” at least in some embodiments refers to (partial or in full) acts, tasks, operations, etc., of intercepting, movement, copying, retrieval, or acquisition (e.g., from a memory, an interface, or a buffer), on the original packet stream or on a copy (e.g., a new instance) of the packet stream. Other aspects of obtaining or receiving may involving instantiating, enabling, or controlling the ability to obtain or receive a stream of packets (or the following parameters and templates or template values).

The term “receipt” at least in some embodiments refers to any action (or set of actions) involved with receiving or obtaining an object, data, data unit, etc., and/or the fact of the object, data, data unit, etc. being received. The term “receipt” at least in some embodiments refers to an object, data, data unit, etc., being pushed to a device, system, element, etc. (e.g., often referred to as a push model), pulled by a device, system, element, etc. (e.g., often referred to as a pull model), and/or the like.

The term “element” at least in some embodiments refers to a unit that is indivisible at a given level of abstraction and has a clearly defined boundary, wherein an element may be any type of entity including, for example, one or more devices, systems, controllers, network elements, modules, etc., or combinations thereof.

The term “measurement” at least in some embodiments refers to the observation and/or quantification of attributes of an object, event, or phenomenon. Additionally or alternatively, the term “measurement” at least in some embodiments refers to a set of operations having the object of determining a measured value or measurement result, and/or the actual instance or execution of operations leading to a measured value.

The term “metric” at least in some embodiments refers to a standard definition of a quantity, produced in an assessment of performance and/or reliability of the network, which has an intended utility and is carefully specified to convey the exact meaning of a measured value.

The term “figure of merit” or “FOM” at least in some embodiments refers to a quantity used to characterize or measure the performance and/or effectiveness of a device, system or method, relative to its alternatives. Additionally or alternatively, the term “figure of merit” or “FOM” at least in some embodiments refers to one or more characteristics that makes something fit for a specific purpose.

The term “signal” at least in some embodiments refers to an observable change in a quality and/or quantity. Additionally or alternatively, the term “signal” at least in some embodiments refers to a function that conveys information about of an object, event, or phenomenon. Additionally or alternatively, the term “signal” at least in some embodiments refers to any time varying voltage, current, or electromagnetic wave that may or may not carry information. The term “digital signal” at least in some embodiments refers to a signal that is constructed from a discrete set of waveforms of a physical quantity so as to represent a sequence of discrete values.

The terms “ego” (as in, e.g., “ego device”) and “subject” (as in, e.g., “data subject”) at least in some embodiments refers to an entity, element, device, system, etc., that is under consideration or being considered. The terms “neighbor” and “proximate” (as in, e.g., “proximate device”) at least in some embodiments refers to an entity, element, device, system, etc., other than an ego device or subject device.

The term “identifier” at least in some embodiments refers to a value, or a set of values, that uniquely identify an identity in a certain scope. Additionally or alternatively, the term “identifier” at least in some embodiments refers to a sequence of characters that identifies or otherwise indicates the identity of a unique object, element, or entity, or a unique class of objects, elements, or entities. Additionally or alternatively, the term “identifier” at least in some embodiments refers to a sequence of characters used to identify or refer to an application, program, session, object, element, entity, variable, set of data, and/or the like. The “sequence of characters” mentioned previously at least in some embodiments refers to one or more names, labels, words, numbers, letters, symbols, and/or any combination thereof. Additionally or alternatively, the term “identifier” at least in some embodiments refers to a name, address, label, distinguishing index, and/or attribute. Additionally or alternatively, the term “identifier” at least in some embodiments refers to an instance of identification. The term “persistent identifier” at least in some embodiments refers to an identifier that is reused by a device or by another device associated with the same person or group of persons for an indefinite period.

The term “identification” at least in some embodiments refers to a process of recognizing an identity as distinct from other identities in a particular scope or context, which may involve processing identifiers to reference an identity in an identity database.

The term “lightweight” or “lite” at least in some embodiments refers to an application or computer program designed to use a relatively small amount of resources such as having a relatively small memory footprint, low processor usage, and/or overall low usage of system resources. The term “lightweight protocol” at least in some embodiments refers to a communication protocol that is characterized by a relatively small overhead. Additionally or alternatively, the term “lightweight protocol” at least in some embodiments refers to a protocol that provides the same or enhanced services as a standard protocol, but performs faster than standard protocols, has lesser overall size in terms of memory footprint, uses data compression techniques for processing and/or transferring data, drops or eliminates data deemed to be nonessential or unnecessary, and/or uses other mechanisms to reduce overall overheard and/or footprint.

The term “circuitry” at least in some embodiments refers to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an application-specific integrated circuit (ASIC), field-programmable gate array (FPGA), programmable logic controller (PLC), system on chip (SoC), system in package (SiP), multi-chip package (MCP), digital signal processor (DSP), etc., that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry. It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations which, when joined logically together, comprise the component or module and achieve the stated purpose for the component or module. Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center) than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set or may be distributed over different locations including over different storage devices, and may exist, at least partially, merely as electronic signals on a system or network. The components or modules may be passive or active, including agents operable to perform desired functions.

The term “processor circuitry” at least in some embodiments refers to, is part of, or includes circuitry capable of sequentially and automatically carrying out a sequence of arithmetic or logical operations, or recording, storing, and/or transferring digital data. The term “processor circuitry” at least in some embodiments refers to one or more application processors, one or more baseband processors, a physical CPU, a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “memory” and/or “memory circuitry” at least in some embodiments refers to one or more hardware devices for storing data, including RAM, MRAM, PRAM, DRAM, and/or SDRAM, core memory, ROM, magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data.

The terms “machine-readable medium” and “computer-readable medium” refers to tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP). A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions. In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine. The terms “machine-readable medium” and “computer-readable medium” may be interchangeable for purposes of the present disclosure. The term “non-transitory computer-readable medium at least in some embodiments refers to any type of memory, computer readable storage device, and/or storage disk and may exclude propagating signals and transmission media.

The term “interface circuitry” at least in some embodiments refers to, is part of, or includes circuitry that enables the exchange of information between two or more components or devices. The term “interface circuitry” at least in some embodiments refers to one or more hardware interfaces, for example, buses, I/O interfaces, peripheral component interfaces, network interface cards, and/or the like.

The term “device” at least in some embodiments refers to a physical entity embedded inside, or attached to, another physical entity in its vicinity, with capabilities to convey digital information from or to that physical entity.

The term “entity” at least in some embodiments refers to a distinct component of an architecture or device, or information transferred as a payload.

The term “controller” at least in some embodiments refers to an element or entity that has the capability to affect a physical entity, such as by changing its state or causing the physical entity to move.

The term “terminal” at least in some embodiments refers to point at which a conductor from a component, device, or network comes to an end. Additionally or alternatively, the term “terminal” at least in some embodiments refers to an electrical connector acting as an interface to a conductor and creating a point where external circuits can be connected. In some embodiments, terminals may include electrical leads, electrical connectors, electrical connectors, solder cups or buckets, and/or the like.

The term “compute node” or “compute device” at least in some embodiments refers to an identifiable entity implementing an aspect of computing operations, whether part of a larger system, distributed collection of systems, or a standalone apparatus. In some examples, a compute node may be referred to as a “computing device”, “computing system”, or the like, whether in operation as a client, server, or intermediate entity. Specific implementations of a compute node may be incorporated into a server, base station, gateway, road side unit, on-premise unit, user equipment, end consuming device, appliance, or the like.

The term “computer system” at least in some embodiments refers to any type interconnected electronic devices, computer devices, or components thereof. Additionally, the terms “computer system” and/or “system” at least in some embodiments refer to various components of a computer that are communicatively coupled with one another. Furthermore, the term “computer system” and/or “system” at least in some embodiments refer to multiple computer devices and/or multiple computing systems that are communicatively coupled with one another and configured to share computing and/or networking resources.

The term “architecture” at least in some embodiments refers to a computer architecture or a network architecture. A “computer architecture” is a physical and logical design or arrangement of software and/or hardware elements in a computing system or platform including technology standards for interacts therebetween. A “network architecture” is a physical and logical design or arrangement of software and/or hardware elements in a network including communication protocols, interfaces, and media transmission.

The term “appliance,” “computer appliance,” or the like, at least in some embodiments refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “user equipment” or “UE” at least in some embodiments refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, station, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface. Examples of UEs, client devices, etc., include desktop computers, workstations, laptop computers, mobile data terminals, smartphones, tablet computers, wearable devices, machine-to-machine (M2M) devices, machine-type communication (MTC) devices, Internet of Things (IoT) devices, embedded systems, sensors, autonomous vehicles, drones, robots, in-vehicle infotainment systems, instrument clusters, onboard diagnostic devices, dashtop mobile equipment, electronic engine management systems, electronic/engine control units/modules, microcontrollers, control module, server devices, network appliances, head-up display (HUD) devices, helmet-mounted display devices, augmented reality (AR) devices, virtual reality (VR) devices, mixed reality (MR) devices, and/or other like systems or devices.

The term “station” or “STA” at least in some embodiments refers to a logical entity that is a singly addressable instance of a medium access control (MAC) and physical layer (PHY) interface to the wireless medium (WM). The term “wireless medium” or WM″ at least in some embodiments refers to the medium used to implement the transfer of protocol data units (PDUs) between peer physical layer (PHY) entities of a wireless local area network (LAN).

The term “network element” at least in some embodiments refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, network access node (NAN), base station, access point (AP), RAN device, RAN node, gateway, server, network appliance, network function (NF), virtualized NF (VNF), and/or the like.

The term “SmartNIC” at least in some embodiments refers to a network interface controller (NIC), network adapter, or a programmable network adapter card with programmable hardware accelerators and network connectivity (e.g., Ethernet or the like) that can offload various tasks or workloads from other compute nodes or compute platforms such as servers, application processors, and/or the like and accelerate those tasks or workloads. A SmartNIC has similar networking and offload capabilities as an IPU, but remains under the control of the host as a peripheral device.

The term “infrastructure processing unit” or “IPU” at least in some embodiments refers to an advanced networking device with hardened accelerators and network connectivity (e.g., Ethernet or the like) that accelerates and manages infrastructure functions using tightly coupled, dedicated, programmable cores. In some implementations, an IPU offers full infrastructure offload and provides an extra layer of security by serving as a control point of a host for running infrastructure applications. An IPU is capable of offloading the entire infrastructure stack from the host and can control how the host attaches to this infrastructure. This gives service providers an extra layer of security and control, enforced in hardware by the IPU.

The term “network access node” or “NAN” at least in some embodiments refers to a network element in a radio access network (RAN) responsible for the transmission and reception of radio signals in one or more cells or coverage areas to or from a UE or station. A “network access node” or “NAN” can have an integrated antenna or may be connected to an antenna array by feeder cables. Additionally or alternatively, a “network access node” or “NAN” may include specialized digital signal processing, network function hardware, and/or compute hardware to operate as a compute node. In some examples, a “network access node” or “NAN” may be split into multiple functional blocks operating in software for flexibility, cost, and performance. In some examples, a “network access node” or “NAN” may be a base station (e.g., an evolved Node B (eNB) or a next generation Node B (gNB)), an access point and/or wireless network access point, router, switch, hub, radio unit or remote radio head, Transmission Reception Point (TRxP), a gateway device (e.g., Residential Gateway, Wireline 5G Access Network, Wireline 5G Cable Access Network, Wireline BBF Access Network, and the like), network appliance, and/or some other network access hardware.

The term “access point” or “AP” at least in some embodiments refers to an entity that contains one station (STA) and provides access to the distribution services, via the wireless medium (WM) for associated STAs. An AP comprises a STA and a distribution system access function (DSAF).

The term “edge computing” encompasses many implementations of distributed computing that move processing activities and resources (e.g., compute, storage, acceleration resources) towards the “edge” of the network, in an effort to reduce latency and increase throughput for endpoint users (client devices, user equipment, etc.). Such edge computing implementations typically involve the offering of such activities and resources in cloud-like services, functions, applications, and subsystems, from one or multiple locations accessible via wireless networks. Thus, the references to an “edge” of a network, cluster, domain, system or computing arrangement used herein are groups or groupings of functional distributed compute elements and, therefore, generally unrelated to “edges” (links or connections) as used in graph theory.

The term “central office” (or CO) indicates an aggregation point for telecommunications infrastructure within an accessible or defined geographical area, often where telecommunication service providers have traditionally located switching equipment for one or multiple types of access networks. The CO can be physically designed to house telecommunications infrastructure equipment or compute, data storage, and network resources. The CO need not, however, be a designated location by a telecommunications service provider. The CO may host any number of compute devices for Edge applications and services, or even local implementations of cloud-like services.

The term “cloud computing” or “cloud” at least in some embodiments refers to a paradigm for enabling network access to a scalable and elastic pool of shareable computing resources with self-service provisioning and administration on-demand and without active management by users.

Cloud computing provides cloud computing services (or cloud services), which are one or more capabilities offered via cloud computing that are invoked using a defined interface (e.g., an API or the like).

The term “compute resource” or simply “resource” at least in some embodiments refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, etc.), OSs, virtual machines (VMs), software/applications, computer files, and/or the like. A “hardware resource” at least in some embodiments refers to compute, storage, and/or network resources provided by physical hardware element(s). A “virtualized resource” at least in some embodiments refers to compute, storage, and/or network resources provided by virtualization infrastructure to an application, device, system, etc. The term “network resource” or “communication resource” at least in some embodiments refers to resources that are accessible by computer devices/systems via a communications network. The term “system resources” at least in some embodiments refers to any kind of shared entities to provide services, and may include computing and/or network resources. System resources may be considered as a set of coherent functions, network data objects or services, accessible through a server where such system resources reside on a single host or multiple hosts and are clearly identifiable.

The term “workload” at least in some embodiments refers to an amount of work performed by a computing system, device, entity, etc., during a period of time or at a particular instant of time. A workload may be represented as a benchmark, such as a response time, throughput (e.g., how much work is accomplished over a period of time), and/or the like. Additionally or alternatively, the workload may be represented as a memory workload (e.g., an amount of memory space needed for program execution to store temporary or permanent data and to perform intermediate computations), processor workload (e.g., a number of instructions being executed by a processor during a given period of time or at a particular time instant), an I/O workload (e.g., a number of inputs and outputs or system accesses during a given period of time or at a particular time instant), database workloads (e.g., a number of database queries during a period of time), a network-related workload (e.g., a number of network attachments, a number of mobility updates, a number of radio link failures, a number of handovers, an amount of data to be transferred over an air interface, etc.), and/or the like. Various algorithms may be used to determine a workload and/or workload characteristics, which may be based on any of the aforementioned workload types.

The term “cloud service provider” or “CSP” at least in some embodiments refers to an organization which operates typically large-scale “cloud” resources comprised of centralized, regional, and Edge data centers (e.g., as used in the context of the public cloud). References to “cloud computing” generally refer to computing resources and services offered by a CSP at remote locations with at least some increased latency, distance, or constraints relative to Edge computing.

The term “cloud storage” at least in some embodiments refers to a model of computer data storage in which data is stored in logical pools, referred to as the “cloud.” Additionally or alternatively, term “cloud storage” at least in some embodiments refers to data storage services provided by or otherwise accessible through a cloud computing service or CSP.

The term “data center” at least in some embodiments refers to a purpose-designed structure that is intended to house multiple high-performance compute and data storage nodes such that a large amount of compute, data storage and network resources are present at a single location. This often entails specialized rack and enclosure systems, suitable heating, cooling, ventilation, security, fire suppression, and power delivery systems. The term may also refer to a compute and data storage node in some contexts. A data center may vary in scale between a centralized or cloud data center (e.g., largest), regional data center, and edge data center (e.g., smallest).

The term “network function” or “NF” at least in some embodiments refers to a functional block within a network infrastructure that has one or more external interfaces and a defined functional behavior. The term “network service” or “NS” at least in some embodiments refers to a composition of Network Function(s) and/or Network Service(s), defined by its functional and behavioral specification(s).

The term “network function virtualization” or “NFV” at least in some embodiments refers to the principle of separating network functions from the hardware they run on by using virtualization techniques and/or virtualization technologies. The term “virtualized network function” or “VNF” at least in some embodiments refers to an implementation of an NF that can be deployed on a Network Function Virtualization Infrastructure (NFVI). The term “Network Functions Virtualization Infrastructure Manager” or “NFVI” at least in some embodiments refers to a totality of all hardware and software components that build up the environment in which VNFs are deployed. The term “Virtualized Infrastructure Manager” or “VIM” at least in some embodiments refers to a functional block that is responsible for controlling and managing the NFVI compute, storage and network resources, usually within one operator's infrastructure domain.

The term “virtualization container” or “container” at least in some embodiments refers to a partition of a compute node that provides an isolated virtualized computation environment. The term “OS container” at least in some embodiments refers to a virtualization container utilizing a shared Operating System (OS) kernel of its host, where the host providing the shared OS kernel can be a physical compute node or another virtualization container.

The term “virtual machine” or “VM” at least in some embodiments refers to a virtualized computation environment that behaves in a same or similar manner as a physical computer and/or a server. The term “hypervisor” at least in some embodiments refers to a software element that partitions the underlying physical resources of a compute node, creates VMs, manages resources for VMs, and isolates individual VMs from each other

The term “edge compute node” or “edge compute device” at least in some embodiments refers to an identifiable entity implementing an aspect of edge computing operations, whether part of a larger system, distributed collection of systems, or a standalone apparatus. In some examples, a compute node may be referred to as a “edge node”, “edge device”, “edge system”, whether in operation as a client, server, or intermediate entity. Additionally or alternatively, the term “edge compute node” at least in some embodiments refers to a real-world, logical, or virtualized implementation of a compute-capable element in the form of a device, gateway, bridge, system or subsystem, component, whether operating in a server, client, endpoint, or peer mode, and whether located at an “edge” of an network or at a connected location further within the network. References to a “node” used herein are generally interchangeable with a “device”, “component”, and “sub-system”; however, references to an “edge computing system” generally refer to a distributed architecture, organization, or collection of multiple nodes and devices, and which is organized to accomplish or offer some aspect of services or resources in an edge computing setting.

The term “Data Network” or “DN” at least in some embodiments refers to a network hosting data-centric services such as, for example, operator services, the internet, third-party services, or enterprise networks. Additionally or alternatively, a DN at least in some embodiments refers to service networks that belong to an operator or third party, which are offered as a service to a client or user equipment (UE). DNs are sometimes referred to as “Packet Data Networks” or “PDNs”. The term “Local Area Data Network” or “LADN” at least in some embodiments refers to a DN that is accessible by the UE only in specific locations, that provides connectivity to a specific DNN, and whose availability is provided to the UE.

The term “Internet of Things” or “IoT” at least in some embodiments refers to a system of interrelated computing devices, mechanical and digital machines capable of transferring data with little or no human interaction, and may involve technologies such as real-time analytics, machine learning and/or AI, embedded systems, wireless sensor networks, control systems, automation (e.g., smart home, smart building and/or smart city technologies), and the like. IoT devices are usually low-power devices without heavy compute or storage capabilities. The term “Edge IoT devices” at least in some embodiments refers to any kind of IoT devices deployed at a network's edge.

The term “radio technology” at least in some embodiments refers to technology for wireless transmission and/or reception of electromagnetic radiation for information transfer.

The term “radio access technology” or “RAT” at least in some embodiments refers to the technology used for the underlying physical connection to a radio based communication network.

The term “communication protocol” (either wired or wireless) at least in some embodiments refers to a set of standardized rules or instructions implemented by a communication device and/or system to communicate with other devices and/or systems, including instructions for packetizing/depacketizing data, modulating/demodulating signals, implementation of protocols stacks, and/or the like.

The term “application layer” at least in some embodiments refers to an abstraction layer that specifies shared communications protocols and interfaces used by hosts in a communications network. Additionally or alternatively, the term “application layer” at least in some embodiments refers to an abstraction layer that interacts with software applications that implement a communicating component, and may include identifying communication partners, determining resource availability, and synchronizing communication. Examples of application layer protocols include HTTP, HTTPs, File Transfer Protocol (FTP), Dynamic Host Configuration Protocol (DHCP), Internet Message Access Protocol (IMAP), Lightweight Directory Access Protocol (LDAP), MQTT, Remote Authentication Dial-In User Service (RADIUS), Diameter protocol, Extensible Authentication Protocol (EAP), RDMA over Converged Ethernet version 2 (RoCEv2), Real-time Transport Protocol (RTP), RTP Control Protocol (RTCP), Real Time Streaming Protocol (RTSP), Skinny Client Control Protocol (SCCP), Session Initiation Protocol (SIP), Session Description Protocol (SDP), Simple Mail Transfer Protocol (SMTP), Simple Network Management Protocol (SNMP), Simple Service Discovery Protocol (SSDP), Small Computer System Interface (SCSI), Internet SCSI (iSCSI), iSCSI Extensions for RDMA (iSER), Transport Layer Security (TLS), voice over IP (VoIP), Virtual Private Network (VPN), Extensible Messaging and Presence Protocol (XMPP), Telecommunication Standardization Sector of the International Telecommunication Union (ITU-T) X.500 (or ISO/IEC 9594), and/or the like.

The term “session layer” at least in some embodiments refers to an abstraction layer that controls dialogues and/or connections between entities or elements, and may include establishing, managing and terminating the connections between the entities or elements.

The term “transport layer” at least in some embodiments refers to a protocol layer that provides e2e communication services such as, for example, connection-oriented communication, reliability, flow control, and multiplexing. Examples of transport layer protocols include datagram congestion control protocol (DCCP), fibre channel protocol (FBC), Generic Routing Encapsulation (GRE), GPRS Tunneling (GTP), Micro Transport Protocol (μTP), Multipath TCP (MPTCP), MultiPath QUIC (MPQUIC), Multipath UDP (MPUDP), Quick UDP Internet Connections (QUIC), Remote Direct Memory Access (RDMA), Resource Reservation Protocol (RSVP), Stream Control Transmission Protocol (SCTP), transmission control protocol (TCP), user datagram protocol (UDP), and/or the like.

The term “network layer” at least in some embodiments refers to a protocol layer that includes means for transferring network packets from a source to a destination via one or more networks. Additionally or alternatively, the term “network layer” at least in some embodiments refers to a protocol layer that is responsible for packet forwarding and/or routing through intermediary nodes. Additionally or alternatively, the term “network layer” or “internet layer” at least in some embodiments refers to a protocol layer that includes interworking methods, protocols, and specifications that are used to transport network packets across a network. As examples, the network layer protocols include internet protocol (IP), IP security (IPsec), Internet Control Message Protocol (ICMP), Internet Group Management Protocol (IGMP), Open Shortest Path First protocol (OSPF), Routing Information Protocol (RIP), RDMA over Converged Ethernet version 2 (RoCEv2), Subnetwork Access Protocol (SNAP), and/or some other internet or network protocol layer.

The term “link layer” or “data link layer” at least in some embodiments refers to a protocol layer that transfers data between nodes on a network segment across a physical layer. Examples of link layer protocols include logical link control (LLC), medium access control (MAC), Ethernet, RDMA over Converged Ethernet version 1 (RoCEv1), and/or the like.

The term “medium access control protocol”, “MAC protocol”, or “MAC” at least in some embodiments refers to a protocol that governs access to the transmission medium in a network, to enable the exchange of data between stations in a network. Additionally or alternatively, the term “medium access control layer”, “MAC layer”, or “MAC” at least in some embodiments refers to a protocol layer or sublayer that performs functions to provide frame-based, connectionless-mode (e.g., datagram style) data transfer between stations or devices. Additionally or alternatively, the term “medium access control layer”, “MAC layer”, or “MAC” at least in some embodiments refers to a protocol layer or sublayer that performs mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per cell in case of CA); priority handling between UEs by means of dynamic scheduling; priority handling between logical channels of one UE by means of logical channel prioritization; priority handling between overlapping resources of one UE; and/or padding (see e.g., [IEEE802], 3GPP TS 38.321 v16.7.0 (2021 Dec. 23) and 3GPP TS 36.321 v16.6.0 (2021 Sep. 27) (collectively referred to as “[TSMAC]”)).

The term “physical layer”, “PHY layer”, or “PHY” at least in some embodiments refers to a protocol layer or sublayer that includes capabilities to transmit and receive modulated signals for communicating in a communications network (see e.g., [IEEE802], 3GPP TS 38.201 v16.0.0 (2020 Jan. 11) and 3GPP TS 36.201 v16.0.0 (2020 Jul. 14)).

The term “RAT type” at least in some embodiments may identify a transmission technology and/or communication protocol used in an access network, for example, new radio (NR), Long Term Evolution (LTE), narrowband IoT (NB-IOT), untrusted non-3GPP, trusted non-3GPP, trusted Institute of Electrical and Electronics Engineers (IEEE) 802 (e.g., [IEEE80211]; see also IEEE Standard for Local and Metropolitan Area Networks: Overview and Architecture, IEEE Std 802-2014, pp. 1-74 (30 Jun. 2014) (“[IEEE802]”), the contents of which is hereby incorporated by reference in its entirety), non-3GPP access, MuLTEfire, WiMAX, wireline, wireline-cable, wireline broadband forum (wireline-BBF), and the like. Examples of RATs and/or wireless communications protocols include Advanced Mobile Phone System (AMPS) technologies such as Digital AMPS (D-AMPS), Total Access Communication System (TACS) (and variants thereof such as Extended TACS (ETACS), etc.); Global System for Mobile Communications (GSM) technologies such as Circuit Switched Data (CSD), High-Speed CSD (HSCSD), General Packet Radio Service (GPRS), and Enhanced Data Rates for GSM Evolution (EDGE); Third Generation Partnership Project (3GPP) technologies including, for example, Universal Mobile Telecommunications System (UMTS) (and variants thereof such as UMTS Terrestrial Radio Access (UTRA), Wideband Code Division Multiple Access (W-CDMA), Freedom of Multimedia Access (FOMA), Time Division-Code Division Multiple Access (TD-CDMA), Time Division-Synchronous Code Division Multiple Access (TD-SCDMA), etc.), Generic Access Network (GAN)/Unlicensed Mobile Access (UMA), High Speed Packet Access (HSPA) (and variants thereof such as HSPA Plus (HSPA+), etc.), Long Term Evolution (LTE) (and variants thereof such as LTE-Advanced (LTE-A), Evolved UTRA (E-UTRA), LTE Extra, LTE-A Pro, LTE LAA, MuLTEfire, etc.), Fifth Generation (5G) or New Radio (NR), etc.; ETSI technologies such as High Performance Radio Metropolitan Area Network (HiperMAN) and the like; IEEE technologies such as [IEEE802] and/or WiFi (e.g., [IEEE80211] and variants thereof), Worldwide Interoperability for Microwave Access (WiMAX) (e.g., [WiMAX] and variants thereof), Mobile Broadband Wireless Access (MBWA)/iBurst (e.g., IEEE 802.20 and variants thereof), etc.; Integrated Digital Enhanced Network (iDEN) (and variants thereof such as Wideband Integrated Digital Enhanced Network (WiDEN); millimeter wave (mmWave) technologies/standards (e.g., wireless systems operating at 10-300 GHz and above such as 3GPP 5G, Wireless Gigabit Alliance (WiGig) standards (e.g., IEEE 802.11ad, IEEE 802.11ay, and the like); short-range and/or wireless personal area network (WPAN) technologies/standards such as Bluetooth (and variants thereof such as Bluetooth 5.3, Bluetooth Low Energy (BLE), etc.), IEEE 802.15 technologies/standards (e.g., IEEE Standard for Low-Rate Wireless Networks, IEEE Std 802.15.4-2020, pp. 1-800 (23 Jul. 2020) (“[IEEE802154]”), ZigBee, Thread, IPv6 over Low power WPAN (6LoWPAN), WirelessHART, MiWi, ISA100.11a, IEEE Standard for Local and metropolitan area networks—Part 15.6: Wireless Body Area Networks, IEEE Std 802.15.6-2012, pp. 1-271 (29 Feb. 2012), WiFi-direct, ANT/ANT+, Z-Wave, 3GPP Proximity Services (ProSe), Universal Plug and Play (UPnP), low power Wide Area Networks (LPWANs), Long Range Wide Area Network (LoRA or LoRaWAN™), and the like; optical and/or visible light communication (VLC) technologies/standards such as IEEE Standard for Local and metropolitan area networks—Part 15.7: Short-Range Optical Wireless Communications, IEEE Std 802.15.7-2018, pp. 1-407 (23 Apr. 2019), and the like; V2X communication including 3GPP cellular V2X (C-V2X), Wireless Access in Vehicular Environments (WAVE) (IEEE Standard for Information technology—Local and metropolitan area networks—Specific requirements—Part 11: Wireless LAN Medium Access Control (MAC) and Physical Layer (PHY) Specifications Amendment 6: Wireless Access in Vehicular Environments, IEEE Std 802.11p-2010, pp. 1-51 (15 Jul. 2010) (“[IEEE80211p]”), which is now part of [IEEE80211]), IEEE 802.11bd (e.g., for vehicular ad-hoc environments), Dedicated Short Range Communications (DSRC), Intelligent-Transport-Systems (ITS) (including the European ITS-G5, ITS-GSB, ITS-GSC, etc.); Sigfox; Mobitex; 3GPP2 technologies such as cdmaOne (2G), Code Division Multiple Access 2000 (CDMA 2000), and Evolution-Data Optimized or Evolution-Data Only (EV-DO); Push-to-talk (PTT), Mobile Telephone System (MTS) (and variants thereof such as Improved MTS (IMTS), Advanced MTS (AMTS), etc.); Personal Digital Cellular (PDC); Personal Handy-phone System (PHS), Cellular Digital Packet Data (CDPD); Cellular Digital Packet Data (CDPD); DataTAC; Digital Enhanced Cordless Telecommunications (DECT) (and variants thereof such as DECT Ultra Low Energy (DECT ULE), DECT-2020, DECT-5G, etc.); Ultra High Frequency (UHF) communication; Very High Frequency (VHF) communication; and/or any other suitable RAT or protocol. In addition to the aforementioned RATs/standards, any number of satellite uplink technologies may be used for purposes of the present disclosure including, for example, radios compliant with standards issued by the International Telecommunication Union (ITU), or the ETSI, among others. The examples provided herein are thus understood as being applicable to various other communication technologies, both existing and not yet formulated.

The term “channel” at least in some embodiments refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” at least in some embodiments refers to a connection between two devices through a RAT for the purpose of transmitting and receiving information.

The term “reliability” at least in some embodiments refers to the ability of a computer-related component (e.g., software, hardware, or network element/entity) to consistently perform a desired function and/or operate according to a specification. Reliability in the context of network communications (e.g., “network reliability”) at least in some embodiments refers to the ability of a network to carry out communication. The term “network reliability” at least in some embodiments refers to a probability or measure of delivering a specified amount of data from a source to a destination (or sink).

The term “flow” at least in some embodiments refers to a sequence of data and/or data units (e.g., datagrams, packets, or the like) from a source entity/element to a destination entity/element. Additionally or alternatively, the terms “flow” or “traffic flow” at least in some embodiments refer to an artificial and/or logical equivalent to a call, connection, or link.

Additionally or alternatively, the terms “flow” or “traffic flow” at least in some embodiments refer to a sequence of packets sent from a particular source to a particular unicast, anycast, or multicast destination that the source desires to label as a flow; from an upper-layer viewpoint, a flow may include of all packets in a specific transport connection or a media stream, however, a flow is not necessarily 1:1 mapped to a transport connection. Additionally or alternatively, the terms “flow” or “traffic flow” at least in some embodiments refer to a set of data and/or data units (e.g., datagrams, packets, or the like) passing an observation point in a network during a certain time interval. Additionally or alternatively, the term “flow” at least in some embodiments refers to a user plane data link that is attached to an association. Examples are circuit switched phone call, voice over IP call, reception of an SMS, sending of a contact card, PDP context for internet access, demultiplexing a TV channel from a channel multiplex, calculation of position coordinates from geopositioning satellite signals, etc. For purposes of the present disclosure, the terms “traffic flow”, “data flow”, “dataflow”, “packet flow”, “network flow”, and/or “flow” may be used interchangeably even though these terms at least in some embodiments refers to different concepts.

The term “dataflow” or “data flow” at least in some embodiments refers to the movement of data through a system including software elements, hardware elements, or a combination of both software and hardware elements. Additionally or alternatively, the term “dataflow” or “data flow” at least in some embodiments refers to a path taken by a set of data from an origination or source to destination that includes all nodes through which the set of data travels.

The term “stream” at least in some embodiments refers to a sequence of data elements made available over time. At least in some embodiments, functions that operate on a stream, which may produce another stream, are referred to as “filters,” and can be connected in pipelines, analogously to function composition; filters may operate on one item of a stream at a time, or may base an item of output on multiple items of input, such as a moving average. Additionally or alternatively, the term “stream” or “streaming” at least in some embodiments refers to a manner of processing in which an object is not represented by a complete logical data structure of nodes occupying memory proportional to a size of that object, but are processed “on the fly” as a sequence of events.

The term “distributed computing” at least in some embodiments refers to computation resources that are geographically distributed within the vicinity of one or more localized networks' terminations. The term “distributed computations” at least in some embodiments refers to a model in which components located on networked computers communicate and coordinate their actions by passing messages interacting with each other in order to achieve a common goal.

The term “service” at least in some embodiments refers to the provision of a discrete function within a system and/or environment. Additionally or alternatively, the term “service” at least in some embodiments refers to a functionality or a set of functionalities that can be reused.

The term “microservice” at least in some embodiments refers to one or more processes that communicate over a network to fulfil a goal using technology-agnostic protocols (e.g., HTTP or the like). Additionally or alternatively, the term “microservice” at least in some embodiments refers to services that are relatively small in size, messaging-enabled, bounded by contexts, autonomously developed, independently deployable, decentralized, and/or built and released with automated processes. Additionally or alternatively, the term “microservice” at least in some embodiments refers to a self-contained piece of functionality with clear interfaces, and may implement a layered architecture through its own internal components. Additionally or alternatively, the term “microservice architecture” at least in some embodiments refers to a variant of the service-oriented architecture (SOA) structural style wherein applications are arranged as a collection of loosely-coupled services (e.g., fine-grained services) and may use lightweight protocols.

The term “network service” at least in some embodiments refers to a composition of Network Function(s) and/or Network Service(s), defined by its functional and behavioral specification.

The term “session” at least in some embodiments refers to a temporary and interactive information interchange between two or more communicating devices, two or more application instances, between a computer and user, and/or between any two or more entities or elements. Additionally or alternatively, the term “session” at least in some embodiments refers to a connectivity service or other service that provides or enables the exchange of data between two entities or elements. The term “network session” at least in some embodiments refers to a session between two or more communicating devices over a network. The term “web session” at least in some embodiments refers to session between two or more communicating devices over the Internet or some other network. The term “session identifier,” “session ID,” or “session token” at least in some embodiments refers to a piece of data that is used in network communications to identify a session and/or a series of message exchanges.

The term “quality” at least in some embodiments refers to a property, character, attribute, or feature of something as being affirmative or negative, and/or a degree of excellence of something. Additionally or alternatively, the term “quality” at least in some embodiments, in the context of data processing, refers to a state of qualitative and/or quantitative aspects of data, processes, and/or some other aspects of data processing systems.

The term “Quality of Service” or “QoS’ at least in some embodiments refers to a description or measurement of the overall performance of a service (e.g., telephony and/or cellular service, network service, wireless communication/connectivity service, cloud computing service, etc.). In some cases, the QoS may be described or measured from the perspective of the users of that service, and as such, QoS may be the collective effect of service performance that determine the degree of satisfaction of a user of that service. In other cases, QoS at least in some embodiments refers to traffic prioritization and resource reservation control mechanisms rather than the achieved perception of service quality. In these cases, QoS is the ability to provide different priorities to different applications, users, or flows, or to guarantee a certain level of performance to a flow. In either case, QoS is characterized by the combined aspects of performance factors applicable to one or more services such as, for example, service operability performance, service accessibility performance; service retain ability performance; service reliability performance, service integrity performance, and other factors specific to each service. Several related aspects of the service may be considered when quantifying the QoS, including packet loss rates, bit rates, throughput, transmission delay, availability, reliability, jitter, signal strength and/or quality measurements, and/or other measurements such as those discussed herein. Additionally or alternatively, the term “Quality of Service” or “QoS’ at least in some embodiments refers to mechanisms that provide traffic-forwarding treatment based on flow-specific traffic classification. In some implementations, the term “Quality of Service” or “QoS” can be used interchangeably with the term “Class of Service” or “CoS”.

The term “forwarding treatment” at least in some embodiments refers to the precedence, preferences, and/or prioritization a packet belonging to a particular dataflow receives in relation to other traffic of other dataflows. Additionally or alternatively, the term “forwarding treatment” at least in some embodiments refers to one or more parameters, characteristics, and/or configurations to be applied to packets belonging to a dataflow when processing the packets for forwarding. Examples of such characteristics may include resource type (e.g., non-guaranteed bit rate (GBR), GBR, delay-critical GBR, etc.); priority level; class or classification; packet delay budget; packet error rate; averaging window; maximum data burst volume; minimum data burst volume; scheduling policy/weights; queue management policy; rate shaping policy; link layer protocol and/or RLC configuration; admission thresholds; etc. In some implementations, the term “forwarding treatment” may be referred to as “Per-Hop Behavior” or “PHB”.

The term “best effort delivery” or “best effort” at least in some embodiments refers to a network service or forwarding treatment in which there is no guarantee that data (or individual packets) will be delivered or that data/packet delivery will meet a particular QoS or CoS treatment. Under best effort, network performance characteristics (e.g., network delay, packet loss, latency, and the like) depend on the current network traffic load and/or the network hardware capacity such that the likelihood of packet delay variation, network delay, packet loss, retransmission, timeout, session disconnect, and the like increase as the network load increases.

The term “real-time” or “real time” at least in some embodiments refers to various operations in computing and/or other processes that guarantee response times within a specified time (e.g., a deadline), usually a relatively short time. The term “real-time” or “real time” at least in some embodiments refers to hardware and software systems subject to a specified time constraint.

The term “queue” at least in some embodiments refers to a collection of entities (e.g., data, objects, events, etc.) are stored and held to be processed later. that are maintained in a sequence and can be modified by the addition of entities at one end of the sequence and the removal of entities from the other end of the sequence; the end of the sequence at which elements are added may be referred to as the “back”, “tail”, or “rear” of the queue, and the end at which elements are removed may be referred to as the “head” or “front” of the queue. Additionally, a queue may perform the function of a buffer, and the terms “queue” and “buffer” may be used interchangeably throughout the present disclosure. The term “enqueue” at least in some embodiments refers to one or more operations of adding an element to the rear of a queue. The term “dequeue” at least in some embodiments refers to one or more operations of removing an element from the front of a queue.

The term “time to live” (or “TTL”) or “hop limit” at least in some embodiments refers to a mechanism which limits the lifespan or lifetime of data in a computer or network. TTL may be implemented as a counter or timestamp attached to or embedded in the data. Once the prescribed event count or timespan has elapsed, data is discarded or revalidated.

The term “piggyback” or “piggybacking”, in the context of computer communications and/or networking, refers to attaching, appending, or hooking a first data unit to a second data unit that is to be transmitted next or sometime before the first data unit; in this way, the first data unit gets a “free ride” in the data packet or frame carrying the second data unit.

The term “channel coding” at least in some embodiments refers to processes and/or techniques to add redundancy to messages or packets in order to make those messages or packets more robust against noise, channel interference, limited channel bandwidth, and/or other errors. For purposes of the present disclosure, the term “channel coding” can be used interchangeably with the terms “forward error correction” or “FEC”; “error correction coding”, “error correction code”, or “ECC”; and/or “network coding” or “NC”.

The term “network coding” at least in some embodiments refers to processes and/or techniques in which transmitted data is encoded and decoded to improve network performance.

The term “code rate” at least in some embodiments refers to the proportion of a data stream or flow that is useful or non-redundant (e.g., for a code rate of k/n, for every k bits of useful information, the (en)coder generates a total of n bits of data, of which n−k are redundant).

The term “systematic code” at least in some embodiments refers to any error correction code in which the input data is embedded in the encoded output. The term “non-systematic code” at least in some embodiments refers to any error correction code in which the input data is not embedded in the encoded output.

The term “interleaving” at least in some embodiments refers to a process to rearrange code symbols so as to spread bursts of errors over multiple codewords that can be corrected by ECCs.

The term “code word” or “codeword” at least in some embodiments refers to an element of a code or protocol, which is assembled in accordance with specific rules of the code or protocol.

The term “PDU Connectivity Service” at least in some embodiments refers to a service that provides exchange of protocol data units (PDUs) between a UE and a data network (DN). The term “PDU Session” at least in some embodiments refers to an association between a UE and a DN that provides a PDU connectivity service (see e.g., 3GPP TS 38.415 v16.6.0 (2021 Dec. 23) (“[TS38415]”) and 3GPP TS 38.413 v16.8.0 (2021 Dec. 23) (“[TS538413]”), the contents of each of which are hereby incorporated by reference in their entireties); a PDU Session type can be IPv4, IPv6, IPv4v6, Ethernet, Unstructured, or any other network/connection type, such as those discussed herein. The term “PDU Session Resource” at least in some embodiments refers to an NG-RAN interface (e.g., NG, Xn, and/or E1 interfaces) and radio resources provided to support a PDU Session. The term “multi-access PDU session” or “MA PDU Session” at least in some embodiments refers to a PDU Session that provides a PDU connectivity service, which can use one access network at a time or multiple access networks simultaneously.

The term “traffic shaping” at least in some embodiments refers to a bandwidth management technique that manages data transmission to comply with a desired traffic profile or class of service. Traffic shaping ensures sufficient network bandwidth for time-sensitive, critical applications using policy rules, data classification, queuing, QoS, and other techniques. The term “throttling” at least in some embodiments refers to the regulation of flows into or out of a network, or into or out of a specific device or element.

The term “access traffic steering” or “traffic steering” at least in some embodiments refers to a procedure that selects an access network for a new data flow and transfers the traffic of one or more data flows over the selected access network. Access traffic steering is applicable between one 3GPP access and one non-3GPP access.

The term “access traffic switching” or “traffic switching” at least in some embodiments refers to a procedure that moves some or all traffic of an ongoing data flow from at least one access network to at least one other access network in a way that maintains the continuity of the data flow.

The term “access traffic splitting” or “traffic splitting” at least in some embodiments refers to a procedure that splits the traffic of at least one data flow across multiple access networks. When traffic splitting is applied to a data flow, some traffic of the data flow is transferred via at least one access channel, link, or path, and some other traffic of the same data flow is transferred via another access channel, link, or path.

The term “network address” at least in some embodiments refers to an identifier for a node or host in a computer network, and may be a unique identifier across a network and/or may be unique to a locally administered portion of the network. Examples of network addresses include a Closed Access Group Identifier (CAG-ID), Bluetooth hardware device address (BD_ADDR), a cellular network address (e.g., Access Point Name (APN), AMF identifier (ID), AF-Service-Identifier, Edge Application Server (EAS) ID, Data Network Access Identifier (DNAI), Data Network Name (DNN), EPS Bearer Identity (EBI), Equipment Identity Register (EIR) and/or 5G-EIR, Extended Unique Identifier (EUI), Group ID for Network Selection (GIN), Generic Public Subscription Identifier (GPSI), Globally Unique AMF Identifier (GUAMI), Globally Unique Temporary Identifier (GUTI) and/or 5G-GUTI, Radio Network Temporary Identifier (RNTI), International Mobile Equipment Identity (IMEI), IMEI Type Allocation Code (IMEA/TAC), International Mobile Subscriber Identity (IMSI), IMSI software version (IMSISV), permanent equipment identifier (PEI), Local Area Data Network (LADN) DNN, Mobile Subscriber Identification Number (MSIN), Mobile Subscriber/Station ISDN Number (MSISDN), Network identifier (NID), Network Slice Instance (NSI) ID, Permanent Equipment Identifier (PEI), Public Land Mobile Network (PLMN) ID, QoS Flow ID (QFI) and/or 5G QoS Identifier (5QI), RAN ID, Routing Indicator, SMS Function (SMSF) ID, Stand-alone Non-Public Network (SNPN) ID, Subscription Concealed Identifier (SUCI), Subscription Permanent Identifier (SUPI), Temporary Mobile Subscriber Identity (TMSI) and variants thereof, UE Access Category and Identity, and/or other cellular network related identifiers), an email address, Enterprise Application Server (EAS) ID, an endpoint address, an Electronic Product Code (EPC) as defined by the EPCglobal Tag Data Standard, a Fully Qualified Domain Name (FQDN), an internet protocol (IP) address in an IP network (e.g., IP version 4 (Ipv4), IP version 6 (IPv6), etc.), an internet packet exchange (IPX) address, Local Area Network (LAN) ID, a media access control (MAC) address, personal area network (PAN) ID, a port number (e.g., Transmission Control Protocol (TCP) port number, User Datagram Protocol (UDP) port number), QUIC connection ID, RFID tag, service set identifier (SSID) and variants thereof, telephone numbers in a public switched telephone network (PTSN), a socket address, universally unique identifier (UUID) (e.g., as specified in ISO/IEC 11578:1996), a Universal Resource Locator (URL) and/or Universal Resource Identifier (URI), Virtual LAN (VLAN) ID, an X.21 address, an X.25 address, Zigbee® ID, Zigbee® Device Network ID, and/or any other suitable network address and components thereof.

The term “application identifier”, “application ID”, or “app ID” at least in some embodiments refers to an identifier that can be mapped to a specific application or application instance; in the context of 3GPP 5G/NR systems, an “application identifier” at least in some embodiments refers to an identifier that can be mapped to a specific application traffic detection rule.

The term “endpoint address” at least in some embodiments refers to an address used to determine the host/authority part of a target URI, where the target URI is used to access an NF service (e.g., to invoke service operations) of an NF service producer or for notifications to an NF service consumer.

The term “closed access group” or “CAG” at least in some embodiments refers to a group of list of users permitted to connect and/or access a specific network, a specific access network, and/or attach to a specific cell or network access node. Closed access groups (CAGs) are sometimes referred to as Access Control Lists (ACLs), Closed Subscriber Groups (CSGs), Closed User Groups (CUGs), and the like. The term “CAG-ID” at least in some embodiments refers to an identifier of a CAG.

The term “port” in the context of computer networks, at least in some embodiments refers to a communication endpoint, a virtual data connection between two or more entities, and/or a virtual point where network connections start and end. Additionally or alternatively, a “port” at least in some embodiments is associated with a specific process or service.

The term “physical rate” or “PHY rate” at least in some embodiments refers to a speed at which one or more bits are actually sent over a transmission medium. Additionally or alternatively, the term “physical rate” or “PHY rate” at least in some embodiments refers to a speed at which data can move across a wireless link between a transmitter and a receiver.

The term “delay” at least in some embodiments refers to a time interval between two events. Additionally or alternatively, the term “delay” at least in some embodiments refers to a time interval between the propagation of a signal and its reception.

The term “packet delay” at least in some embodiments refers to the time it takes to transfer any packet from one point to another. Additionally or alternatively, the term “packet delay” or “per packet delay” at least in some embodiments refers to the difference between a packet reception time and packet transmission time. Additionally or alternatively, the “packet delay” or “per packet delay” can be measured by subtracting the packet sending time from the packet receiving time where the transmitter and receiver are at least somewhat synchronized.

The term “processing delay” at least in some embodiments refers to an amount of time taken to process a packet in a network node.

The term “transmission delay” at least in some embodiments refers to an amount of time needed (or necessary) to push a packet (or all bits of a packet) into a transmission medium.

The term “propagation delay” at least in some embodiments refers to amount of time it takes a signal's header to travel from a sender to a receiver.

The term “network delay” at least in some embodiments refers to the delay of an a data unit within a network (e.g., an IP packet within an IP network).

The term “queuing delay” at least in some embodiments refers to an amount of time a job waits in a queue until that job can be executed. Additionally or alternatively, the term “queuing delay” at least in some embodiments refers to an amount of time a packet waits in a queue until it can be processed and/or transmitted.

The term “delay bound” at least in some embodiments refers to a predetermined or configured amount of acceptable delay. The term “per-packet delay bound” at least in some embodiments refers to a predetermined or configured amount of acceptable packet delay where packets that are not processed and/or transmitted within the delay bound are considered to be delivery failures and are discarded or dropped.

The term “packet drop rate” at least in some embodiments refers to a share of packets that were not sent to the target due to high traffic load or traffic management and should be seen as a part of the packet loss rate.

The term “packet loss rate” at least in some embodiments refers to a share of packets that could not be received by the target, including packets dropped, packets lost in transmission and packets received in wrong format.

The term “latency” at least in some embodiments refers to a time delay between the cause and the effect of some physical change in a system being observed. Additionally or alternatively, the term “latency” at least in some embodiments refers to the amount of time it takes to transfer a first/initial data unit in a data burst from one point to another. Additionally or alternatively, the term “latency” at least in some embodiments refers to an interval between two points in time. Additionally or alternatively, the term “latency” at least in some embodiments refers to a time interval or amount of time of an event.

The term “P99 latency” or “99th percentile latency” at least in some embodiments refers to the worst latency that is observed by 99% of all requests.

The term “bandwidth” at least in some embodiments refers to a measurement of bit-rate of available or consumed data communication resources, which may be expressed in bits per second (bit/s) or multiples thereof (e.g., kbit/s, Mbit/s, Gbit/s, and the like).

The term “throughput” or “network throughput” at least in some embodiments refers to a rate of production or the rate at which something is processed. Additionally or alternatively, the term “throughput” or “network throughput” at least in some embodiments refers to a rate of successful message (date) delivery over a communication channel. The term “goodput” at least in some embodiments refers to a number of useful information bits delivered by the network to a certain destination per unit of time.

The term “application” at least in some embodiments refers to a computer program designed to carry out a specific task other than one relating to the operation of the computer itself. Additionally or alternatively, term “application” at least in some embodiments refers to a complete and deployable package, environment to achieve a certain function in an operational environment.

The term “algorithm” at least in some embodiments refers to an unambiguous specification of how to solve a problem or a class of problems by performing calculations, input/output operations, data processing, automated reasoning tasks, and/or the like.

The term “application programming interface” or “API” at least in some embodiments refers to a set of subroutine definitions, communication protocols, and tools for building software. Additionally or alternatively, the term “application programming interface” or “API” at least in some embodiments refers to a set of clearly defined methods of communication among various components. An API may be for a web-based system, operating system, database system, computer hardware, or software library.

The terms “instantiate,” “instantiation,” and the like at least in some embodiments refers to the creation of an instance. An “instance” also at least in some embodiments refers to a concrete occurrence of an object, which may occur, for example, during execution of program code.

The term “data processing” or “processing” at least in some embodiments refers to any operation or set of operations which is performed on data or on sets of data, whether or not by automated means, such as collection, recording, writing, organization, structuring, storing, adaptation, alteration, retrieval, consultation, use, disclosure by transmission, dissemination or otherwise making available, alignment or combination, restriction, erasure and/or destruction.

The term “data pipeline” or “pipeline” at least in some embodiments refers to a set of data processing elements (or data processors) connected in series and/or in parallel, where the output of one data processing element is the input of one or more other data processing elements in the pipeline; the elements of a pipeline may be executed in parallel or in time-sliced fashion and/or some amount of buffer storage can be inserted between elements.

The term “packet processor” at least in some embodiments refers to software and/or hardware element(s) that transform a stream of input packets into output packets (or transforms a stream of input data into output data); examples of the transformations include adding, removing, and modifying fields in a packet header, trailer, and/or payload.

The term “use case” at least in some embodiments refers to a description of a system from a user's perspective. Use cases sometimes treat a system as a black box, and the interactions with the system, including system responses, are perceived as from outside the system. Use cases typically avoid technical jargon, preferring instead the language of the end user or domain expert.

The term “user” at least in some embodiments refers to an abstract representation of any entity issuing command requests to a service provider and/or receiving services from a service provider.

The term “cache” at least in some embodiments refers to a hardware and/or software component that stores data so that future requests for that data can be served faster. The term “cache hit” at least in some embodiments refers to the event of requested data being found in a cache; cache hits are served by reading data from the cache, which is faster than precomputing a result or reading from a slower data store. The term “cache miss” at least in some embodiments refers to the event of requested data not being found in a cache.

The term “cache replacement algorithm”, “cache replacement policy”, “cache eviction algorithm”, “cache algorithm”, or “caching algorithm” at least in some embodiments refers to an optimization instructions or algorithms used by a caching system to manage cached data stored by the caching system. Examples of cache algorithms include Bélády's algorithm, random replacement (RR), first-in first-out (FIFO), last-in first-out (LIFO), first-in last-out (FILO), least recently used (LRU), time-aware LRU (TLRU), pseudo-LRU (PLRU), most recently used (MRU), least frequently used (LFU), LFU with dynamic aging (LFUDA), least frequent recently used (LFRU), re-reference interval prediction (RRIP), low inter-reference recency set (LIRS), adaptive replacement cache (ARC), Markov chain-based cache replacement, multi-queue algorithm (MQ), and/or the like.

The term “cache eviction policy” or “cache eviction algorithm” at least in some embodiments refers to an a method of determining whether an element in a cache should be removed from the cache, which may take place or otherwise be performed when the cache is full.

The term “cache retention policy” or “cache retention algorithm” at least in some embodiments refers to an a method of determining whether an element in a cache should be retained or not evicted from the cache, which may take place or otherwise be performed when the cache is full.

The term “distributed cache” at least in some embodiments refers to a caching system that spans multiple servers and/or that can scale in size and/or transactional capacity. Distributed caching systems are often used for storing application data residing in a database system and/or web session data.

The term “cache stampede” or “cache dog-piling” at least in some embodiments refers to a type of cascading failure that can occur when massively parallel computing systems with caching mechanisms come under very high load.

The term “cascading failure” at least in some embodiments refers to a failure of one element in a system of interconnected elements triggers, causes, or otherwise impacts the failure of one or more other elements in the system of interconnected elements. In an example of a cascading failure, failure of a first element in a system results in one or more other elements compensating for the first element, which in turn overloads the one or more other elements, causing the one or more other elements to fail as well, prompting additional elements in the system to fail one after another.

The term “cache replication” or “replication” at least in some embodiments refers to the creation and maintenance of distributed copies of content under the control of content providers.

The term “cache replication factor” or “replication factor” at least in some embodiments refers to a number of copies of data that a cluster or storage tier is to maintain.

The term “cache freshness” or “fresh” at least in some embodiments refers to cached objects that are considered to be relevant, or considered to be a candidate to be served to a requestor. In some cases, cached objects may be considered fresh if those objects are within a freshness time frame or period as specified by the caching policy.

The term “cache staleness” or “stale” at least in some embodiments refers to cached objects that are considered to be candidates for eviction from a cache. In some cases, cached objects may be considered stale if those objects remain in the cache up to or beyond a time period set by a caching policy.

The term “cold cache” at least in some embodiments refers to a cache that is empty or has irrelevant data. The term “hot cache” at least in some embodiments refers to a cache that contains relevant data and/or where all requests for objects are satisfied from the cache itself. The term “cache warming” at least in some embodiments refers to a methods or techniques of preloading a cache with objects that are likely to be requested by one or more requestors.

The term “cache latency” at least in some embodiments refers to a latency or time duration per incoming access operation for items found in a cache.

The term “conflict misses” at least in some embodiments refers to cache misses that occur when requested data was in a cache previously, but got evicted.

The term “capacity misses” at least in some embodiments refers to cache misses that occur due to the limited size of a cache and not the cache's mapping function. The term “coherence misses” at least in some embodiments refers to cache misses that occur because a cache line that would otherwise be present in the thread's cache has been invalidated by a write from another thread. The term “coverage misses” at least in some embodiments refers to cache misses that occur because a cache line that would otherwise be present in the processor's cache has been invalidated as a consequence of a directory eviction. The term “replaced misses” at least in some embodiments refers to cache misses that occur when a cache state is modified and some of its blocks are replaced due to a context switch. The term “reordered misses” at least in some embodiments refers to cache misses that occur when a cache state is modified and some of its blocks have a change in recency due to a context switch).

The term “hit rate” at least in some embodiments refers to the number of accesses to the cache that actually find that data in the cache. The term “hit ratio” at least in some embodiments refers to the ratio of the number of cache hits to the total number of cache requests over a given period of time. The term “hit latency” at least in some embodiments refers to the number of accesses to the cache that do not find the block in the cache. The term “miss rate” at least in some embodiments refers to the number of accesses to the cache that do not find that data in the cache. The term “miss ratio” at least in some embodiments refers to a ratio of the number of cache misses to the total number of cache requests over a given period of time. The term “miss latency” at least in some embodiments refers to latency incurred due to a cache miss. The term “average latency” at least in some embodiments refers to the time spent waiting for an object to be accessed or obtained. The term “average memory access time” or “AMAT” at least in some embodiments refers to average time it takes to access the memory, based on hit time, miss penalty, and miss rate. The term “average miss penalty” or “AMP” at least in some embodiments refers to the cost of a cache miss in terms of time. The term “average cache occupancy” at least in some embodiments refers to the time the cache is busy for each reference.

The term “tiered storage architecture” or “tiered storage” at least in some embodiments refers to a scheme or method of assigning different categories of data to various types of storage media. Additionally or alternatively, the term “tiered storage architecture” or “tiered storage” at least in some embodiments refers to a storage architecture categorizes data hierarchically based on one or more factors such as performance, availability, location, media costs, access frequency, and/or other like factors or parameters. The term “storage tier” at least in some embodiments refers to a rank or categorized set of storage elements in a tiered storage architecture.

The term “data unit” at least in some embodiments at least in some embodiments refers to a basic transfer unit associated with a packet-switched network; a data unit may be structured to have header and payload sections. The term “data unit” at least in some embodiments may be synonymous with any of the following terms, even though they may refer to different aspects: “datagram”, a “protocol data unit” or “PDU”, a “service data unit” or “SDU”, “frame”, “packet”, a “network packet”, “segment”, “block”, “cell”, “chunk”, and/or the like. Examples of data units, network packets, and the like, include internet protocol (IP) packet, Internet Control Message Protocol (ICMP) packet, UDP packet, TCP packet, SCTP packet, ICMP packet, Ethernet frame, RRC messages/packets, SDAP PDU, SDAP SDU, PDCP PDU, PDCP SDU, MAC PDU, MAC SDU, BAP PDU. BAP SDU, RLC PDU, RLC SDU, WiFi frames as discussed in a [IEEE802] protocol/standard (e.g., [IEEE80211] or the like), and/or other like data structures.

The term “information element” or “IE” at least in some embodiments refers to a structural element containing one or more fields. Additionally or alternatively, the term “information element” or “IE” at least in some embodiments refers to a field or set of fields defined in a standard or specification that is used to convey data and/or protocol information.

The term “field” at least in some embodiments refers to individual contents of an information element, or a data element that contains content.

The term “data element” or “DE” at least in some embodiments refers to a data type that contains one single data. Additionally or alternatively, the term “data element” at least in some embodiments refers to an atomic state of a particular object with at least one specific property at a certain point in time, and may include one or more of a data element name or identifier, a data element definition, one or more representation terms, enumerated values or codes (e.g., metadata), and/or a list of synonyms to data elements in other metadata registries. Additionally or alternatively, a “data element” at least in some embodiments refers to a data type that contains one single data. Data elements may store data, which may be referred to as the data element's content (or “content items”). Content items may include text content, attributes, properties, and/or other elements referred to as “child elements.” Additionally or alternatively, data elements may include zero or more properties and/or zero or more attributes, each of which may be defined as database objects (e.g., fields, records, etc.), object instances, and/or other data elements. An “attribute” at least in some embodiments refers to a markup construct including a name—value pair that exists within a start tag or empty element tag. Attributes contain data related to its element and/or control the element's behavior.

The term “data frame” or “DF” at least in some embodiments refers to a data type that contains more than one data element in a predefined order.

The term “reference” at least in some embodiments refers to data useable to locate other data and may be implemented a variety of ways (e.g., a pointer, an index, a handle, a key, an identifier, a hyperlink, etc.).

The term “database” at least in some embodiments refers to an organized collection of data stored and accessed electronically. Databases at least in some embodiments can be implemented according to a variety of different database models, such as relational, non-relational (also referred to as “schema-less” and “NoSQL”), graph, columnar (also referred to as extensible record), object, tabular, tuple store, and multi-model. Examples of non-relational database models include key-value store and document store (also referred to as document-oriented as they store document-oriented information, which is also known as semi-structured data). A database may comprise one or more database objects that are managed by a database management system (DBMS).

The term “database object” at least in some embodiments refers to any representation of information that is in the form of an object, attribute-value pair (AVP), key-value pair (KVP), tuple, etc., and may include variables, data structures, functions, methods, classes, database records, database fields, database entities, associations between data and/or database entities (also referred to as a “relation”), blocks in block chain implementations, and links between blocks in block chain implementations. Furthermore, a database object may include a number of records, and each record may include a set of fields. A database object can be unstructured or have a structure defined by a DBMS (a standard database object) and/or defined by a user (a custom database object). In some implementations, a record may take different forms based on the database model being used and/or the specific database object to which it belongs. For example, a record may be: 1) a row in a table of a relational database; 2) a JavaScript Object Notation (JSON) object; 3) an Extensible Markup Language (XML) document; 4) a KVP; etc.

The term “cryptographic hash function”, “hash function”, or “hash”) at least in some embodiments refers to a mathematical algorithm that maps data of arbitrary size (sometimes referred to as a “message”) to a bit array of a fixed size (sometimes referred to as a “hash value”, “hash”, or “message digest”). A cryptographic hash function is usually a one-way function, which is a function that is practically infeasible to invert.

The term “hash table” at least in some embodiments refers to a data structure that implements an associative array and/or a structure that can map keys to values, wherein a hash function is used to compute an index (or a hash code) into an array of buckets (or slots) from which the desired value can be found. During lookup, a key is hashed and the resulting hash indicates where the corresponding value is stored.

The term “consistent hashing” at least in some embodiments refers to a hashing technique wherein, when a hash table is resized, only keys need to be remapped on average where is the number of keys and is the number of slots. In contrast, in most traditional hash tables, a change in the number of array slots causes nearly all keys to be remapped because the mapping between the keys and the slots is defined by a modular operation.

The term “loss function” or “cost function” at least in some embodiments refers to an event or values of one or more variables onto a real number that represents some “cost” associated with the event. A value calculated by a loss function may be referred to as a “loss”, a “cost”, or “error” value or the like. Additionally or alternatively, the term “loss function” or “cost function” at least in some embodiments refers to a function used to determine the error or loss between the output of an algorithm and a target value. Additionally or alternatively, the term “loss function” or “cost function” at least in some embodiments refers to a function are used in optimization problems with the goal of minimizing a loss or error.

The term “objective function” at least in some embodiments refers to a function to be maximized or minimized for a specific optimization problem. In some cases, an objective function is defined by its decision variables and an objective. The objective is the value, target, or goal to be optimized, such as maximizing profit or minimizing usage of a particular resource. The specific objective function chosen depends on the specific problem to be solved and the objectives to be optimized. Constraints may also be defined to restrict the values the decision variables can assume thereby influencing the objective value (output) that can be achieved. During an optimization process, an objective function's decision variables are often changed or manipulated within the bounds of the constraints to improve the objective function's values. In general, the difficulty in solving an objective function increases as the number of decision variables included in that objective function increases. The term “decision variable” refers to a variable that represents a decision to be made.

The term “optimization” or “mathematical optimization” at least in some embodiments refers to an act, process, function, algorithm, process, or methodology of making something (e.g., a design, system, or decision) as fully perfect, functional, or effective as possible. Additionally or alternatively, the term “optimization” at least in some embodiments refers to mathematical procedures for identifying, determining, and/or selecting a best element, with regard to some criterion, from some set of available alternatives, and/or finding the maximum or minimum of a function. The term “optimization problem” at least in some embodiments refers to a function, algorithm, process, or some other method of identifying and/or determining the best solution from all feasible solutions. Additionally or alternatively, the term “optimization problem” at least in some embodiments refers to maximizing or minimizing a real function by systematically choosing input values from within an allowed set and computing the value of the function. The term “optimal” at least in some embodiments refers to a most desirable or satisfactory end, outcome, or output. The term “optimum” at least in some embodiments refers to an amount or degree of something that is most favorable to some end. The term “optima” at least in some embodiments refers to a condition, degree, amount, or compromise that produces a best possible result. Additionally or alternatively, the term “optima” at least in some embodiments refers to a most favorable or advantageous outcome or result.

The term “probability” at least in some embodiments refers to a numerical description of how likely an event is to occur and/or how likely it is that a proposition is true. The term “probability distribution” at least in some embodiments refers to a mathematical function that gives the probabilities of occurrence of different possible outcomes for an experiment or event.

The term “probability distribution” at least in some embodiments refers to a function that gives the probabilities of occurrence of different possible outcomes for an experiment or event. Additionally or alternatively, the term “probability distribution” at least in some embodiments refers to a statistical function that describes all possible values and likelihoods that a random variable can take within a given range (e.g., a bound between minimum and maximum possible values). A probability distribution may have one or more factors or attributes such as, for example, a mean or average, mode, support, tail, head, median, variance, standard deviation, quantile, symmetry, skewness, kurtosis, etc. A probability distribution may be a description of a random phenomenon in terms of a sample space and the probabilities of events (subsets of the sample space). Example probability distributions include discrete distributions (e.g., Bernoulli distribution, discrete uniform, binomial, Dirac measure, Gauss-Kuzmin distribution, geometric, hypergeometric, negative binomial, negative hypergeometric, Poisson, Poisson binomial, Rademacher distribution, Yule-Simon distribution, zeta distribution, Zipf distribution, etc.), continuous distributions (e.g., Bates distribution, beta, continuous uniform, normal distribution, Gaussian distribution, bell curve, joint normal, gamma, chi-squared, non-central chi-squared, exponential, Cauchy, lognormal, logit-normal, F distribution, t distribution, Dirac delta function, Pareto distribution, Lomax distribution, Wishart distribution, Weibull distribution, Gumbel distribution, Irwin-Hall distribution, Gompertz distribution, inverse Gaussian distribution (or Wald distribution), Chernoff's distribution, Laplace distribution, Pólya-Gamma distribution, etc.), and/or joint distributions (e.g., Dirichlet distribution, Ewens's sampling formula, multinomial distribution, multivariate normal distribution, multivariate t-distribution, Wishart distribution, matrix normal distribution, matrix t distribution, etc.).

The term “moving average” at least in some embodiments refers to a calculation to analyze data points by creating a series of averages of different subsets of the full data set.

The term “weighted average” at least in some embodiments refers to an average that has multiplying factors to give different weights to data at different positions in a sample window.

The term “weighted moving average” at least in some embodiments refers to the convolution of data with a fixed weighting function.

The term “exponential moving average”, “EMA”, “exponentially weighted moving average”, or “EWMA” at least in some embodiments refers to a first-order infinite impulse response filter that applies weighting factors that decrease or increase exponentially.

Although many of the previous examples are provided with use of specific cellular/mobile network terminology, including with the use of 4G/5G 3GPP network components (or expected terahertz-based 6G/6G+ technologies), it will be understood these examples may be applied to many other deployments of wide area and local wireless networks, as well as the integration of wired networks (including optical networks and associated fibers, transceivers, etc.). Furthermore, various standards (e.g., 3GPP, ETSI, etc.) may define various message formats, PDUs, containers, frames, etc., as comprising a sequence of optional or mandatory data elements (DEs), data frames (DFs), information elements (IEs), and/or the like. However, it should be understood that the requirements of any particular standard should not limit the embodiments discussed herein, and as such, any combination of containers, frames, DFs, DEs, IEs, values, actions, and/or features are possible in various embodiments, including any combination of containers, DFs, DEs, values, actions, and/or features that are strictly required to be followed in order to conform to such standards or any combination of containers, frames, DFs, DEs, IEs, values, actions, and/or features strongly recommended and/or used with or in the presence/absence of optional elements.

Although these implementations have been described with reference to specific exemplary aspects, it will be evident that various modifications and changes may be made to these aspects without departing from the broader scope of the present disclosure. Many of the arrangements and processes described herein can be used in combination or in parallel implementations to provide greater bandwidth/throughput and to support edge services selections that can be made available to the edge systems being serviced. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1-31. (canceled)

32. An apparatus employed as an object management system (OMS) in a multi-tiered caching system including a plurality of storage tiers, the apparatus comprising:
memory circuitry to store program code of the OMS; and
processor circuitry connected to the memory circuitry, wherein the processor circuitry is to execute the program code to:
measure a fetch cost for accessing an object from a first cache of a first storage tier of the plurality of storage tiers in which the object is currently stored, wherein the fetch cost is based on a fetch latency, and the fetch latency is an amount of latency of the object being delivered to a requestor of the object;
determine a second storage tier of the plurality of storage tiers in which to evict the object when the fetch cost exceeds a threshold;
cause eviction of the object from the first cache; and
store the evicted object in the second cache.

33. The apparatus of claim 32, wherein the processor circuitry is to execute the program code to:
determine the fetch cost based on a fetch latency, wherein the fetch latency is based on a fetch time, and the fetch time is an amount of time between issuing a fetch command to access the object from the first cache and delivery of the object to the requestor.

34. The apparatus of claim 33, wherein the processor circuitry is to execute the program code to:
determine a number of delayed hits of accessing the object;
determine the fetch cost based on the fetch time and the number of delayed hits; and
determine the fetch cost based on a mean weighted average (MWA) of the fetch time compounded with the number of delayed hits.

35. The apparatus of claim 34, wherein the processor circuitry is to execute the program code to:
determine a mean time to reuse (MTR) of the object based on a time-series aggregation of a reuse time, wherein the reuse time is a time between a previous access of the object and a current access of the object.

36. The apparatus of claim 35, wherein the processor circuitry is to execute the program code to:
aggregate cache space among caches of the storage tiers of the plurality of storage tiers; and
allocate an amount of the aggregated cache space to the object based on the fetch cost, MTR, and an access density of the object.

37. The apparatus of claim 36, wherein the processor circuitry is to execute the program code to:
increase a replication factor of the object when the object has a higher fetch cost than other objects stored in the first cache or other caches of other storage tiers of the plurality of storage tiers

38. The apparatus of claim 37, wherein the processor circuitry is to execute the program code to:
increase a compression factor for the object when the object has a higher fetch cost than other objects stored in the first cache or other caches of other storage tiers of the plurality of storage tiers; and
distribute, by the OMS, the object with consistent hashing across the aggregated cache space.

39. The apparatus of claim 32, wherein the processor circuitry is to execute the program code to:
detect a request for the object issued by the requestor; and
cause issuance of the fetch command to access the object from the first cache when there is no outstanding fetch command for the object;
wait until the object is fetched from the first cache when there is an outstanding fetch command for the object; and
cause delivery of the object to the requestor when the object is fetched from the first cache.

40. The apparatus of claim 32, wherein the processor circuitry is to execute the program code to:
determine a latency requirement for delivery of the object from the first cache to the requestor, a current latency of delivery of data from the first cache to the requestor, and a current network route between the first cache and the requestor; and
route the object to be delivered to the requestor over a new network route to the requestor when the current latency and an estimated remaining latency is larger than the latency requirement.

41. The apparatus of claim 32, wherein the second storage tier is a best-effort storage tier in comparison with other storage tiers of the plurality of storage tiers when:
the fetch cost is less than or equal to the threshold, and
the first storage tier is an outer-most storage tier among the plurality of storage tiers.

42. The apparatus of claim 32, wherein the second storage tier is a nearest available storage tier with respect to the first storage tier when:
the fetch cost is greater the threshold, and
the first storage tier is an outer-most storage tier among the plurality of storage tiers.

43. The apparatus of claim 32, wherein the second storage tier is a storage tier of the plurality of storage tiers further from the requestor than the first storage tier when:
the first storage tier is not an outer-most storage tier among the plurality of storage tiers.

44. The apparatus of claim 32, wherein the apparatus is one of a router, a switch, a smart edge switch, a gateway device, a network appliance, a load balancing server, a firewall appliance, a data processing unit (DPU), an infrastructure processing unit (IPU), a network interface controller (NIC), a smart NIC, a storage controller, a cache controller or caching agent of interconnect interface circuitry, a memory controller, an in-memory caching engine, a server host processor platform, a hardware accelerator, and a cloud computing service.

45. The apparatus of claim 32, wherein the OMS is implemented as, or part of, a protocol stack layer of a communication protocol, a network storage stack software element on a DPU, a Software-Defined Networking switch, virtualized network function, an in-server library, a caching agent of a message broker framework, a user agent caching mechanism, or a web caching system.

46. One or more non-transitory computer-readable media (NTCRM) comprising instructions of an object management system (OMS), wherein execution of the instructions by network device in a multi-tiered caching system including a plurality of storage tiers is to cause the network device to:
detect a request for an object issued by a requestor; and
issue a fetch command to access the object from a first cache in which the object is currently stored when there is no outstanding fetch command for the object, wherein the first cache is part of a first storage tier of the plurality of storage tiers in which the object is currently stored;
wait until the object is fetched from the first cache when there is an outstanding fetch command for the object;
deliver the object to the requestor when the object is fetched from the first cache
measure a fetch cost for accessing the object from the first cache, wherein the fetch cost is based on a fetch latency, and the fetch latency is an amount of latency of the object being delivered to the requestor from the first cache;
determine a second storage tier of the plurality of storage tiers in which to evict the object when the fetch cost exceeds a threshold; and
evict the object from the first cache to the second cache.

47. The one or more NTCRM of claim 46, wherein execution of the instructions is to cause the network device to:
determine a fetch time as an amount of time between issuance of the fetch command and delivery of the object to the requestor;
determine a number of delayed hits of accessing the object from the first cache; and
determine the fetch cost as a mean weighted average (MWA) of the fetch time compounded with the number of delayed hits, wherein the MWA includes one or more of a simple moving average (SMA), a cumulative average (CA), a weighted moving average (WMA), an exponential moving average (EMA), an exponentially weighted moving average (EWMA), a modified moving average (MMA), a running moving average (RMA), a smoothed moving average (SMMA), or a moving average regression model.

48. The one or more NTCRM of claim 47, wherein execution of the instructions is to cause the network device to:
determine a mean time to reuse (MTR) of the object based on a time-series aggregation of a reuse time, wherein the reuse time is a time between a previous access of the object and a current access of the object.

49. The one or more NTCRM of claim 46, wherein execution of the instructions is to cause the network device to:
determine a latency requirement for delivery of the object from the first cache to the requestor, a current latency of delivery of data from the first cache to the requestor, and a current network route between the first cache and the requestor; and
route the object to be delivered to the requestor over a new network route to the requestor when the current latency and an estimated remaining latency is larger than the latency requirement.

50. A method of managing a multi-tiered caching system including a plurality of storage tiers, the method comprising:
detecting, by an object management system (OMS), a request for an object issued by a requestor; and
issuing, by the OMS, a fetch command to access the object from a first cache in which the object is currently stored when there is no outstanding fetch command for the object, wherein the first cache is part of a first storage tier of the plurality of storage tiers in which the object is currently stored;
waiting, by the OMS, until the object is fetched from the first cache when there is an outstanding fetch command for the object;
delivering, by the OMS, the object to the requestor when the object is fetched from the first cache
measuring, by the OMS, a fetch cost for accessing the object from the first cache, wherein the fetch cost is based on a fetch latency, and the fetch latency is an amount of latency of the object being delivered to the requestor from the first cache;
determining, by the OMS, a second storage tier of the plurality of storage tiers in which to evict the object when the fetch cost exceeds a threshold; and
evicting, by the OMS, the object from the first cache to the second cache.

51. The method of claim 50, wherein the method includes:
determining a fetch time as an amount of time between issuance of the fetch command and delivery of the object to the requestor;
determining a number of delayed hits of accessing the object from the first cache; and
determining the fetch cost as a mean weighted average (MWA) of the fetch time compounded with the number of delayed hits.

52. The method of claim 51, wherein the MWA includes one or more of a simple moving average (SMA), a cumulative average (CA), a weighted moving average (WMA), an exponential moving average (EMA), an exponentially weighted moving average (EWMA), a modified moving average (MMA), a running moving average (RMA), a smoothed moving average (SMMA), or a moving average regression model.

53. The method of claim 51, wherein the method includes:
determine a mean time to reuse (MTR) of the object based on a time-series aggregation of a reuse time, wherein the reuse time is a time between a previous access of the object and a current access of the object.

54. The method of claim 53, wherein the method includes:
aggregating, by the OMS, cache space among caches of the storage tiers of the plurality of storage tiers;
allocating, by the OMS, an amount of the aggregated cache space to the object based on the fetch cost, MTR, and an access density of the object;
increasing, by the OMS, a replication factor of the object when the object has a higher fetch cost than other objects stored in the first cache or other caches of other storage tiers of the plurality of storage tiers;
increasing, by the OMS, a compression factor for the object when the object has a higher fetch cost than other objects stored in the first cache or other caches of other storage tiers of the plurality of storage tiers; and
distributing, by the OMS, the object with consistent hashing across the aggregated cache space

55. The method of claim 54, wherein the method includes:
determining, by the OMS, a latency requirement for delivery of the object from the first cache to the requestor, a current latency of delivery of data from the first cache to the requestor, and a current network route between the first cache and the requestor; and
routing, by the OMS, the object to be delivered to the requestor over a new network route to the requestor when the current latency and an estimated remaining latency is larger than the latency requirement.

56. The method of claim 50, wherein:
the second storage tier is a best-effort storage tier in comparison with other storage tiers of the plurality of storage tiers when the fetch cost is less than or equal to the threshold and the first storage tier is an outer-most storage tier among the plurality of storage tiers;
the second storage tier is a nearest available storage tier with respect to the first storage tier when the fetch cost is greater the threshold and the first storage tier is an outer-most storage tier among the plurality of storage tiers; and
the second storage tier is a storage tier of the plurality of storage tiers further from the requestor than the first storage tier when the first storage tier is not an outer-most storage tier among the plurality of storage tiers.
